(19) United States
(12) Patent Application Publication
(10) Pub. No.: US 2024/0418912 A1
(43) Pub. Date: Dec. 19, 2024

(54) LIGHT-UNIFORMIZING FILM AND METHOD FOR PREPARING SAME

(71) Applicant: NINGBO EXCITON TECHNOLOGY CO., LTD., Ningbo (CN)

(72) Inventors: Yan ZHANG, Ningbo (CN); Zhipeng YE, Ningbo (CN); Gang LI, Ningbo (CN); Haijiang TANG, Ningbo (CN)

(73) Assignee: NINGBO EXCITON TECHNOLOGY CO., LTD., Ningbo (CN)

(21) Appl. No.: 18/705,483

(22) PCT Filed: Sep. 16, 2022
(86) PCT No.: PCT/CN2022/119297

§ 371 Date: Apr. 26, 2024

(30) Foreign Application Priority Data
Oct. 29, 2021 (CN) 202111268629.0
Oct. 29, 2021 (CN) 202111268823.9
Oct. 29, 2021 (CN) 202111268882.6
Oct. 29, 2021 (CN) 202111269132.0
Oct. 29, 2021 (CN) 202111270266.4
Oct. 29, 2021 (CN) 202111272130.7
Dec. 23, 2021 (CN) 202111587097.7
Mar. 29, 2022 (CN) 202210320342.6
Mar. 29, 2022 (CN) 202210322327.5

(51) Int. Cl. G02B 5/02; G02B 3/06; G02F 1/1335; G02F 1/13357

(52) U.S. Cl. CPC G02B 5/0231; G02B 3/06; G02B 5/0278; G02F 1/133603; G02F 1/133607; G02F 1/133611

(57) ABSTRACT

A light-uniformizing film, comprising a light-splitting layer (21), a substrate layer (20) and a light-diffusion layer (22), or only comprising the light-splitting layer (21) and the substrate layer (20), wherein the light-diffusion layer (22) is located on the upper surface of the substrate layer (20), the light-splitting layer (21) is located on the lower surface of the substrate layer (20), and the light-splitting layer (21) has a good surface finish, such that the abnormal deflection of light is small. By means of the light-uniformizing film, the energy concentrated within a certain range around a beam center of a point light source can be rationally distributed in other directions, the energy of a central hotspot on a projection screen is reduced, and the overall light-emission area is enlarged, thereby improving the uniformity of energy distribution.

### TECHNICAL FIELD

The present application relates to a light-uniformizing film, and especially relates to a light-uniformizing film for reducing LED shadow and improving uniformity and method for preparing same.

### TECHNICAL BACKGROUND

Light emitting diodes (LEDs) are the most commonly used light sources in the field of optoelectronic display fields. How to efficiently and uniformly convert this point-light source into the desired line- or even surface-light source has always been content worthy of continuous research. In the traditional field of liquid crystal display (LCD), the display of LCD panels requires backlight modules, especially the straight-down backlight modules to provide light source problems. The LED array emits a certain beam angle of light vertically from the lamp panel, and converts the point-light source into a uniform surface light source through diffusion plates and various traditional optical films (such as diffusion films, brightening films, etc.).

Due to the fact that the majority of the light emitted by LEDs is concentrated at the center of the beam and within the beam angle that deviates slightly from the center, this highly concentrated light will produce higher intensity (the peak intensity of cosine emitters is at the center of the beam, while other angles light intensity gradually decreases, and the ratio to the peak light intensity is equal to the cosine value of that angle. It will form small and bright light spots-hotspots directly above the position of the light when projected onto the panel, with energy (illuminance) distribution drop in the center of the hotspots and between the two hotspots is significant, resulting in the problems of uneven light emission or light shadows. Especially in some new display technology application scenarios, when the brightness of a single LED light is high, the distance between the lights is large, or the mixing distance is short, the gap in energy distribution further increases, the phenomenon of light shadows will become more obvious, for example, in order to pursue the maximum visual effect, MiniLED models not only design high brightness for single lights to improve contrast and peak brightness, but also design short mixingdistance (OD) to reduce the halo phenomenon in the dark field and reduce crosstalk between pixels, making it difficult to solve light shadows. Another embodiment is, for large-sized ordinary straight-down models, in order to shorten thickness, the OD needs to be shortened, or to reduce light consumption, the distance between lights needs to be expanded, making it equally difficult to solve the problem of lighting shadows.

How to reasonably allocate the energy concentrated within a certain range of the beam center of a point-light source to other direction at a shorter mixing distance, and reduce the energy of the central bright spot on the projection screen (LCD middle finger panel position), and expands the overall luminous area, thereby improving the uniformity of energy distribution (reducing standard deviation), is the key to solve the problem of light shadows.

However, traditional diffusion plates and diffusion films, due to their own optical principles, only utilize particle refraction, scattering, and reflection (Whether they are air bubbles, organic particles, inorganic particles, or particle-free imprinting) to play a role of the disordered diffusion of light (without directionality), the expansion of the luminous area is very limited, and the energy is still concentrated in the central position, so it cannot meet requirements of the light of homogenization of the above application scenarios (as shown in FIGS. 1a and 1b).

Therefore, it is necessary to develop a light-uniformizing film with directional adjustment of light direction to effectively separate (spectroscopic effect) the centrally concentrated light and can expand the emitting area (light spreading effect) as shown in FIGS. 1a and 1c).

### SUMMARY OF THE INVENTION

In order to improve problems of light shadows of point-light source array of a high brightness short OD, the present invention provides a light uniformizing film and method for preparing same.

The light uniformizing film provided by the present invention can reasonably distribute the energy concentrated within a certain range of the beam center of the point-light source to other directions, and reduce the energy of the central bright spot on the projection screen, expand the overall luminous area, thereby improving the uniformity of energy distribution. The light uniformizing film provided by the present invention can make the emitted light more uniform, the brightness more uniform, and improve the light shadow problems of the point-light source arrays with high brightness and short OD. The light uniformizing film provided by the present invention can also improve the light shadow problems of point-light source array with long OD.

In order to solve the above-mentioned technical problems, the present invention provides the technical solution as follows:

The present invention provides a light uniformizing film, which comprises a spectral layer and a substrate layer.

The present invention provides a light uniformizing film, The light uniformizing film comprises a spectral layer, a substrate layer, and a diffuser layer. The diffuser layer is located on the upper surface of the substrate layer, and the spectral layer is located on the lower surface of the substrate layer.

The line roughness Ra of the surface of the spectral layer is <250 nm. The surface smoothness of the spectral layer is high.

The light-uniformizing film can reasonably distribute the energy concentrated within 30 degrees of the beam angle at the center of the point light source beam to other directions, and reduce the energy of the central bright spot on the projection screen, expand the overall luminous area, thereby at least improving the uniformity of energy distribution to 30% less.

Furthermore, when the light within a beam angle of 30 degrees of the light source passes through the light-uniformizing film, a single bright spot can be observed on the projection screen to be transformed into multiple bright spots or a superposition of multiple bright spots, and the size of the bright spots decreases, the intensity weakens, and uniformity of the energy distribution is measured by using the standard deviation of the illuminance distribution on the projection screen, the standard deviation of the illuminance distribution can be increased by at least 30%.

The spectral layer is composed of the long ribs stacked in N directions, N is the topological coefficient. The long ribs are laid flat in the substrate layer (referred to as the substrate), The long ribs extend infinitely towards both ends, The long ribs in the same direction are tightly arranged, and the 360 degree azimuth angle is divided equally by N directions, that is, the angle interval between adjacent directions is equally 180/N degrees, N is selected from 1, 2, or 3.

The cross sections of the long ribs of the spectral layer are the same, each is isosceles triangles, with the left and right waists being finite-cut straight lines at both ends, outer convex arcs or inner concave arcs, with the bottom edge being a straight line and the bottom edge W₁ ranging from 10 to 100 μm, the vortex angle θ of 60˜120°; The degree of curvature of the outer convex arc or the inner concave arc (referred to concave convex arc) is indicated by the center angle, the center angle α being 1˜30°.

The spectral layer is one of the standard plane spectral layer, convex arc spectral layer, and concave arc spectral layer, and the cross-section of its corresponding long rib is isosceles triangle which has left and right waists being finite-cut straight lines at both ends, outer convex arcs (referred to convex arcs), and inner concave arcs (referred to concave arcs).

The substrate layer is transparent polymer, and the material of which is selected from one of polyethylene terephthalate (PET) and methyl methacrylate (PMMA), polycarbonate (PC), cellulose triacetate (TAC), and cycloolefin polymer (COP).

The thickness M of the substrate layer is 25-500 μm.

The light uniformizing film is one of planar light-uniformizing film, prism light-uniformizing film, cylinder light-uniformizing film, pyramid light-uniformizing film, or microlens light-uniformizing film.

The light-uniformizing film is a planar light-uniformizing film, which includes a spectral layer and a substrate layer. The spectral layer is one of the standard plane spectral layer, convex arc face spectral layer, or concave arc surface spectral layer. The spectral layer whose waists of the isosceles triangle with long rib cross-section are straight lines is called the standard plane spectral layer, the spectral layer whose waists being the outer convex arc is called the convex are spectral layer, and the spectral layer whose waist being the inner concave arc is called the concave arc spectral layer.

The light-uniformizing film is a prism light uniformizing film, which includes a spectral layer, a substrate layer, and a diffuser layer. The spectral layer is one of the standard plane spectral layer, convex arc face spectral layer, or concave arc surface spectral layer. The diffuser layer is a prism layer, which is laid flat by triangular prism ribs. The cross-section of the triangular prism ribs is an isosceles triangle, and the bottom edge V of the triangle is 10-100 μm, with the vortex angle β of 60˜120°. Furthermore, the vortex angle β is 75˜105 The light-uniformizing film is a cylinder light-uniformizing film, which includes a spectral layer, a substrate layer, and a diffuser layer. The spectral layer is one of the standard plane spectral layer, convex arc surface spectral layer, or concave arc surface spectral layer. The diffuser layer is a cylinder layer, which is laid flat by a cylindrical lens. The cross-section of the cylindrical lens is an arc, and the width (chord length) F of the arc is 20˜1000 μm. The height of the arc is K, and the ratio of height and width K/F is 0.05-0.5.

The light-uniformizing film is a pyramid light-uniformizing film, which includes a spectral layer, a substrate layer, and a diffuser layer. The spectral layer is one of the standard plane spectral layer, convex arc surface spectral layer, or concave arc surface spectral layer. The diffuser layer is a pyramid layer, formed by overlaying a triangular or quadrangular pyramid, with the vertices of the triangular pyramid forming an equilateral triangular arrangement and the vertices of the quadrangular pyramid forming a square arrangement, and the height T of the pyramid is 10-100 μm. The angle between the side and the height γ is 30˜60°.

The light-uniformizing film is a microlens light-uniformizing film, which includes a spectral layer, a substrate layer, and a diffuser layer. The spectral layer is one of the standard plane spectral layer, convex arc surface spectral layer, or concave arc surface spectral layer. The diffuser layer is a microlens layer, in the microlens layer, the coordinates of the main optical axes of three adjacent microlenses are connected to form an equilateral triangle array, and the microlenses in the microlens array are closely arranged. The width of themicrolens G is ranging from 10 to 100 μm, the height of the microlens is H, the ratio of the height and width H/G is ranging from 0.05 to 0.5, and the distance between the main optical axes of two adjacent microlens D is equal to G.

The spectral layer and the diffuser layer are made of transparent polymer resin.

The material of the transparent polymer resin is selected from one of AR (acrylic resin, acrylic resin or modified acrylic resin), PMMA or PC. AR is preferred for the light curing process, while PMMA and PC are preferred for the hot-press molding process. The transparent polymer resin of the spectral layer is selected from one of AR, PC, or PMMA, and the refractive index n₁ is selected from 1.4 to 1.65. When the spreading layer is a prism layer, a cylinder layer, a pyramid layer, or a microlens layer, the transparent polymer resin is selected from one of AR, PC, or PMMA, and the refractive index n₂ is selected from 1.4 to 1.65.

The present invention provides a light-uniformizing film, comprising a substrate layer 20 and a spectral layer 21, the diffuser layer 22 does not exist, as shown in FIG. 10, and the light-uniformizing film is a planar light-uniformizing film. The thickness M of the substrate layer 20 is 25-500 μm, for example, 25 μm, 75 μm, 100 μm, 125 μm, 250 μm, 500 μm. The material of the substrate layer is selected from one of PET, PMMA or PC, and the spectral layer is composed of transparent polymer resin, the material is one of light-cured acrylic resin (AR), PMMA or PC, and the refractive index m, is 1.4-1.65, such as 1.4, 1.5, 1.58, 1.65. The spectral layer is designed as a single axis standard plane: it is composed of the long ribs stacked in N different directions. The long ribs are laid flat on the lower surface of the substrate layer, extending infinitely towards both ends. The long ribs in the same direction are tightly arranged, and the topological coefficient N is 1, that is, single axis spectroscopy (as shown in FIG. 6). The spectral layer is selected from the standard plane spectral layer, and the cross-section of its corresponding long rib is an isosceles triangle, with the left and right waists being finite cut straight lines at both ends, that is, the cross-section of the long rib is an isosceles triangle with the vertex angle θ of 60°-120°, such as 60°, 75°, 80°, 90°, 105°, 120°. When the spectral layer is a convex arc face spectral layer or a concave arc surface spectral layer, the cross-section of its corresponding long rib is an isosceles triangle which has an outer convex arc line (referred to as convex arc line) and an inner concave arc line (referred to as concave arc line) that are finite cut at both ends with the vertex angle θ of 60°-120°, such as 60°, 80°, 87°, 90°, 100°, 120°, with the center angle α being 1°-30°, such as 1°, 3°, 10°, 30°. The light-uniformizing performance of this light-uniformizing film is good, with an improvement in uniformity of U=30-120%. The aforementioned technicalsolution includes embodiments 1-31.

The present invention provides a light-uniformizing film comprising a substrate layer 20, a spectral layer 21, and a diffuser layer 22, as shown in FIG. 11, wherein the light-uniformizing film is a prism light-uniformizing film. The thickness M of the substrate layer 20 is 25-500 μm for example, 25 μm, 75 μm, 250 μm, 500 μm. The material of the substrate layer is selected from one of PET, PMMA, or PC. The spectral layer is composed of transparent polymer resin, the material of which is light-cured acrylic resin (AR) with a refractive index n₁ is 1.5. The spectral layer is composed of transparent polymer resin, the material of which is light-cured acrylic resin (AR) with a refractive index n₂ of 1.4-1.65, such as 1.4, 1.5, 1.65. The spectral layer is designed as a biaxial standard plane: is composed of the long ribs stacked in N different directions, which are laid flat on the lower surface of the substrate layer. The long ribs extend infinitely towards both ends, and the long ribs in the same direction are tightly arranged. The topological coefficient N is selected from 2, which is the biaxial spectral (as shown in FIG. 7); The spectral layer is selected from the standard plane spectral layer, and the cross-section of its corresponding long rib is an isosceles triangle has left and right waists being finite cut straight lines at both ends, that is, the cross-section of the long rib is a straight triangle with a vertex angle θ of 90°. The diffuser layer is a prism layer 221, which is composed of three prism ribs laid flat. The cross-section of the three prism ribs is an isosceles triangle, and the bottom edge V of the triangle is 10-100 μm, for example, 10 μm, 25 μm, 50 μm, 75 μm, 100 μm. the vortex angle β is 60°-120°, such as 60°, 75°, 90°, 105°, 120°; the light-uniformizing performance of the light-uniformizing film is good, with an improvement in uniformity of U=91-302%. The aforementioned technical solution include embodiments 37-48. The present invention provides a light-uniformizing film comprising a substrate layer 20, a spectral layer 21, and a diffuser layer 22, as shown in FIG. 12, the light-uniformizing film is a cylinder light-uniformizing film. The thickness M of the substrate layer 20 is 25-500 μm, for example, 25 μm, 75 μm, 125 μm, 250 μm, 500 μm. The material of the substrate layer is selected from one of PET, PMMA, or PC. The spectral layer is composed of transparent polymer resin, the material of which is a light-cured acrylic resin (AR) with a refractive index n₁ of 1.5. The spectral layer is composed of transparent polymer resin, the material of which is a light-cured acrylic resin (AR) with a refractive index n₂ of 1.4-1.65, such as 1.4, 1.5, 1.65. The spectral layer is designed as a biaxial standard plane, composed of the long ribs stacked in N different directions, which are laid flat on the lower surface of the substrate layer. The long ribs extend infinitely towards both ends, and the long ribs in the same direction are tightly arranged. The topological coefficient N is selected from 2, which is biaxial spectroscopy; the spectral layer is selected from the standard plane spectral layer, and the cross-section of its corresponding long rib is an isosceles triangle, with the left and right waists being finite cut straight lines at both ends, that is, the cross-section of the long rib is an isosceles triangle with the vertex angle θ of 90°. The diffuser layer is a cylindrical lens layer 222, which is laid flat by cylindrical lens ribs. The cross-section of the cylindrical lens is an arc, and the width (chord length) of the arc F is 20-1000 μm, for example, 20 μm, 50 μm, 100 μm, 250 μm, 500 μm, 1000 μm. The height of the arc is K, and the ratio of height and width K/F is 0.05-0.5, such as 0.05, 0.1, 0.3, 0.5. The light-uniformizing performance of the light-uniformizing film is good, with an improvement in uniformity of U=97-125%. The aforementioned technical solution includes embodiments 49-60.

The present invention provides a light-uniformizing film comprising a substrate layer 20, a spectral layer 21, and a diffuser layer 22, as shown in FIG. 12, wherein the light-uniformizing film is a pyramid light-uniformizing film. The thickness M of the substrate layer 20 is 25-500 μm, for example, 25 μm, 75 μm, 250 μm, 500 μm. The material of the substrate layer is selected from one of PET, PMMA, or PC. The spectral layer is composed of transparent polymer resin, the material of which is a light-cured acrylic resin (AR) with a refractive index n₁ of 1.5. The diffuser layer is composed of transparent polymer resin, the material of which is light-cured acrylic resin (AR) with a refractive index n₂ of 1.4-1.65, such as 1.4, 1.5, 1.65. The spectral layer is designed as a biaxial standard plane: composed of the long ribs stacked in N different directions, which are laid flat on the lower surface of the substrate layer, the long ribs extend infinitely towards both ends, and The long ribs in the same direction are tightly arranged. The topological coefficient N is selected from 2, which is biaxial spectroscopy; the spectral layer is selected from the standard plane spectral layer, and the cross-section of its corresponding long rib is isosceles triangle with two finite cut straight lines on both ends, that is, the cross-section of the long rib is a straight triangle with a vertex angle θ of 90°. The diffuser layer is a pyramid layer 224, which is laid flat by the quadrangular pyramid. The vertices of the pyramid form a square arrangement, and the height T of the pyramid is 10-50 μm, for example, 10 μmm, 20 μm, 30 μm, 40 μm, 50 μm. The angle between the side and the height γ is 30°-60°, for example, 30°, 45°, 60°. The light-uniformizing performance of the light-uniformizing film is good, with an improvement in uniformity of U=41-270%. The aforementioned technical solution includes embodiments 61-70.

The present invention provides a light-uniformizing film comprising a substrate layer 20, a spectral layer 21, and a diffuser layer 22, as shown in FIG. 13, wherein the light-uniformizing film is a microlens light-uniformizing film. The thickness M of the substrate layer 20 is 25-500 μm, for example, 25 μm, 75 μm, 250 μm, 500 μm. The material of the substrate layer is selected from one of PET, PMMA or PC, and the spectrogram layer is composed of transparent polymer resin, the material of which is made of light-cured acrylic resin (AR) with a refractive index n₁ of 1.5. The diffuser layer is made of transparent polymer resin, the material of which is light-cured acrylic resin (AR), with a refractive index n₂ of 1.4-1.65, such as 1.4, 1.5, 1.65. The spectral layer is designed as a biaxial standard plane: composed of the long ribs stacked in N different directions, which are laid flat on the lower surface of the substrate layer. The long ribs extend infinitely towards both ends, and The long ribs in the same direction are tightly arranged, the topological coefficient N is selected from 2, which is biaxial spectroscopy; the spectral layer is selected from the standard plane spectral layer, and the cross-section of its corresponding long rib is isosceles triangle with two finite cut straight lines on both ends, that is, the cross-section of the long rib is a straight triangle with a vertex angle θ of 90°. The diffuser layer is the microlens layer 225, and the coordinates of the main optical axes of the three adjacent microlenses are connected to form an equilateral triangle array. The microlenses in the microlens array are closely arranged. The width G of the microlens is 10-100 μm, for example, 10 μm, 25 μm, 50 μm, 75 μm, 100 μm. The height of the microlens is H, and the ratio of height and width H/G is 0.05-0.5, such as 0.05, 0.1, 0.3, 0.5. The distance between the main optical axes of adjacent microlenses is equal to G. The light-uniformizing performance of the light-uniformizing film is good, with an improvement in uniformity of U=97-114%. The aforementioned technical solution includes embodiments 71-80.

The present invention provides a preparation method for a light-uniformizing film, characterized in that a spectral layer is prepared on the back of the substrate layer using micro replication or hot-press molding process and utilizing transparent polymer resin; and a diffuser layer is prepared on the front of the substrate layer using photo cured micro replication or hot-press molding process and utilizing transparent polymer resin formula.

Furthermore, the preparation method of the light-uniformizing film comprises the following steps:
(1) Using the substrate layer as the support layer, a spectral layer is prepared on the back to obtain a planar light-uniformizing film only containing the spectral layer and substrate layer;

Furthermore, the preparation method of the light-uniformizing film comprises the following steps:
(1) Preparing mold 1 for the spectral layer;
(2) Micro replicating or hot press molding on the back to form a spectral layer using the substrate layer as the support layer, using mold 1, whereby obtaining a light-uniformizing film (i.e. a planar light-uniformizing film, which can also be used as a light-uniformizing film semi-finished product with other spreading layer structures) that only contains the spectral layer and substrate layer;

Furthermore, the preparation method of the light-uniformizing film comprises the following steps:
(1) Preparing a spectral layer on the back using the substrate layer as the support layer, whereby obtaining a semi-finished product containing the spectral layer;
(2) Preparing a diffuser layer on the front of the semi-finished product prepared in step (1) to obtain a light-uniformizing film containing both the spectral layer and the diffuser layer, simultaneously;

Furthermore, the preparation method of the light-uniformizing film comprises the following steps:
(1) Preparing mold 1 for the spectral layer (the concave long ribs superposed with texture), it is usually machined by polished metal rollers or metal plates through diamond precision carving process, where the shape of the diamond carving knife is the same as the cross-section of the long rib;
(2) Micro replicating or hot press molding on the back of the substrate layer to prepare a spectral layer (the convex long ribs superposed with texture), obtaining a semi-finished product containing a spectral layer;
(3) Preparing mold 2 for the diffuser layer (complementary structure of the diffuser layer), it is usually machined by polished metal rollers or metal plates through microbead sandblasting, diamond carving, etc.;
(4) Micro replicating or hot-press molding on the front of the substrate layer using mold 2 to produce a diffuser layer, obtaining both a diffuser layer and a light spreading layer, simultaneously;

Furthermore, the preparation method of the light-uniformizing film comprises the following steps:
(1) Preparing mold 1 for the spectral layer (the concave long ribs superposed with texture), usually machining by polished metal rollers or metal plates through diamond precision carving process, where the shape of the diamond carving knife is the same as the cross-section of the long rib;
(2) Micro replicating or hot-press molding on the back of the substrate layer to produce a spectral layer (the convex long ribs superposed with texture) using mold 1, whereby obtaining a semi-finished product containing the spectral layer;
(3) Preparing mold 2 for the diffuser layer (with the same structure as the diffuser layer), it is usually machined by polished metal rollers or metal plates sprayed through processes such as microbead sandblasting, diamond carving, etc.;
(4) Preparing mold 3 for the diffuser layer (complementary structure of the diffuser layer), which can be embossed by mold 2 (through high hardness metal squeezing low hardness metals to obtain metal molds, or by using optical films with the same structure as the diffuser layer as templates to electroform complementary structures of the metal molds, or by using optical films with complementary structures obtained by pressing mold 2 and directly use them as soft mold 3;
(5) Micro replicating or hot-press molding on the front of the substrate layer to produce a diffuser layer using mold 3, whereby obtaining the light-uniformizing film containing the spectral layer and the diffuser layer, simultaneously;

It should be noted that the processing methods of the spectral layer and the diffuser layer should be selected based on types of structure and material. It is not preferred in the present invention.

It should be noted that the preparation method of the light-uniformizing film provided by the present invention is applicable to the production of sheets and also to the production of rolls.

This light-uniformizing film can be used as an optical functional material in the backlight system of straight-down LED arrays, especially suitable for Mini LED backlight sources, it is used to improve the lighting shadow problems of high brightness and short OD point-light source arrays. OD represents point-light source to backlight, the distance between the optical film closest to the point-light source in the architecture. Short OD can refer to that which is less than 1 mm or even zero. Compared with existing technology, the light-uniformizing film provided by the present invention can concentrate at the center of the point-light source beam, especially it can reasonably distribute the energy within the beam angle of 30 degrees to other directions, and reduce the energy of the central bright spot on the projection screen, while expanding the overall luminous area, thereby increasing the uniformity of energy distribution to at least 30%.

On the other hand, the present invention provides a concave diffusion light-uniformizing film (priority number: 202111268882.6, case number: 210087). When both the spectral layer and the diffuser layer are arranged in a regular arrangement, interference fringes will be generated between these two layers, which will affect the appearance and assembly effect of the light-uniformizing film. This problem can be solved by modifying the spectral layer or diffuser layer to an irregular structure.

Furthermore, the diffuser layer can be changed to an irregular structure, it may sacrifice some light spreading performance, but it does not affect the separation performance of the optical layer.

In addition, due to the fact that particles of organic particles are mostly polydisperse, scattering is difficult to avoid when the particle size is smaller than a certain scale. Scattering reduces the total reflection ratio of the diffuser layer, and further leads to reduce the total reflection when the mating of the resin and the particle refractive index is poor. Thus, a particle-free diffusion coating can be considered to achieve the reduction upon considering irregular structures.

Furthermore, the irregular structure can be a concave diffuser layer (the concave diffuser layer cannot be achieved through particle coating and can only be achieved through UV transfer printing.

Furthermore, the concave diffuser layer exhibits sharp protrusions at the intersection of many circular arcs, similar to prisms with smaller vortex angles. Thus, the structure has better light spreading effect compared to the diffuser layer of the convex structure.

The present invention provides a concave diffusion light-uniformizing film, which comprises a spectral layer, a substrate layer, and a diffuser layer, the light layer is located on the upper surface of the substrate layer, and the spectral layer is located on the lower surface of the substrate layer. The diffuser layer is a concave diffuser layer.

The concave diffuser layer is a particle-free coating with a haze of 60-98%. The upper surface of the concave diffuser layer has a concave arc surface, the concave arc surfaces intersect to form peaks. The concave arc surface is a downward concave arc surface. The concave are surface is irregular concave arc surface.

The surface smoothness of the spectral layer is high, and the abnormal deviation of light is less. The spectral layer is one of the standard plane spectral layer, convex arc surface spectral layer, and concave arc surface spectral layer. Furthermore, the particle-free coating is composed of transparent polymer resin. The transparent polymer resin is selected from AR with refractive index n₂ is selected from 1.4 to 1.65.

The present invention provides a diffusion light-uniformizing film, comprising a substrate layer 20, a spectral layer 21, and a diffuser layer 22, as shown in FIG. 15, the light-uniformizing film is a concave diffusion light-uniformizing film. The thickness M of the substrate layer 20 is 25-500 μm, for example, 25 μm, 75 μm, 250 μm, 500 μm. The material of the substrate layer is selected from one of PET, PMMA, or PC, and the spectrogram layer is composed of transparent polymer resin, the material of which is a light-cured acrylic resin (AR) with a refractive index n₁ of 1.4-1.65, for example 1.4, 1.5, 1.65, the diffuser layer is composed of transparent polymer resin, and the material is light-cured acrylic resin (AR) with the refractive index n₂ ranges from 1.4 to 1.65, for example, 1.4, 1.5, 1.65. The spectral layer is composed of the long ribs stacked in N different directions. The long ribs are laid flat on the lower surface of the substrate layer, extending infinitely towards both ends, The long ribs in the same direction are tightly arranged, and the topological coefficient N is 1, 2, or 3; When the spectral layer is selected from the standard plane spectral layer, the cross-section of the corresponding long rib isosceles triangle has two finite cut straight lines on both ends, that is, the cross-section of the long ribs is a straight triangle with a vertex angle θ of 60°-120°, such as 60°, 75°, 90°, 105°, 120°. The diffuser layer is a concave diffuser layer (particle-free coating) 228, and the haze of the concave diffuser layer is 60-98%, for example, 60%, 80%, 90%, 95%, 98%. The light-uniformizing performance of the light-uniformizing film is good, with an improvement in uniformity of U=85-272%. When the spectral layer is a convex arc surface spectral layer or a concave arc surface spectral layer, the cross section of its corresponding the long ribs is isosceles triangle with left and right waists which are an outer convex arc line (referred to as convex arc line) and an inner concave arc line (referred to as concave arc line) that are finite cut at both ends, the vertex angle θ is 60°-120°, such as 60°, 120°, and the center angle α is 1-30°, such as 1°, 30°; The diffuser layer is a particle-free diffuser layer 228, and the haze of the diffuser layer is 95%. The light-uniformizing performance of the light-uniformizing film is good, with an improvement in uniformity of U=158-171%. The aforementioned technical solution includes embodiments 81-110.

The present invention provides a preparation method for a concave diffusion light-uniformizing film, a spectral layer is prepared on the back of the substrate layer using micro replication or hot-press molding process and utilizing transparent polymer resin; and a diffuser layer is prepared on the front of the substrate layer using micro replication or hot-press molding process and utilizing transparent polymer resin.

Furthermore, the preparation method of the concave diffusion light-uniformizing film comprises the following steps:
(1) Preparing mold 1 for the spectral layer (the concave long ribs superposed with texture), it is usually machined by polished metal rollers or metal plates through diamond precision carving process, where the shape of the diamond carving knife is the same as the cross-section of the long rib;
(2) Micro replicating or hot-press molding on the back of the substrate layer to produce a spectral layer (the convex long ribs superposed with texture) using mold 1, whereby obtaining semi-finished products containing the spectral layer;
(3) Preparing mold 2 for the diffused layer (with concave diffusion structure), it is usually machined by polished metal rollers or metal plates through processes such as microbeads sandblasting and diamond carving;
(4) Preparing mold 3 for the diffused layer (with convex diffusion structure), metal molds can be obtained by Mold 2 via embossing (through high hardness metal extruding low hardness metals), or the metal molds with convex structures can be electroformed by using optical films of the concave diffusion structures as templates, and the optical film with convex diffusion structure can also be obtained by mold 2 pressing or particle coating and directly act them as soft mold molds;
(5) Micro replicating or hot-press molding on the front of the semi-finished substrate layer to forming a diffuser layer (concave diffuser layer without particle coating), whereby obtaining a concave diffusion light-uniformizing film containing both the spectral layer and the diffuser layer, simultaneously.

The concave diffusion light-uniformizing film can be used in the backlight system of straight-down LED arrays as an optical functional material. Specially it is applicable in Mini LED backlight sources, used to improve the light shadow problems of high brightness and short OD point-light source arrays.

Compared with existing technologies, the concave diffusion light-uniformizing film provided by the present invention can reasonably distribute the energy concentrated at the center of the point-light source beam, especially it can distribute reasonably the energy within the beam angle of 30 degrees to other directions, and reduce the energy of the central bright spot on the projection screen, while expanding the overall luminous surface, thereby increasing the uniformity of energy distribution to at least 85%, and with a good appearance and no interference fringes.

On the other hand, the present invention provides a diffusion light-uniformizing film. (Priority number: 202111272130.7, Case number: 210088)

When both the spectral layer and the diffuser layer are structures in a regular pattern, interference fringes will be generated between these two layers, which will affect the appearance and assembly effect of the light-uniformizing film. This problem can be solved by modifying the spectral layer or diffuser layer to an irregular structure.

Furthermore, the diffuser layer can be changed to an irregular structure, it may sacrifice some light spreading performance, but it does not affect the separation performance of the optical layer.

In addition, due to the fact that organic particles are mostly polydisperse, scattering is difficult to avoid when the particle size is smaller than a certain scale. Scattering will reduce the total reflection ratio of the diffuser layer, and it further causes a decrease in the total reflection when the resin and particle refractive index are in poor mating. Thus, a particle-free diffusion coating can be considered when in consideration of irregular structures.

Furthermore, the irregular structure can be a particle-free diffuser layer.

The present invention provides a diffusion light-uniformizing film, which comprises a spectral layer, a substrate layer, and a diffuser layer. The diffuser layer is located on the upper surface of the substrate layer, the spectral layer is located on the lower surface of the substrate layer, and the diffuser layer is a particle-free diffuser layer with a haze of 60-98%.

The upper surface of the particle-free diffuser layer has convex and concave surfaces, which are arranged alternately. The concave arc surface is a downward concave arc surface. The concave arc surface is an irregular concave arc surface. The convex arc surface is an upward convex concave arc surface. The convex plane is an irregular convex plane. The surface smoothness of the spectral layer is high, the abnormal deviation of light is less.

The spectral layer is one of the standard plane spectral layer, convex arc surface spectral layer, and concave arc surface spectral layer.

Furthermore, the particle-free diffuser layer is composed of transparent polymer resin. The transparent polymer resin is selected from AR, with the reflective index n₂ is selected from 1.4 to 1.65.

The present invention provides a preparation method for a diffusion light-uniformizing film. a spectral layer is prepared on the back of the substrate layer using micro replication or hot-press molding process and utilizing transparent polymer resin; and a diffuser layer is prepared on the front of the substrate layer using photo cured micro replication or hot-press molding process and utilizing transparent polymer resin formula; Wherein, the diffuser layer is a particle-free diffuser layer.

The present invention provides a light-uniformizing film comprising a substrate layer 20, a spectral layer 21, and a diffuser layer 22, as shown in FIG. 16, wherein the light-uniformizing film is a diffusion light-uniformizing film, the thickness M of the substrate layer 20 is 25-500 μm, for example, 25 μm, 75 μm, 250 μm, 500 μm. The material of the substrate layer is selected from one of PET, PMMA, or PC, and the spectrogram layer is composed of transparent polymer resin, the material of which is a light-cured acrylic resin (AR) with a refractive index n₁ of 1.4-1.65, such as 1.4-1.65. The diffuser layer is composed of transparent polymer resin, the material of which is a light-cured acrylic resin (AR) with a refractive index n₂ of 1.4-1.65, for example 1.4, 1.5, 1.65. The spectral layer is composed of the long ribs stacked in N different directions. The lower surface of the layer is flat, with the long ribs extending infinitely towards both ends. The long ribs in the same direction are tightly arranged, and the topological coefficient N is selected from 1, 2, or 3; When the spectral layer is selected from the standard plane spectral layer, the corresponding long rib cross-section isosceles triangle has two finite cut straight lines on both sides, that is, the cross-section of the long rib is a straight triangle with a vertex angle θ of 60°-120°, such as 60°, 75°, 90°, 105°, 120°; The diffuser layer is a particle-free diffuser layer 227, and the haze of the diffuser layer is 60-98%, such as 60%, 80%, 90%, 95%, 98%, the light-uniformizing performance of the light-uniformizing film is good, with a improvement in uniformity range of U=60-164%. When the spectral layer is convex arc surface or concave arc surface spectral layer, whose corresponding long rib cross-section isosceles triangle has an outer convex arc line (referred to as convex arc line) and an inner concave arc line (referred to as concave arc line) with finite truncation of the left and right waists at both ends, and the vortex angle θ of 60°-120°, for example, 60°, 120°, the center angle α of 1-30°, for example 1°, 30°; The diffuser layer is a particle-free diffuser layer 227, and the haze of the diffuser layer is 95%. The light-uniformizing performance of the light-uniformizing film is good, with an improvement in uniformity of U=99-105%. The aforementioned technical solution includes implementation embodiments111-140.

Furthermore, the preparation method of the diffusion light-uniformizing film comprises the following steps:
(1) Preparing mold 1 for the spectral layer (the concave long ribs superposed with texture) is generally obtained by polishing metal rollers or metal plates through diamond precision carving process, where the shape of the diamond carving knife is the same as the cross-section of the long ribs;
(2) Using mold 1 to micro replicate or hot-press molding the back of the substrate layer to produce a spectral layer (the convex long ribs superposed with texture), obtaining a semi-finished product containing the spectral layer;
(3) Preparing mold 2 for the diffuser layer (convex diffusion complementary structure, i.e. concave diffusion structure) is generally obtained by polishing metal rollers or metal plates through processes such as microbead sandblasting and diamond carving;
(4) A diffuser layer (concave diffuser layer without particle coating) is formed by micro replication or hot-press molding on the front of the semi-finished substrate layer, whereby obtaining a concave diffusion light-uniformizing film containing both the spectral layer and the diffuser layer, simultaneously.

The concave diffusion light-uniformizing film can be used in the backlight system of straight-down LED arrays as an optical functional material. Especially it is applicable in Mini LED backlight sources, used to improve the light shadow problems of high brightness and short OD point-light source arrays.

Compared with existing technologies, the concave diffusion light-uniformizing film provided by the present invention can reasonably distribute the energy concentrated at the center of the point-light source beam, especially it can reasonably distribute the energy within the beam angle of 30 degrees to other directions, and reduce the energy of the central bright spot on the projection screen, while expanding the overall luminous surface, thereby increasing the uniformity of energy distribution to at least 85%, and with a good appearance and no interference fringes.

On the other hand, the present invention provides a diffusion light-uniformizing film. (Priority number: 202111270266.4, case number: 210089).

The irregular structure can be a particle diffuser layer.

The present invention provides a diffusion light-uniformizing film, which comprises a spectral layer, a substrate layer, and a diffuser layer, and a diffuser layer located on the upper surface of the substrate layer, the spectral layer is located on the lower surface of the substrate layer, and the diffuser layer is a particle diffuser layer.

Furthermore, the diffuser layer is an irregular structure.

Furthermore, the diffuser layer is a particle diffuser layer with a haze of 60-98%. Furthermore, the particle diffuser layer is an irregular structure.

The surface smoothness of the spectral layer is high, and the abnormal deviation of light is less. The spectral layer is one of the standard plane spectral layer, convex arc surface spectral layer, and concave arc surface spectral layer.

Furthermore, the particle diffuser layer is composed of transparent polymer resin and transparent polymer particles; the particle size of the transparent polymer particles is 1-20 μM.

Furthermore, the transparent polymer resin is selected from PU, with the refractive index n₂ being selected from 1.47 to 1.51. The transparent polymer particles are selected from one or at least two combinations of PMMA, PBMA (butyl methacrylate), PS (polystyrene), PU (polyurethane), nylon, and organosilicon.

The present invention provides a light-uniformizing film comprising a substrate layer 20, spectral layer 21, and a diffuser layer 22, as shown in FIG. 17, wherein the light-uniformizing film is a diffusion light-uniformizing film. The thickness M of the substrate layer 20 is 25-500 μm, for example, 25 μm, 75 μm, 250 μm, 500 μm. The material of the substrate layer is selected from one of PET, PMMA, or PC, and the spectral layer is composed of transparent polymer resin, the material of which is made of light-cured acrylic resin (AR) with a refractive index n₁ of 1.4-1.65, such as 1.4, 1.5, 1.65. The spectral layer is composed of the long ribs stacked in N different directions. The long ribs are laid flat on the lower surface of the substrate layer, extending infinitely towards both ends. The long ribs in the same direction are tightly arranged, and the topological coefficient N is selected from 1, 2, or 3; When the spectral layer is selected from the standard plane, its corresponding to the long rib cross-section of an isosceles triangle, where the left and right waists are finite cut straight lines at both ends, that is, the cross-section of the long rib is a straight triangle with a vertex angle θ of 60°-120°, such as 60°, 75°, 90°, 105°, 120°; The diffuser layer is a particle diffuser layer 226, with a haze of 60-98%, such as 60%, 80%, 90%, and 98%. The particle diffuser layer is composed of transparent polymer resin and transparent polymer particles. The transparent polymer resin is selected from PU, with the refractive index n2being selected from 1.5, the materials of the transparent polymer particles are one of PMMA, PBMA (poly butyl methacrylate), PS (polystyrene), PU (polyurethane), nylon, and organosilicon with a particle size of 1-20 μm. The light-uniformizing performance of the light-uniformizing film is good, and the improvement in uniformity is improved U=55-152%. When the spectral layer is a convex arc surface spectral layer or a concave arc surface spectral layer, its corresponding long rib cross section isosceles triangle has an outer convex arc line (referred to as convex arc line) and an inner concave arc line (referred to as concave arc line) that are finite cut at both ends, with the corresponding left and right waists of the isosceles triangle θ of 60°-120°, such as 60°, 120°, and the center angle α is 1-30°, such as 1°, 30°; The light-uniformizing performance of the light-uniformizing film is good, with an improvement in uniformity of U=92-97%. The aforementioned technical solution includes embodiments 141-175.

The present invention provides a preparation method for a diffusion light-uniformizing film, multiple spectral layer are prepared on the back of the substrate layer by using micro replication or hot-press molding process and utilizing transparent polymer resin; and a diffuser layer is prepared on the front of the substrate layer using the thermal curing coating process and utilizing transparent polymer resin containing particles. Wherein, the diffuser layer is a particle diffuser layer.

Furthermore, the preparation method of the diffusion light-uniformizing film comprises the following steps:
(1) Preparing mold 1 for the spectral layer (the concave long ribs superposed with texture), it is usually machined by polished metal rollers or metal plates through diamond precision carving process, where the shape of the diamond carving knife is the same as the cross-section of the long rib;
(2) Using mold 1 to micro replicate or hot-press molding the back of the substrate layer to produce a spectral layer (the convex long ribs superposed with texture), whereby obtaining a semi-finished product containing a spectral layer;
(3) Applying a diffuser layer (with particle diffuser layer) on the front of the semi-finished substrate layer to obtain a diffusion light-uniformizing film containing both the diffuser layer and the spectral layer, simultaneously;
The diffusion light-uniformizing film can be used as an optical functional material in the backlight system of straight-down LED arrays. Especially suitable for the Mini LED backlight source, it is used to improve the light shadow problems of the point-light source array with high brightness and short OD.

Compared with existing technologies, the diffusion light-uniformizing film provided by the present invention can reasonably distribute the energy concentrated at the center of the point-light source beam, especially it can reasonably distribute the energy within a beam angle of 30 degrees to other directions, and reduce the energy of the central bright spot on the projection screen, while expanding the overall luminous surface, thereby increasing the uniformity of energy distribution to at least 55%, and with a good appearance and no interference fringes.

On the other hand, the present invention provides a triangular pyramid light-uniformizing film. (Priority number: 202111269132.0, case number: 210090)

When the structure surface of the diffuser layer presents more directions, the direction of transmission and refraction is diverse, and the light spreading effect is better, especially when using a pyramid as the light spreading structure, since the dense arrangement of the triangular prisms, their vertices are arranged in a equilateral triangle, with each adjacent two triangles is a pyramid formed by two opposing triangles in the top view, so for a pyramid, the structural surface. There are actually six types (as shown in al˜a3 and b1˜b3 in FIG. 18). This has more advantages in spreading lights compared to the four surfaces of the quadrangular pyramid structure (adjacent quadrangular pyramid is the same, which has only four identical surfaces (as shown in cl˜c4 in FIG. 18).

The present invention provides a triangular prism light-uniformizing film, which comprises a spectral layer, a substrate layer, and a diffuser layer. The diffuser layer is located on the upper surface of the substrate layer, and the spectral layer is located on the lower surface of the substrate layer.

The surface smoothness of the spectral layer is high, and the abnormal deviation of light is less. The spectral layer is one of the standard plane spectral layer, convex arc surface spectral layer, and concave arc surface spectral layer. The diffuser layer is a triangular pyramid layer, formed by overlying flat the triangular pyramids, and the vertices of the triangular pyramids form an equilateral triangle arrangement. The height T of the pyramid is 10-50 μm. The angle between the side and the height γ is 30˜60°.

The triangular pyramid layer is formed by overlying flat a triangular pyramid, and the vertices of the triangular pyramid form an equilateral triangle arrangement. The height T of the pyramid ranges from 10 to 50 μm. The angle between the side and the height γ is 30˜60°.

The triangular pyramid is an upward convex triangular pyramid.

The triangular pyramids are tightly arranged. The triangle formed by the three base edges adjacent two triangular prisms is presented a prism formed by two opposing triangles in the top view. Furthermore, the triangular pyramid layer is composed of transparent polymer resin. The transparent polymer resin is selected from AR, with a refractive index N2 is selected from 1.4 to 1.65.

The present invention provides a preparation method for a triangular pyramid light-uniformizing film, characterized in that a spectral layer is prepared on the back of the substrate layer using micro replication or hot-press molding process and utilizing transparent polymer resin; a diffuser layer is prepared on the front of the substrate layer using micro replication or hot-press molding and utilizing transparent polymer resin; Wherein, the diffuser layer is a triangular pyramid layer.

The present invention provides a light-uniformizing film comprising a substrate layer 20, a spectral layer 21, and a diffuser layer 22, as shown in FIG. 18. The light-uniformizing film is a triangular prism light-uniformizing film. The thickness M of the substrate layer 20 is 25-500 μm, for example, 25 μm, 75 μm, 250 μm, 500 μm. The material of the substrate layer is selected from one of PET, PMMA, or PC, and the spectral layer is made of transparent polymer resin, the material is light-cured acrylic resin (AR) with a refractive index n₁ of 1.4-1.65, such as 1.4, 1.5, 1.65. The diffuser layer is composed of transparent polymer resin, the material of which is light-cured acrylic resin (AR), and the refractive index n₂ is 1.4-1.65, such as 1.4, 1.5, 1.65. The spectral layer is composed of the long ribs stacked in N directions. The long ribs are laid flat on the lower surface of the substrate layer, extending infinitely towards both ends, the long ribs in the same direction are tightly arranged, and the topological coefficient N is selected from 1 and 2 or 3. When the spectral layer is selected from the standard plane spectral layer, the isosceles triangle of its corresponding long rib cross-section has left and right waists, which are straight lines with finite cuts at both ends, respectively, i.e. the cross-section of the long rib is a straight triangle with a vertex angle θ of 60°-120°, such as 60°, 75°, 90°, 105°, 120°. The diffuser layer is a triangular pyramid layer 223, which is laid flat by a triangular pyramids, and the vertices of the triangular pyramids form an equilateral triangle arrangement, the height T of the pyramid is 10-50 μm, for example, 10 μm, 20 μm, 30 μm, 40 μm, 50 μm. The angle between the side and the height γ is 30°-60°, for example, 30°, 45°, 60°. The light-uniformizing performance of the light-uniformizing film is good, with an improvement in uniformity U=75-681%. When the spectral layer is a convex arc surface spectral layer or a concave arc surface spectral layer, its corresponding long rib cross section is an isosceles triangle, with an outer convex arc line (referred to as convex arc line) and an inner concave arc line (referred to as concave arc line) that are finite cut at both ends, with the corresponding left and right waists of the isosceles triangle θ of 60°-120°, such as 60°, 120°, and the center angle α is 1-30°, such as 1°, 30°; The light-uniformizing performance of the light-uniformizing film is good, with an improvement in uniformity of U=89-126%. The aforementioned technical solution includes embodiments 176-205.

Furthermore, the preparation method of the triangular prism light-uniformizing film comprises the following steps:
(1) Preparing mold 1 for the spectral layer (the concave long ribs superposed with texture), it is usually machined by polished metal rollers or metal plates passed through diamonds obtained through precision carving process, where the shape of the diamond carving knife is the same as the cross-section of the long rib;
(2) Micro replicating or hot-press molding on the back of the substrate layer to produce a spectral layer (the convex long ribs superposed with texture) using mold 1, whereby obtaining a semi-finished product containing the spectral layer;
(3) Preparing mold 2 for the diffuser layer (convex triangular pyramid structure), it is usuallymachined by polished metal rollers or metal plates through diamond precision carving process;
(4) Preparing mold 3 for the diffuser layer (concave triangular pyramid structure), it can be embossed (by high hardness metal extruding the low hardness metal) by mold 2 to obtain a metal mold, or the metal mold with a concave structure can be electroformed using an optical film with a convex structure as a template, or the optical film with a concave structure can be obtained by embossing with the mold 2 and directly used it as a soft mold 3;
(5) Micro replicating or hot-press molding on the front of the semi-finished substrate layer to produce the diffuser layer (convex triangular pyramid structure) using mold 3, whereby obtaining a triangular pyramid light-uniformizing film containing both the spectral layer and the diffuser layer, simultaneously;
The triangular prism light-uniformizing film can be used as an optical functional material in the backlight system of straight-down LED arrays, especially applicable to the Mini LED backlight source, it is used to improve the light shadow problems of high brightness and short OD point-light source arrays.

Compared with existing technologies, the triangular prism light-uniformizing film provided by the present invention can reasonably distribute the energy concentrated at the center of the point-light source beam, especially it can distribute the energy within a beam angle of 30 degrees to other directions, and reduce the energy of the central bright spot on the projection screen, while expanding the overall luminous surface, thereby increasing the uniformity of energy distribution to at least 75%, with a good appearance and no interference fringes.

On the other hand, the present invention provides an atomization light-uniformizing film. (Priority number: 202111587097.7, case number: 210113).

In some special occasions, the spectral layer can be designed as a rough surface, that is, to prepare an atomized spectral layer that not only has the function of beam deflection, but also has the function of beam diffusion. Compared to the planar light-uniformizing film, the uniform effect is better, and this design can keep the upper surface of the substrate layer still blank for lamination or more structural designs.

The present invention provides an atomization light-uniformizing film, which comprises an atomization spectral layer, a substrate layer, and a diffuser layer, the light layer is located on the upper surface of the substrate layer, and the spectral layer is located on the lower surface of the substrate layer, and the surface of the spectral layer is rough. Beams passing through atomization light-uniformizing film can undergo deflection and diffusion, simultaneously.

The spectral layer is an atomized spectral layer with a rough surface.

Furthermore, the surface roughness of the atomized spectral layer is Ra=2-10 μm. It can be selected from one of the three ranges2-3 μm, 3-5 μm or 5-10 μm.

The atomization spectral layer is composed of the long ribs stacked in N different directions, where N is the topological coefficient. The long ribs are laid flat on the lower surface of the substrate, with the long ribs extending infinitely towards both ends. The long ribs in the same direction are tightly arranged, and the N directions divide the 360 degree azimuth equally, that is, each of the angle interval between adjacent directions is 180/N degrees, and N is selected from 1, 2, or 3.

Furthermore, the atomization spectral layer is a concave rough surface spectral layer or a convex rough surface spectral layer.

Furthermore, the atomization spectral layer is a concave rough surface spectral layer, and the cross-section of the long ribs in the concave rough surface spectral layer is an approximate isosceles triangle (the coordinates of three vertices form the position distribution of the isosceles triangle, as shown in FIGS. 19 and 20), and the left and right waist are concave rough lines with finite cuts at both ends, with the bottom edge being a straight line and the bottom edge W₁ is ranging from 10 to 100 μm, with the vertex angle θ of 60° to 120°. The concave rough line has a concave arc. Furthermore, the concave rough line is composed of densely arranged concave arcs. A concave circular structure is positioned on the surface of the long rib.

Furthermore, the radius and number of concave arcs in the concave arc of the concave rough line are not limited, and each can meet the surface roughness of the spectral layer.

Furthermore, the atomization spectral layer is a convex rough surface spectral layer, and the long rib cross-section in the convex rough surface spectral layer is an approximate isosceles triangle (the position distribution of the isosceles triangle is formed by the coordinates of three vertices, as shown in FIGS. 21 and 22). The left and right waists are convex rough lines with finite cuts at both ends, with the bottom edge being a straight line and the bottom edge W₁ is ranging from 10 to 100 μm, with the vortex angle θ of 60° to 120°. The concave rough line has a concave arc. Furthermore, the concave rough line is composed of densely arranged concave arcs. A concave circular structure is positioned on the surface of the long rib.

Furthermore, the radius and number of convex arcs in the convex rough line are not limited and each can meet the surface roughness of the spectral layer.

The present invention provides an atomization light-uniformizing film, comprising a substrate layer 20 and an atomized spectral layer 212, as shown in FIG. 20. The thickness M of the substrate layer 20 is 25-500 μm, for example, 25 μm, 75 μm, 100 μm, 125 μm, 250 μm, or 500 μm. The material of the substrate layer is selected from one of PET, PMMA, or PC; The spectral layer is composed of transparent polymer resin, the material of which is one of light-cured acrylic resin (AR), PMMA or PC, with a refractive index n₁ of 1.4-1.65, such as 1.4, 1.5, 1.58 or 1.65; The atomized spectral layer is a concave rough surface spectral layer (as shown in FIG. 19), with a rough surface and a line roughness Ra of 2-10 μm, for example, 2-3 μm, 3-5 μm, 5-10 μm; The spectral layer is composed of the long ribs stacked in N directions, the long ribs are laid flat on the lower surface of the substrate layer. The long ribs extend infinitely towards both ends, and the long ribs in the same direction are tightly arranged, with a topological coefficient N of 1, 2, or 3; The spectral layer is selected from the standard plane spectral layer, and the cross section of the long rib isosceles triangle corresponding to the standard plane spectral layer has left and right waists being finite cut straight lines at both ends, that is, the cross section of the long rib is an equilateral triangle shape with the vortex angle θ of 60°-120°, such as 60°, 75°, 90°, 105°, or 120°. The light-uniformizing performance of the atomization light-uniformizing film is good, with an improvement in uniformity range of U=50-187%. The aforementioned technical solution includes embodiments 206-235.

The present invention provides an atomization light-uniformizing film, comprising a substrate layer 20 and an atomized spectral layer 211, as shown in FIG. 22. The thickness M of the substrate layer 20 is 25-500 μm, for example, 25 μm, 75 μm, 100 μm, 125 μm, 250 μm, or 500 μm, the material of the substrate layer is selected from one of PET, PMMA, or PC; The spectral layer is composed of transparent polymer resin, the material is made of one of light-cured acrylic resin (AR), PMMA or PC, with a refractive index n₁ of 1.4-1.65, for example, 1.4, 1.5, 1.58 or 1.65; The atomization separation layer is a convex rough surface separation layer (as shown in FIG. 21), and the surface of the atomization separation layer is rough, with a line roughness Ra of 2-10 μm, for example, 2-3 μm, 3-5 μm, 5-10 μm; the spectral layer is composed of the long ribs stacked in N different directions, and the long ribs are laid flat on the lower surface of the substrate layer. The long ribs extend infinitely towards both ends, with the long ribs in the same direction being tightly arranged, with a topological coefficient N of 1, 2, or 3; The spectral layer is selected from the standard plane spectral layer, and the cross section of the long rib isosceles triangle corresponding to the standard plane spectral layer has left and right waists being finite cut straight lines at both ends, that is, the cross section of the long rib is an equilateral triangle shape with the vortex angle θ of 60°-120°, such as 60°, 75°, 90°, 105°, or 120°. The light-uniformizing performance of the atomization light-uniformizing film is good, with an improvement in uniformity range of U=43-174%. The aforementioned technical solution includes embodiments 236-265.

The present invention provides a preparation method for an atomization light-uniformizing film, an atomization spectral layer is prepared on the back of the substrate layer using micro replication or hot-pressing molding process and utilized the transparent polymer resin.

Furthermore, the preparation method of the atomization light-uniformizing film comprises the following steps:
(1) Preparing mold 1 for the spectral layer (the concave long ribs superposed with texture), it is usually machined by polished metal rollers or metal plates through diamond precision carving process, wherein the shape of the diamond carving knife is the same as the cross-section of the long rib;
(2) Transferring the mold 1 to produce a soft mold 1through UV molding (the convex long ribs superposed with texture), and perform two times of electroforming to obtain a metal Master 1;
(3) Sandblasting treatment of the metal master plate 1, which can generally be carried out using glass microbead to impact pits, and the smooth surface is immediately transformed into a rough surface, whereby obtaining a metal master plate 2 with atomization treatment (the convex long ribs superimposed with texture and dense dent structure);
(2) Transferring the metal master plate 2 through texture and wrapping the roller to obtain mold 2 (the concave long ribs superposed with texture and dense convex structure);
(3) Micro replicating or hot-press molding on the back of the substrate layer to produce an atomization spectral layer (the convex long ribs superposed with texture and dense protrusion structure) using mold 2, whereby obtaining an atomization light-uniformizing film containing the atomized spectral layer and the substrate layer.

Alternatively, the preparation method of the atomization light-uniformizing film comprises the following steps:
(1) Preparing mold 1 for the spectral layer (the concave long ribs superposed with texture), it is usually machined by polished metal rollers or metal plates through diamond precision carving process, where the shape of the diamond carving knife is the same as the cross-section of the long rib;
(2) Sandblasting treatment of mold 1, which can generally be carried out using glass microbead to impact pits, and the smooth surface is immediately transformed into a rough surface, whereby obtaining mold 2 with atomization treatment;
(3) Micro replicating or hot-press molding on the back of the substrate layer to produce an atomization spectral layer (the convex long ribs superposed with texture and dense protrusion structure) using mold 2 with the atomization treatment, whereby obtaining an atomization light-uniformizing film containing the atomized spectral layer and the substrate layer.

The atomization light-uniformizing film provided by the present invention can be used as an optical functional material in the backlight system of a straight-downLED array, especially suitable for Mini LED backlight sources, used to improve the light shadow problems of high brightness and short OD point-light source arrays.

Compared with existing technologies, the atomization light-uniformizing film provided by the present invention can concentrate on the center of the point-light source beam, especially it can reasonably distribute the energy within 30 degree angle to other directions and reduce the energy of the central bright spot on the projection screen, expanding the overall luminous surface, thereby increasing the uniformity of energy distribution by at least 43%.

On the other hand, the present invention provides an orthogonal prism light-uniformizing film. (Priority number: 202210320342.6, case number: 220010). When the diffuser and spectral layer are of the specific structure, the matching angle between them has a certain impact on the light-uniformizing performance, and the influence of the matching angle becomes greater on the central beam for the most concentrated light source. When the topological coefficient of the diffuser layer N=1 (the extension direction of the long rib of the diffuser layer is ω₁), the diffuser layer is a prism layer (the extension direction of the prism rib isω₄), the matching angle Δω(Δω=ω₄−ω₁) of the diffuser layer and the diffuser layer is 0/15/30/45/60/75/90 degrees, and when the light-uniformizing film is placed on four light sources with 60 degree beam angles, it can be found that the changes of the illuminance distribution are as shown in FIG. 25, and the changes of the RSD are as shown in FIG. 26. As can be seen, as Aw increases from 0 to 90 degrees, the light-uniformizing effect on the illuminance map continuously improves and the RSD continuously decreases.

The present invention provides an orthogonal prism light-uniformizing film, which comprises a spectral layer, a substrate layer, and a diffuser layer, the diffuser layer is located on the upper surface of the substrate layer, and the spectral layer is located on the lower surface of the substrate layer.

The surface smoothness of the spectral layer is high, and the abnormal deviation of light is less.

The spectral layer is one of the standard plane spectral layer, convex arc surface spectral layer, and concave arc surface spectral layer.

The topological coefficient N of the spectral layer is 1.

The extension direction ω₁ of the long rib of the spectral layer can be set to 0 degree. The light amplifying layer is an orthogonal prism layer, and the extension direction ω₄ of the triangular prism rib is perpendicular or nearly perpendicular to the extension direction ω₁ of the long rib of the diffuser layer. The matching angle of the two directions Δω=ω₄−ω₁, Δω is 75˜105°, and Δω preferably is 90°;

The orthogonal prism layer is laid flat by ribs of the triangular prism, and the cross-section of the ribs of the triangular prism is an isosceles triangle, the bottom edge V is 10-100 μm, and the vortex angle β is 60˜120°.

Furthermore, the orthogonal prism layer is composed of transparent polymer resin. The transparent polymer resin is selected from AR and the refractive index n₂ is selected from 1.4 to 1.65.

Furthermore, the present invention provides an orthogonal prism light-uniformizing film, wherein the orthogonal prism light-uniformizing film comprises a spectral layer and a substrate layer and diffuser layer, the diffuser layer is located on the upper surface of the substrate layer, and the spectral layer is located on the lower surface of the substrate layer; the spectral layer comprises long ribs, the diffuser layer is an orthogonal prism layer, and the orthogonal prism layer includes several triangular prism ribs. The extension direction of the triangular prism ribs is ω₄ and the extension direction of the long ribs of the diffuser layer isw₁. The matching angle of the two directions Δω=ω₄−ω₁, Δω is 75˜105°.
Furthermore, in the orthogonal prism light-uniformizing film, the spectral layer is composed of the long ribs stacked in N different directions, where N is the topological coefficient. The topological coefficient N of the spectral layer is 1, and the spectral layer is one of the standard plane spectral layer, the convex arc surface spectral layer, and the concave surface spectral layer.
Furthermore, in the orthogonal prism light-uniformizing film, the orthogonal prism layer is laid flat by triangular prism ribs, and the cross-section of the triangular prism rib is an isosceles triangle, and the base edge V of the triangle is 10-100 μm with the vortex angle β being 60˜120°.
Furthermore, in the orthogonal prism light-uniformizing film, the orthogonal prism layer is composed of transparent polymer resin; The transparent polymer resin is selected from AR, with a refractive index n₂ of 1.4˜1.65; the spectral layer is composed of the long ribs stacked in N different directions, N is the topological coefficient, and the long ribs are laid flat on the lower surface of the substrate. The long ribs extend infinitely towards both ends, the ribs in the same direction are tightly arranged, the N directions dividing the 360 degree azimuth equally, that is, the angle interval between adjacent directions is 180/N degrees, and N is 1; The cross sections of the long ribs in the spectral layer are the same, all of which are isosceles triangles. The left and right waists are one of finite cut straight lines at both ends, outer convex arc or inner concave arc, with the bottom edge being a straight line and the bottom edge W₁ ranging from 10 to 100 μm. The vortex angle θ is 60˜120°; The degree of curvature of the outer convex and the inner concave curves is represented by the center angle, the center angle α is 1˜30°; The spectral layer is one of the standard plane spectral layer, convex arc surface spectral layer, or concave arc surface spectral layer, and its corresponding long rib cross-section is isosceles, with the left and right waists being one of straight lines with finite cuts at both ends, an outer convex arc, or an inner concave arc, respectively.

The present invention provides a light-uniformizing film comprising a substrate layer 20, a spectral layer 21, and a diffuser layer 22, as shown in FIGS. 23 and 24, wherein the light-uniformizing film is an orthogonal prism light-uniformizing film. The thickness M of the substrate layer 20 is 25-500 μm, for example, 25 μm, 75 μm, 250 μm, 500 μm. The material of the substrate layer is selected from one of PET, PMMA, or PC, and the spectral layer is composed of transparent polymer resin, the material of which is made of light-cured acrylic resin (AR), with a refractive index n₁ of 1.5, and the diffuser layer is composed of transparent polymer resin, the material of which is made of light-cured acrylic resin (AR) with a refractive index n₂ of 1.4-1.65, such as 1.4, 1.5, 1.65. The spectral layer is composed of the long ribs stacked in N directions. The long ribs are laid flat on the lower surface of the substrate layer, extending infinitely towards both ends. The long ribs in the same direction are tightly arranged, and the topological coefficient N is 1. When the spectral layer is selected from the standard plane spectral layer, its corresponding long rib cross-section is an isosceles triangle, with the left and right waists are finite cut straight lines, that is, the cross-section of the long ribs is a straight triangle, with a vertex angle θ of 60°-120°, such as 60°, 75°, 90°, 105°, 120°. The diffuser layer is an orthogonal prism layer 223, which is laid by the triangular prism ribs. The cross-section of the triangular prism ribs is an isosceles triangle, and the bottom edge V of the triangle is 10-100 μm, for example, 10 μm, 25 μm, 50 μm, 75 μm, 100 μm, with the vortex angle β being 60°-105°, such as 60°, 75°, 80°, 85°, 90°, 105°. The matching angle Δω(i.e., ω₄−ω₁) between the diffuser and the spectral is 70°-105°, such as 75°, 90°, 105°. The light-uniformizing performance of the light-uniformizing film is good, with an improvement in uniformity of U=186-955%.

When the spectral layer is a convex arc spectral layer or a concave arc spectral layer, its corresponding long rib cross-section is an isosceles triangle, with left and right waists being the outer convex arc (referred to as convex arc edge) and inner concave arc (referred to as concave arc edge) with finite cut at both ends, respectively; and the vortex angle θ is 75°, the center angle α is 1-30°, such as 1°, 30°; The light-uniformizing performance of the light-uniformizing film is good, with an improvement in uniformity of U=843-950%. The aforementioned technical solution includes embodiments 266-288.

The present invention provides a preparation method for an orthogonal prism light-uniformizing film, a spectral layer is prepared on the back of the substrate layer using micro replication or hot-press molding process and utilizing transparent polymer resin, and a diffuser layer is prepared on the front of the substrate layer using micro replication or hot-press molding process and utilizing transparent polymer resin; Wherein, the diffuser layer is an orthogonal prism layer.

Furthermore, the preparation method of the orthogonal prism light-uniformizing film comprises the following steps:
(1) Preparing mold 1 for the spectral layer (the concave long ribs superposed with texture), which is usually machined by polishing metal rollers or metal plates through diamond precision carving process, the shape of the diamond carving knife is the same as the cross-section of the long rib, and the carving direction or extension directionω1 is 0 degree;
(2) Micro replicating or hot-press molding on the back of the substrate layer to produce a spectral layer (the convex long ribs superposed with texture) using mold 1, whereby obtaining a semi-finished product containing the spectral layer;
(3) Preparing mold 2 for the diffuser layer (with concave triangular prism structure), it is usually machined by polished metal rollers or metal plates through diamond precision carving process, the carving direction or extension directionω4 isω1+Δω;
(4) Micro replicating or hot-press molding on the front of the semi-finished substrate layer to produce a diffuser layer (with convex triangular prism structure) using mold 2, whereby obtaining an orthogonal prism light-uniformizing film containing both the spectral layer and the diffuser layer;
The orthogonal prism light-uniformizing film can be used as an optical functional material in the backlight system of straight-down LED arrays, especially suitable used in the MiniLED backlight sources, to improve the light shadow problems of high brightness and short OD point-light source arrays.

Compared with existing technologies, the orthogonal prism light-uniformizing film provided by the present invention can reasonably distribute the energy concentrated at the center of the point-light source beam, especially it can distribute the energy within a beam angle of 30 degrees to other directions, and reduce the energy of the central bright spot on the projection screen, expand the overall luminous area, whereby improving the uniformity of energy distribution by at least 186%, and has a good appearance without interference fringes.

On the other hand, the present invention provides an oblique prism light-uniformizing film. (Priority number: 202210322327.5, case number: 220011)

Research has found that, when the diffuser and spectral layer are of the specific structure, the matching angle between them has a certain impact on the light-uniformizing performance, and the influence of the matching angle becomes greater on the central beam for the most concentrated light source. When the topological coefficient of the diffuser layer N=2 (the extension directions of the long ribs of the diffuser layer are ω₁, ω₂, respectively), the diffuser layer is a prism layer (the extension direction of the prism ribs isω4), and the matching angle Δω(Δω=ω₄−ω₁) between the diffuser layer and the spectral layer is 0/15/30/45 degrees, when the light-uniformizing film is placed on four light sources with 20 degree beam angles, it can be found that the changes of the illuminance distribution are as shown in FIG. 29, and the changes of the RSD are as shown in FIG. 30. As can be seen, as Δω increases from 0 to 45 degrees, the uniformity effect on the illuminance map continuously improves and the RSD continuously decreases.

The present invention provides an oblique prism light-uniformizing film, which comprises a spectral layer, a substrate layer, and a diffuser layer, the diffuser layer is located on the upper surface of the substrate layer, and the spectral layer is located on the lower surface of the substrate layer. The surface smoothness of the spectral layer is high, and the abnormal deviation of light is less.

The spectral layer is one of the standard plane spectral layer, convex arc surface spectral layer, and concave arc surface spectral layer.

The topological coefficient N of the spectral layer is 2.

The extension direction ω₁ of the long rib of the spectral layer can be set to 0 degree, andω₂ to 90 degrees.

The diffuser layer is a diagonal prism layer, and the direction of the extension of the triangular prism ribs ω₄ and the direction of the extension of the long ribs of the spectral layerω₁/ω₂are diagonal at 45 degrees, the matching angle of the two directions Δω=ω₄−ω₁, Δω is 30˜60°, preferably 45°.

The oblique prism layer is laid flat by triangular prism ribs, and the cross-section of the triangular prism ribs is an isosceles triangle, the bottom edge V is 10-100 μm, and the vortex angle β is 60˜120°.

Furthermore, the oblique prism layer is composed of transparent polymer resin. The transparent polymer resin is selected from AR and the refractive index n₂ is selected from 1.4 to 1.65.

The present invention provides an oblique prism light-uniformizing film, which comprises a spectral layer, a substrate layer, and a diffuser layer. The diffuser layer is located on the upper surface of the substrate layer, and the spectral layer is located on the lower surface of the substrate layer; The spectral layer is composed of the long ribs stacked in N different directions, N is 2; the diffuser layer is a diagonal prism layer, which includes several triangular prism ribs, and the extension direction of the triangular prism ribs is ω₄, the extension direction of the long rib of the spectral layer is ω₁ andω₂, and the matching angle Δω=ω₄−ω₁ in both directions of the prism rib and the long rib is 30˜60°. The spectral layer is one of the standard plane spectral layer, convex arc surface spectral layer, or concave arc surface spectral layer.

Furthermore, in the oblique prism light-uniformizing film, the oblique prism layer is laid flat by triangular prism ribs. The cross-section of the triangular prism ribs is an isosceles triangle, and the bottom edge V of the isosceles triangle is 10-100 μm, with the vortex angle β of 60˜120°. The extension direction ω₁ of the long rib in the spectral layer can be set to 0°, and w₂ to 90°.

Furthermore, in the oblique prism light-uniformizing film, the oblique prism layer is composed of transparent polymer resin; the transparent polymer resin is selected from AR, and the refractive index n₂ is selected from 1.4˜1.65; the spectral layer is composed of the long ribs stacked in N different directions, where N is the topological coefficient. The long ribs are laid flat on the lower surface of the substrate, extending infinitely towards both ends. The long ribs in the same direction are tightly arranged, and the 360 degree azimuth angle is equally divided in N directions. That is, the angle interval between adjacent directions is 180/N degrees, and N is 2; The cross-section of the long ribs in the spectral layer is the same, all of which are isosceles triangles, with the left and right waists are one of finite cut straight lines at both ends, outer convex arc or inner concave arc, with the bottom edge being a straight line and the bottom edge W₁ ranging from 10 to 100 μm. The vortex angle θ is 60˜120°; The degree of curvature of the convex and concave curves is represented by the center angle, the center angle α is 1˜30°; The spectral layer is one of the standard plane spectral layer, convex arc surface spectral layer, or concave arc surface spectral layer, and its corresponding long rib cross-section is isosceles triangle, with the waists being one of straight lines with finite cuts at both ends, an outer convex arc, or an inner concave arc, respectively.

The present invention provides a light-uniformizing film comprising a substrate layer 20, a spectral layer 21, and a diffuser layer 22, as shown in FIGS. 27 and 28. The light-uniformizing film is an oblique prism light-uniformizing film. The thickness M of the substrate layer 20 is 25-500 μm, for example, 25 μm, 75 μm, 250 μm, 500 μm. The material of the substrate layer is selected from one of PET, PMMA, or PC. The spectral layer is composed of transparent polymer resin, the material of which is a light-cured acrylic resin (AR) with a refractive index n₁ of 1.5. The diffuser layer is composed of transparent polymer resin, the material of which is a light-cured acrylic resin (AR) with a refractive index n₂ of 1.4-1.65, such as 1.4, 1.5, 1.65. The spectral layer is composed of the long ribs stacked in N different directions, which are laid flat on the lower surface of the substrate layer. The long ribs extend infinitely towards both ends, and the long ribs in the same direction are tightly arranged. The topological coefficient N is 2, that is, biaxial spectral separation, wherein ω₁ and ω₂ are perpendicular. When the spectral layer is selected from the standard plane spectral layer, the cross-section of its corresponding long rib is an isosceles triangle, with left and right waists being finite cut straight lines on both sides, that is, the cross-section of the long ribs is a straight triangle with a vertex angle θ of 60°-120°, such as 60°, 75°, 90°, 105°, 120°. The diffuser layer is a diagonal prism layer 223, which is laid flat by the prism ribs. The cross-section of the prism ribs is an isosceles triangle, and the bottom edge V of the triangle is 10-100 μm, for example, 10 μm, 25 μm, 50 μm, 75 μm, 100 μm, with the vortex angle β of 60°-105°, such as 60°, 75°, 80°, 85°, 90°, 105°. The matching angle Δω(i.e., ω₄−ω₁) of the diffuser layer and the spectral layer is 30°-60°, such as 30°, 45°, 60°. The light-uniformizing performance of the light-uniformizing film is good, with an improvement in uniformity of U=167-601%. When the spectral layer is a convex arc surface spectral layer or a concave arc surface spectral layer, the cross section of its corresponding long rib is an isosceles triangle, with left and right waists being an outer convex arc line (referred to as convex arc edge) and an inner concave arc line (referred to as concave arc edge) that are finite cut at both ends, the vortex angle θ is 75°, with a center angle of 1-30°, such as 1°, 30°; The light-uniformizing performance of the light-uniformizing film is good, with an improvement in uniformity of U=544-601%. The aforementioned technical solution includes embodiments 289-311.

The present invention provides a preparation method for an oblique prism light-uniformizing film. a spectral layer is prepared on the back of the substrate layer using micro replication or hot-press molding process and utilizing a transparent polymer resin, and a diffuser layer is prepared on the front of the substrate layer using a micro replication or hot-press molding process and utilizing transparent polymer resin; Wherein, the diffuser layer is a diagonal prism layer.

Furthermore, the preparation method of the oblique prism light-uniformizing film comprises the following steps:
(1) Preparing mold 1 for the spectral layer (with concave long rib texture), it is usually made of polished metal rollers or metal plates through diamond precision carving process, where the shape of the diamond carving knife is the same as the cross-section of the long rib, and the carving direction or extension directionω₁ is 0 degree; ω₂ is 90 degrees.
(2) Micro replicating or hot-press molding on the back of the substrate layer to produce a spectral layer (with convex long rib texture) using mold 1, whereby obtaining a semi-finished product containing the spectral layer;
(3) Preparing mold 2 for the diffuser layer (with concave triangular prism structure), it is usually machined by polished metal rollers or metal plates through diamond precision carving process, the carving direction or extension direction ω₄ is ω₁+Δω;
(4) Micro replicating or hot-press molding on the front of the semi-finished substrate layer to produce a diffuser layer (convex triangular prism structure) using mold 2, whereby obtaining a oblique prism light-uniformizing film containing both the spectral layer and the diffuser layer; The oblique prism light-uniformizing film can be used as an optical functional material in the backlight system of straight-down LED arrays, especially suitable used in Mini LED backlight sources to improve the light shadow problems of high brightness and short OD point-light source arrays.

Compared with existing technologies, the oblique prism light-uniformizing film provided by the present invention can reasonably distribute the energy concentrated at the center of the point-light source beam, especially it can distribute the energy within a beam angle of 30 degrees to other directions, and reduce the energy of the central bright spot on the projection screen, expand the overall light area, thereby improving the uniformity of energy distribution by at least 167%, and has a good appearance without interference fringes.

### DESCRIPTION OF THE FIGURES

FIG. 1 shows a comparison of typical uniform effects of diffusion film/light-uniformizing film (a light source, b light source+diffusion film, c light source+light-uniformizing film);

FIG. 2 is the schematic diagram of the architecture for evaluating the light-uniformizing performance of the light-uniformizing film;

FIG. 3 shows the evaluation method for the spectral effect of the light-uniformizing film (a sphericalcoordinate system, b Lambertian light source, c Lambertian light source+light-uniformizing film);

FIG. 4 shows the composition and cross-sectional schematic diagram of the light-uniformizing film (a substrate layer+spectral layer, b substrate layer+spectral layer+diffused layer);

FIG. 5 shows the schematic diagram of principle of the spectral action (a) and principle of light spreading (b);

FIG. 6 shows the design principle of long rib stacking (N=1) in the spectral layer (a the long rib stacking manner, b the spectral structure details, c the spectral effect, d enlargement of details of the spectral effect;

FIG. 7 shows the design principle of long rib stacking (N=2) in the spectral layer (a the long rib stacking manner, b the spectral structure details, c the spectral effect, d enlargement of details of the spectral effect;

FIG. 8 shows the design principle of long rib stacking (N=3) in the spectral layer (a the long rib stacking manner, b the spectral structure details, c the spectral effect d enlargement of details of the spectral effect;

FIG. 9 shows the schematic diagram of the long ribs with different shapes and cross-sections (a three types of three-dimensional views, b the cross section of the outer convex arc edge triangle, c) cross section of the straight edge triangle d, the cross section of the concave arc side triangle);

FIG. 10 is the schematic diagram of the three-dimensional structure of a planar light-uniformizing film;

FIG. 11 shows the three-dimensional structure of a prism light-uniformizing film and the schematic diagram of the cross-section of the prism ribs;

FIG. 12 shows the three-dimensional structure of a cylinder light-uniformizing film and the schematic diagram of the cross-section of cylindrical lens;

FIG. 13 shows the schematic diagram of the three-dimensional structure of the pyramid light-uniformizing film and the quadrangular pyramid structure;

FIG. 14 shows the three-dimensional structure of the micro lens light-uniformizing film and the structural schematic diagram of the micro lens;

Wherein:
0: LED light board; 1: LED; 2: Light-uniformizing film; 3: Absorption screen; 20: Substrate layer; 21: Spectral layer; 22: Diffuser layer; 40: Input light; 411: Penetrating light; 412: Recycled light; 42: Output light; 43: Secondary input light; 50: Ridges of the long ribs/short ribs; 51: Gorges between the long ribs/short ribs; 221: Prism structure; 222: Cylinder structure; 224: Quadrangular pyramid structure; 225: Microlens structure.

FIG. 15 is the schematic diagram of the cross-section of the concave diffusion light-uniformizing film (with the diffuser layer being the concave diffuser layer);
Wherein: 221: Prism layer; 222: Cylinder layer; 224: Quadrangular pyramid layer; 225: Microlens layer; 228: Concave diffuser layer (particle-free coating).

FIG. 16 is the schematic diagram of the cross-section of the diffusion light-uniformizing film (with the diffuser layer being the particle-free diffuser layer);
Wherein: 221: Prism layer; 222: Cylinder layer; 224: Quadrangular pyramid layer; 225: Microlens layer; 227: Particle-free diffuser layer.

FIG. 17 is the schematic diagram of the cross-section of the diffusion light-uniformizing film (with the diffuser layer being a particle diffuser layer).
Wherein: 221: Prism layer; 222: Cylinder layer; 224: Quadrangular pyramid layer; 225: Microlens layer; 226: a particle diffuser layer.

FIG. 18A shows the schematic diagram of different structural planes of the triangular pyramid (6 types of triangular pyramid al˜a3, b1˜b3, and 4 types of quadrangular pyramid cl˜c4);

FIG. 18B is the structural schematic diagram of the triangular pyramid light-uniformizing film (with the triangular pyramid being the spreading layer);
Wherein: 223: Triangular pyramid layer.

FIG. 19 is a schematic diagram of the approximate isosceles triangle (with the two waists being the concave rough lines);

FIG. 20 is a schematic diagram of the cross-section of the atomization light-uniformizing film (with the atomized spectral layer being a concave rough surface spectral layer);

FIG. 21 is a schematic diagram of an approximate isosceles triangle (with the two waists being the convex rough lines);

FIG. 22 is a schematic diagram of the cross-section of the atomization light-uniformizing film (with the atomized spectral layer being the convex rough surface spectral layer);
Wherein: 20: substrate layer; 21: Spectral layer; 22: Diffuser layer; 211: Atomized spectral layer (convex rough surface spectral layer); 212: Atomized spectral layer (concave rough surface spectral layer);

FIG. 23 shows the three-dimensional structure of the orthogonal prism light-uniformizing film and the schematic diagram of the cross-section of the prism ribs;

FIG. 24 shows the top view of the orthogonal prism light-uniformizing film;

FIG. 25 shows the influence of the matching angle of the prism diffuser layer and the spectral layer (N=1) on the contrast distribution;

FIG. 26 shows the influence of the matching angle of the prism diffuser layer and the spectral layer (N=1) on RSD;

Wherein:
20: Substrate layer; 21: Spectral layer; 22: Diffuser layer; 223: Orthogonal prism layer; 2201: Front prism rib peak; 2202: Front prism rib gorge; 2101: Back long rib wave peak; 2102 Back long rib gorge; MD: The extension direction of the coil, i.e. the Machine Direction; ω: The clockwise deviation angle between the structural carving direction or extension direction and the direction of MD.

FIG. 27 shows the three-dimensional structure of the oblique prism light-uniformizing film and the schematic diagram of the cross-section of the prism ribs;

FIG. 28 shows the top view of the oblique prism light-uniformizing film;

FIG. 29 shows the influence of the matching angle of the prism diffuser layer and the spectral layer (N=2) on the contrast distribution;

FIG. 30 shows the influence of the matching angle of the prism diffuser layer and the spectral layer (N=2) on RSD.

Wherein: 20: substrate layer; 21: Spectral layer; 22: Diffuser layer; 223: oblique prism layer; 2201: Front prism rib peak; 2202: Front prism rib gorge; 2101: Back long rib wave peak (ω₁); 2102 Back long rib gorge (ω₁); 2103: Back long rib wave peak (ω₂); 2104 Back long rib gorge (ω₂); MD: Extension direction of the coil i.e. the Machine Direction; ω: The clockwise deviation angle between the structural carving direction or extension direction and the direction of MD.

### Note:

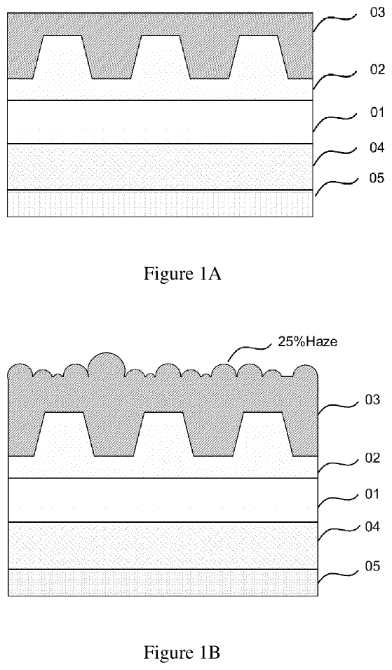

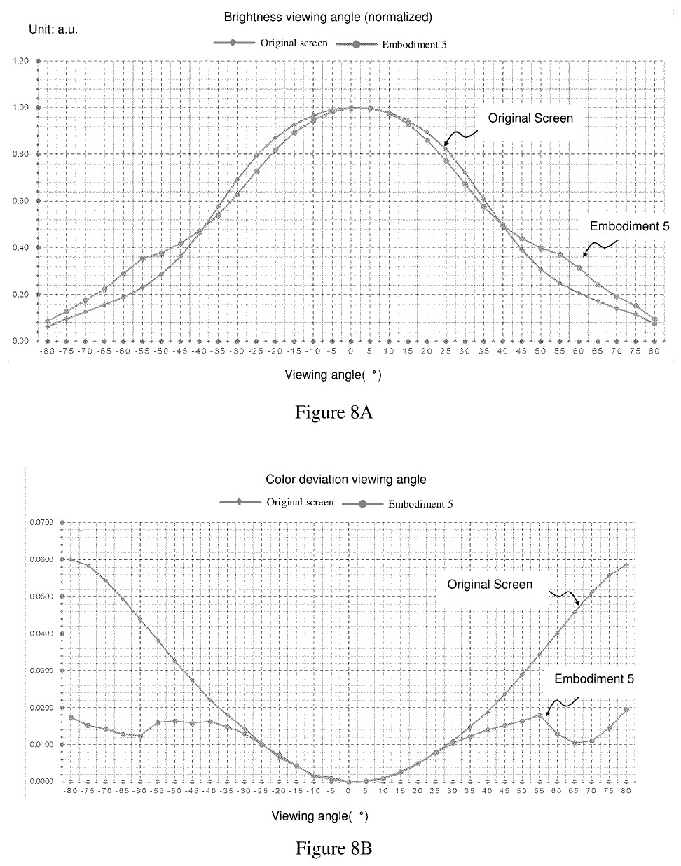

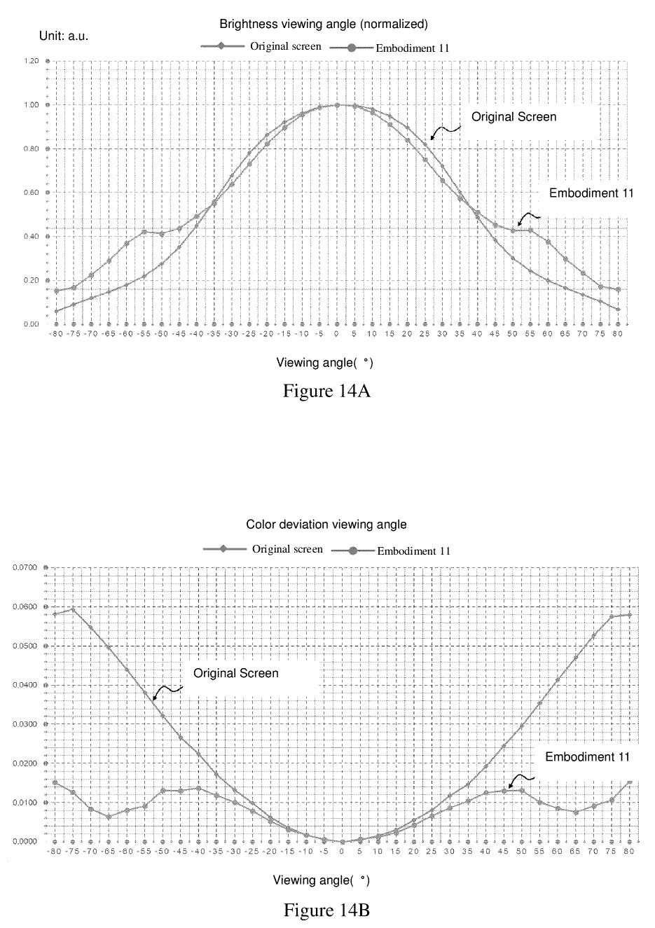

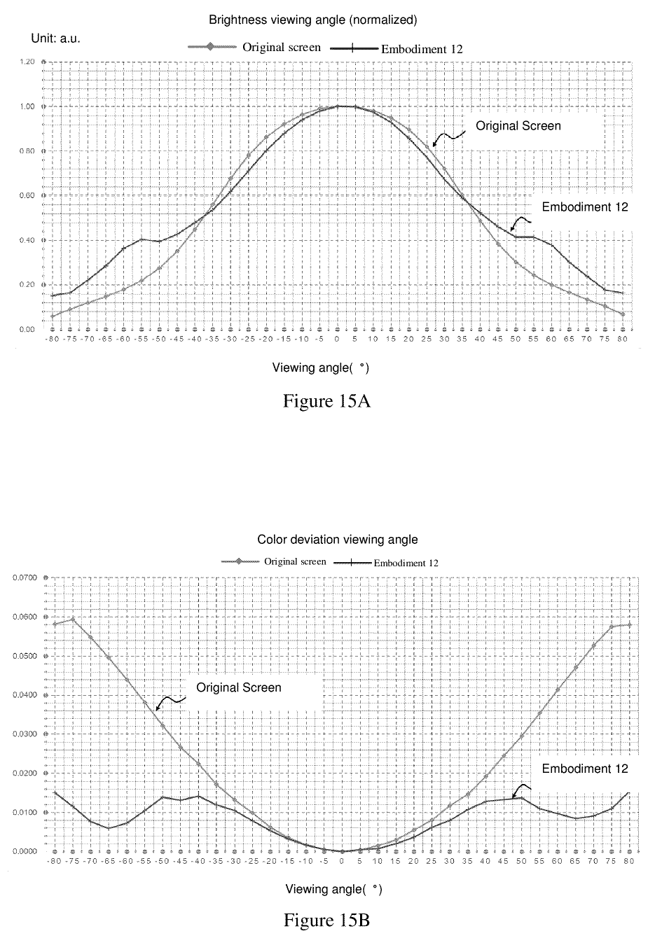

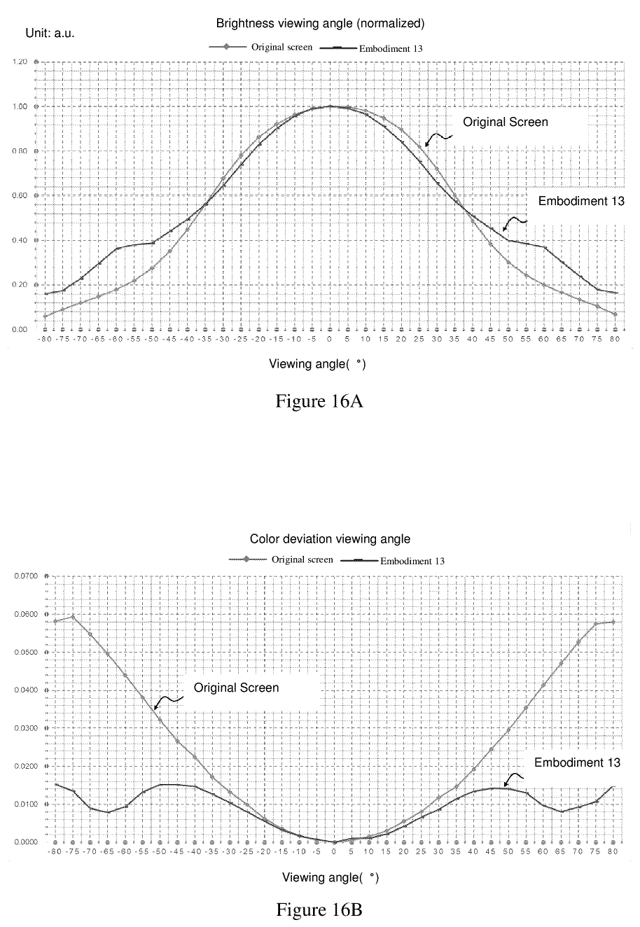

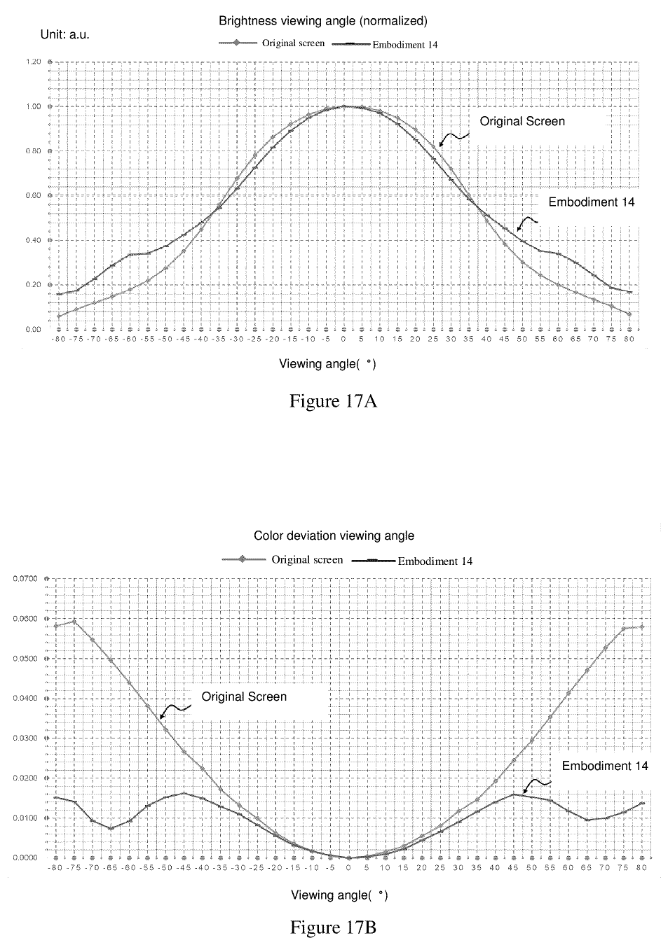

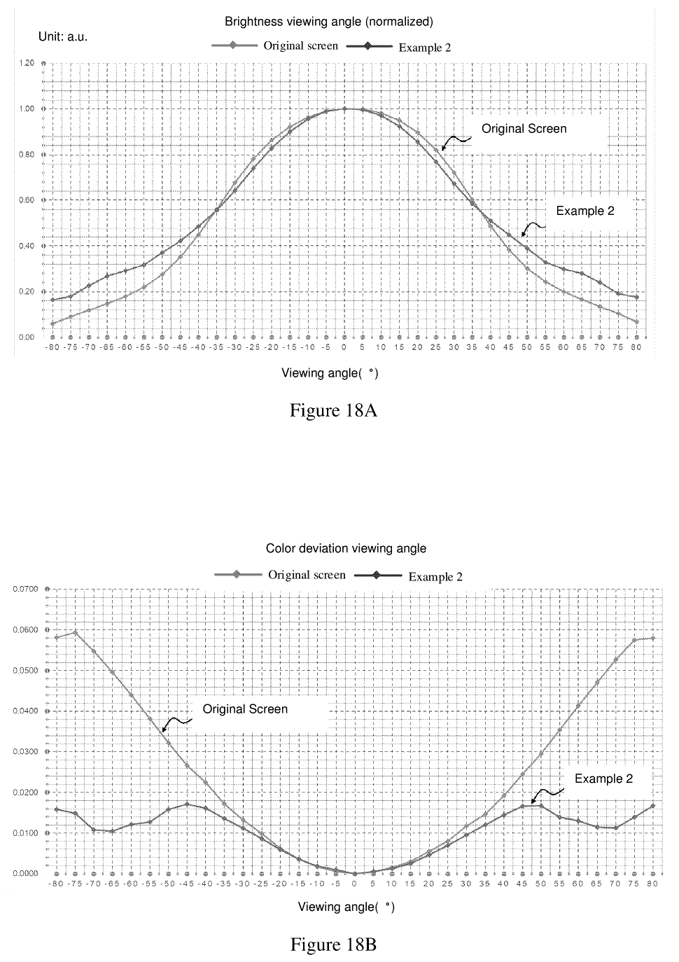

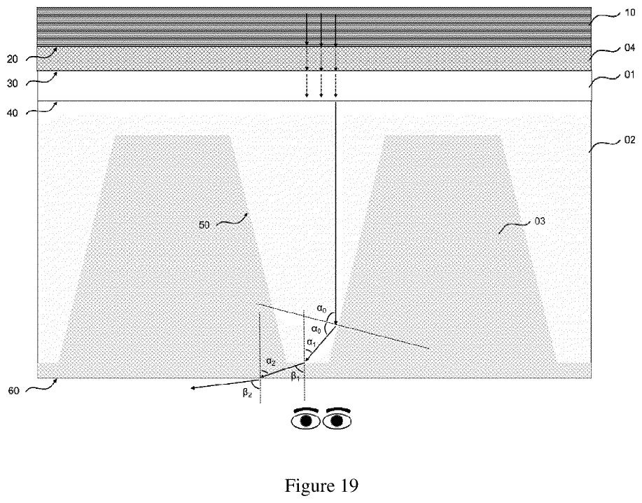

The priority number of FIGS. 1 to 14 is 202111268823.9, and the case file number is 210086;

The priority number of FIG. 15 is 202111268882.6, and the case file number is 210087;

The priority number of FIG. 16 is 202111272130.7, the case file number is 210088, and the original figure number is FIG. 15;

The priority number of FIG. 17 is 202111270266.4, the case file number is 210089, and the original figure number is FIG. 15;

The priority number of FIGS. 18A and 18B is 202111269132.0, the case file number is 210090, and the original figure number is FIGS. 15 and 16;

The priority number of FIGS. 19, 20, 21, and 22 is 202111587097.7, and the case file number is 210113, and the original figure numbers are FIG. 15, FIG. 16, FIG. 17, and FIG. 18;

The priority number of FIGS. 23, 24, 25, and 26 is 202210320342.6, and the case file number is 210010, and the original figure numbers are FIG. 15, FIG. 16, FIG. 17, and FIG. 18;

The priority number of FIGS. 27, 28, 29, and 30 is 202210322327.5, and the case file number is 210011, and the original figure numbers are FIG. 15, FIG. 16, FIG. 17, and FIG. 18.

### DETAILED DESCRIPTION OF THE EMBODIMENTS

For better understanding of the structure, functional features, and advantages of the present invention, the detailed explanation is presented by the preferred embodiments of the present invention and in conjunction with the diagram as follows.

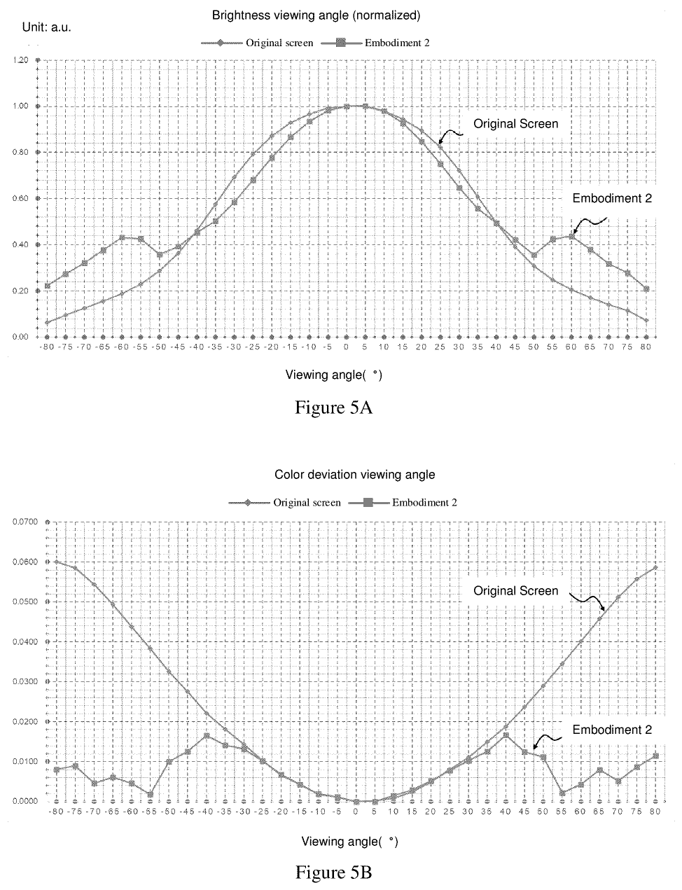

The present invention provides a light-uniformizing film, wherein the spectral layer of the light-uniformizing film plays the spectral effect, and the diffuser layer plays the main light spreading effect. If there is no diffuser layer, the substrate layer can play a certain role in the light spreading effect. The main principle is shown in FIG. 5.

Taking a planar light-uniformizing film as an embodiment, as the main light of the light source is concentrated in the normal direction, FIG. 5a shows the spectral process after the normal input light 40 is incident on the spectral layer 21. The light is incident through the inclined outer surfaces on both sides of the spectral layer, producing at least deflection in two directions (varying in numbers depending on the difference in structure of the spectral layer, if it is the pyramid, actually in four directions), whereby causing the incident light 411 to penetrate inside the light-uniformizing film, exit from the upper surface of the substrate layer 20, and deflect again (from light density to light sparsity), producing further separated output light 42. This is the basic principle of the spectral process. A beam of light from a point-light source is dispersed after passing through a spectral layer, and the beams of several point-light sources are dispersed by the spectral layer. The scattered light overlap with each other, making the output light more uniform.

Taking a planar light-uniformizing film as an embodiment, a small amount of large angle light is tilted incident towards the spectral layer. FIG. 5b shows the spreading process that occurs after the input light 40 is incident to the spectral layer 21 at 45 degrees. Taking the right side light as an embodiment, the light passes through the inclined outer surface of the spectral layer and incident to the right, penetrating and propagating to the upper surface of the substrate layer. Due to the angle meeting the critical angle of total reflection, total reflection occurs, producing the recover light 412. This part of the light passes through the spectral layer and undergoes diffuse reflection at the bottom lamp panel, producing upward two secondary input light 43. When this part of light reaches the spectral layer again, it is drawn from the position of initial input light 40 a considerable distance, or it can also be understood as this repeated light cycle up and down, indirectly expands the vertical light-mixing distance,

In summary, this process ultimately allows light energy to be distributed to a larger area, which is the basic principle of the light spreading process.

Although for a single planar light-uniformizing film, the spectral action is mainly occurred and the proportion of the diffusing is relatively small, after stacking multiple light-uniformizing films, for the upper light-uniformizing film (the input light is already tilted), the proportion of the diffusing effect can be increased.

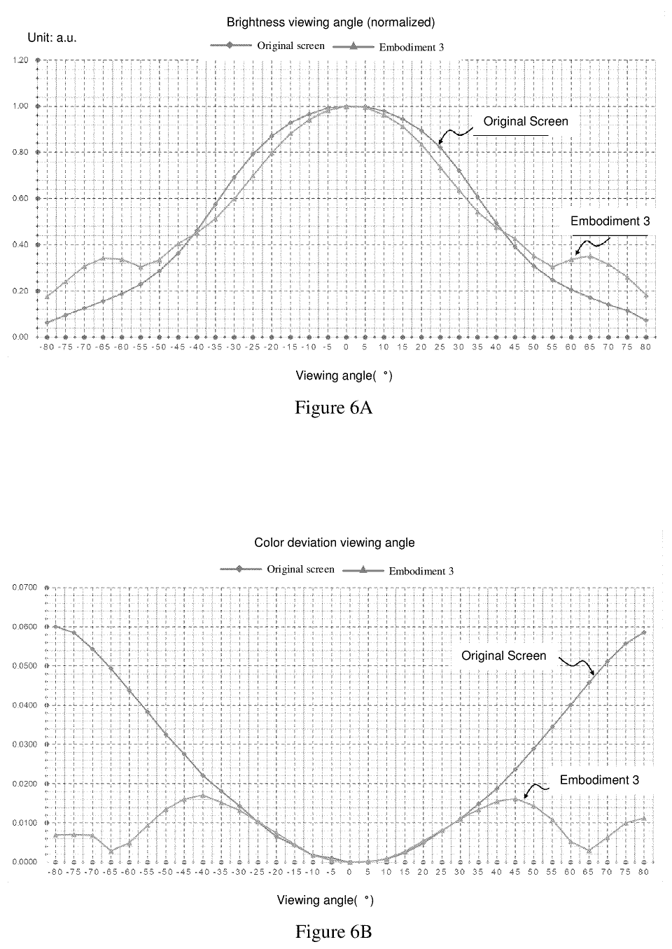

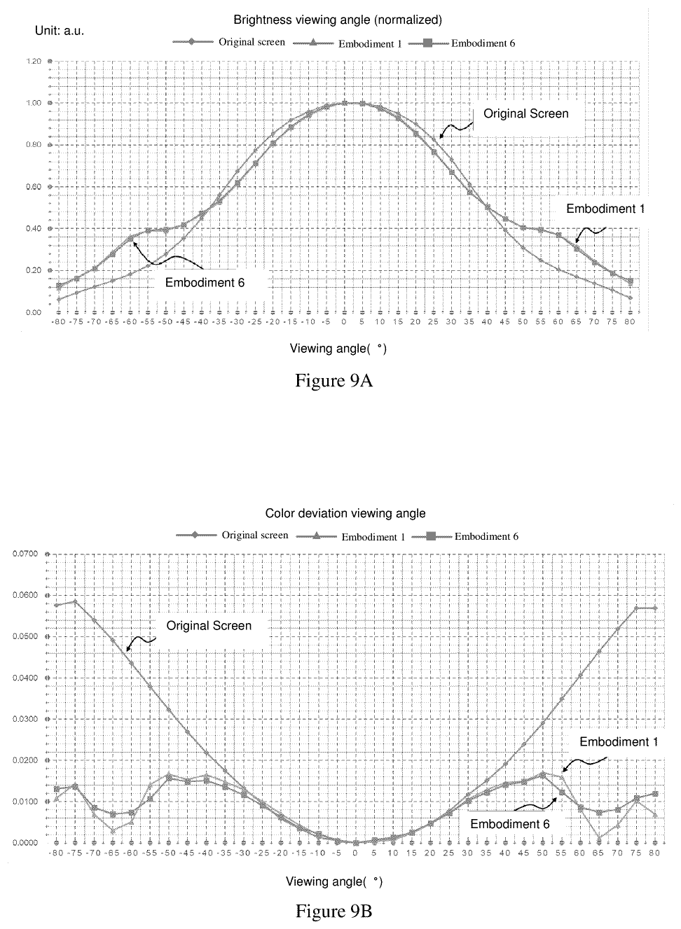

In general, in order that the actual optical path conforms to the design principles, especially when stacking multiple light-uniformizing films, in order for ensuring the proportion of the transmission light and the total reflection light for each layer, the surface smoothness for the structure of the spectral and diffuser layers should be as high as possible, and the line roughness should be as low as possible, whereby reducing the abnormal deflection of light. The embossing molding of precision carving molds is optimum for the structure preparation of the spectral layer, and other methods such as laser and lithography, etc. preparation method cann't guarantee high-precision surfaces. The structural design of the spectral layer adopts the principle of long rib superposition, as shown in FIGS. 6, 7, and 8. The long ribs can also be understood as grooves cutting by diamond carving cutters. The shapes of the long ribs can vary (as shown in FIG. 9a), and its cross-section can be a triangle in three different shapes as shown in FIG. 9b, FIG. 9c, and FIG. 9d.

The performance of the light-uniformizing film provided by the present invention is evaluated as follows.

### Illumination Distribution and Relative Standard Deviation

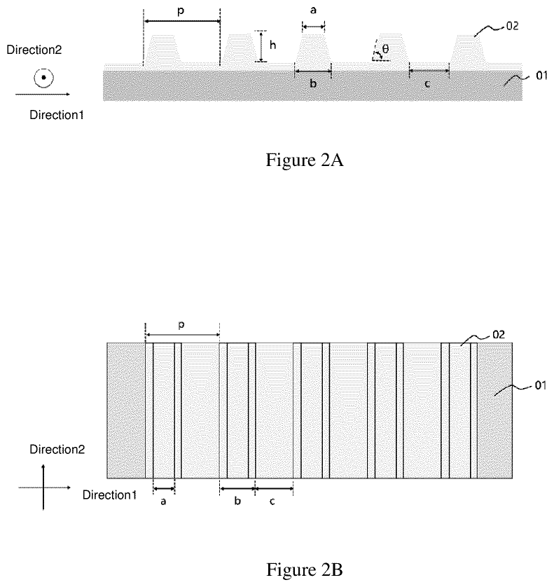

As shown in FIG. 2, the light-uniformizing component 2 is placed above the LED panel and LED0, below the projection screen or absorption screen 3. Wherein, the LED panel has a reflective function, integrating reflective sheets or reflective coatings, and the luminous areas of a single LEDS1=60 μm×60 μm. The size of the absorption screen is infinitely large, and the vertical distance between the absorption screen and the LED is Z=500 μm. The optical simulation methods such as light tools is used to analyze the illuminance distribution of the inspection range S2=1200 μm×1200 μm on the absorption screen, and calculate the relative standard deviation (RSD).

Note 1: This setting has been proportionally reduced to about ⅕ scale of the actual situation, which does not affect the equivalent evaluation;

Note 2: Due to the fact that the addition of light-uniformizing components will change the total amount of radiation reception in the light flux and the inspection range, the degree of change of the different optical components varies, thus the relative standard deviation instead of direct standard deviation is used for evaluation, which can eliminate the impact of base changes (Relative standard deviation=standard deviation/mean value).

Note 3: The light source is set as a cosine emitter with a beam angle of 30 degrees.

### (B) Light-Uniformizing Performance

Obviously, the lower the RSD, the smaller the difference between the illuminance value of each site and the average value, and the more uniform the illuminance distribution. The RSD0 which the light-uniformizing component is not included is used as the reference value of 100%, and the RSD1which the light-uniformizing component is added is used as the measurement value, improving the amplitude of uniformity U=(RSD0/RSD1−1)×100%, and U can be used as an evaluation index for the light-uniformizing performance of the light-uniformizing component.

Note: In the standard architecture described in (A), RSD0=5.47.

### (C) Shapes of Beam

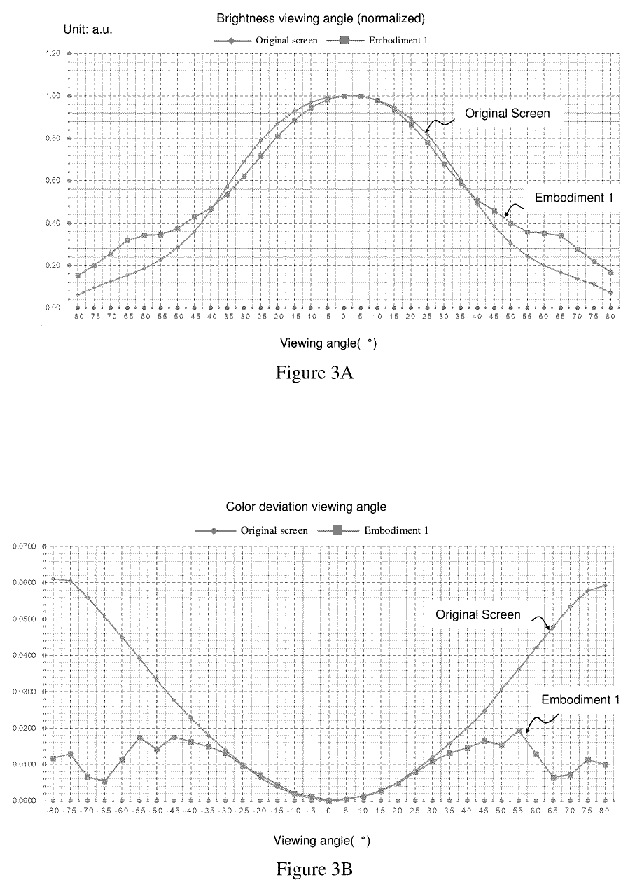

As shown in FIG. 3a, a typical spherical coordinate system is used, with the center of the sphere being as the origin of the light source and the Z-axis being as the outgoing direction, that is, the shapes of beam of the initial light source or after passing through a light-uniformizing component can be described by this spherical coordinate system. FIG. 3b shows the shapes of beam of the Lambertian point-light source (the original LED light), and FIG. 3c shows the shapes of beam after passing through a planar light-uniformizing film.

Note 3: due to the fact that the light-uniformizing film will not be used only one time, and there are also some other films in the backlight architectures (such as quantum dot film/fluorescent film, ordinary diffusion film, brightening film or composite film), thus the shapes of beam is only a qualitative consideration for the spectral effect of a single light-uniformizing film, and the final shapes of beam of the backlight source will depend on the complete optical film stacking structures, and it is not necessary to worry that lights of large angles cannot be corrected to the normal direction ultimately, when a light-uniformizing film is designed.

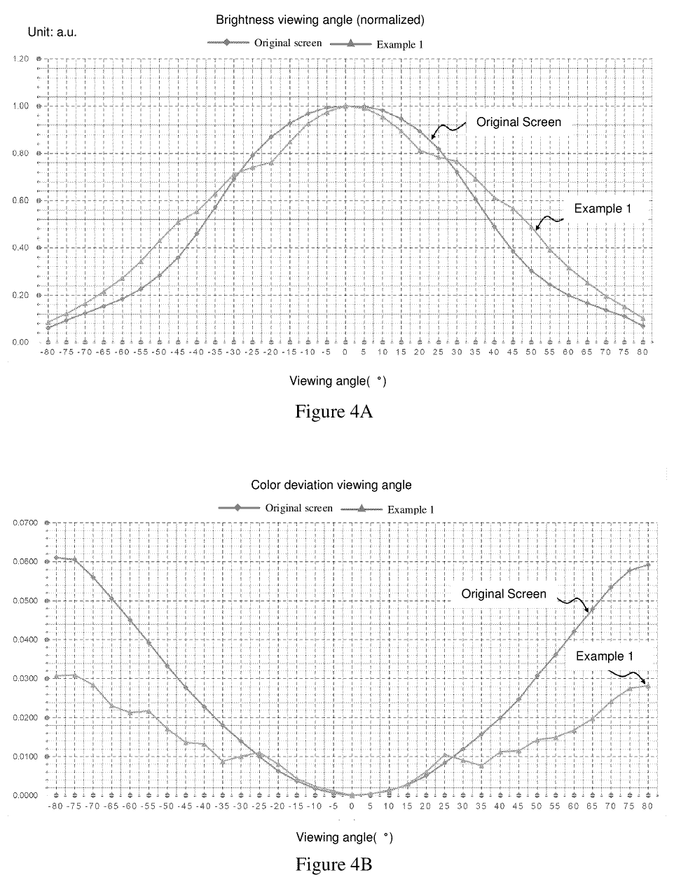

As shown in FIG. 4a, the present invention provides a light-uniformizing film, which comprises a substrate layer 20 and a spectral layer 21, the spectral layer 21 is located on the lower surface of the substrate layer 20.

As shown in FIG. 4b, the present invention provides a light-uniformizing film, which comprises a substrate layer 20, a spectral layer 21, and a diffuser layer 22, the spectral layer is located on the lower surface of the substrate layer 20, and the diffuse layer is located on the upper surface of the substrate layer 20.

### Embodiment 1

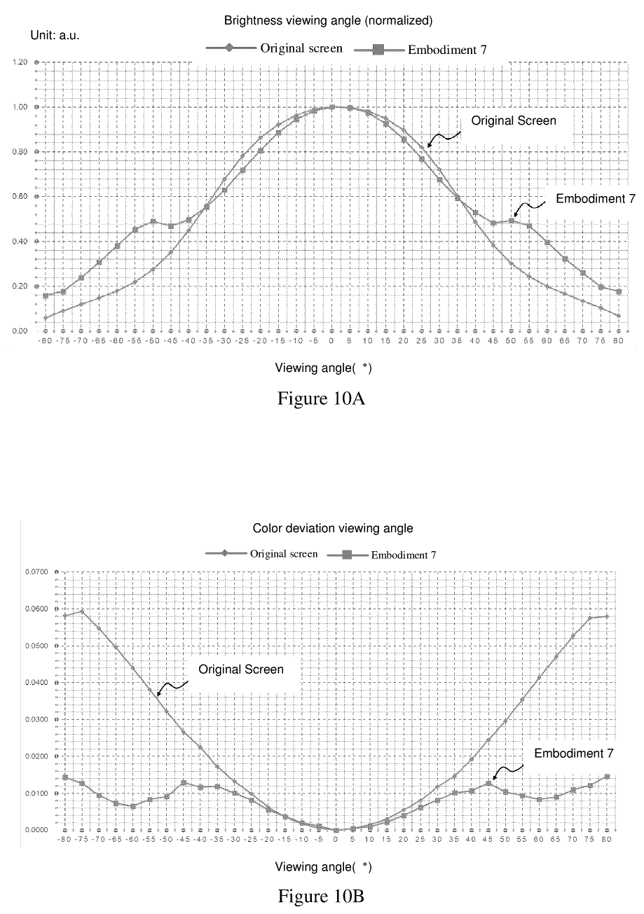

The present invention provides a light-uniformizing film, comprising a substrate layer 20 and a spectral layer 21, the diffuser layer 22 does not exist, as shown in FIG. 10, and the light-uniformizing film is a planar light-uniformizing film. The thickness M of the substrate layer 20 is 75 μm, the material of the substrate layer is selected as PET, and the spectral layer is composed of transparent polymer resin, the material of which is light-cured acrylic resin (AR) with a refractive index n₁ of 1.5. The spectral layer is designed as a single axis standard plane; the spectral layer is composed of the long ribs stacked in N different directions. The long ribs are laid flat on the lower surface of the substrate layer, extending infinitely towards both ends. The long ribs in the same direction are tightly arranged, and the topological coefficient N is 1, that is, single axis spectral (as shown in FIG. 6); The spectral layer is selected from the standard plane spectral layer, and the cross-section of its corresponding long rib is an isosceles triangle, whose waists are finite cut straight lines on both sides, that is, the cross-section of the long rib is a straight triangle with a vertex angle θ of 90°. The light-uniformizing performance of the light-uniformizing film is good, with an improvement in uniformity of U=46%.

### Embodiments 2-36

The other parameters of the planar light-uniformizing film provided in Embodiment 1 are listed in Table 1.

TABLE 1
Design parameters and light-uniformizing performance of the
planar light-uniformizing film provided in Embodiments 1-36.

| | | | | | | | | | Light- | |
|---|---|---|---|---|---|---|---|---|---|---|
| | | | | | | | | | uniformizing | |
| | Substrate layer | | Spectral layer | | | | | | performance | |
| | | M | | Cross-sectional | ⊖ | | | | | U |
| Items | Materials | μm | [symbol] | shape | 0 | [symbol] | Materials | n₁ | RSD | % |
| Embodiment1 | PET | 75 | 1 | Right triangle | 90 | / | AR | 1.5 | 3.73 | 46 |
| Embodiment2 | PET | 25 | 1 | Right triangle | 90 | / | AR | 1.5 | 3.73 | 46 |
| Embodiment3 | PET | 125 | 1 | Right triangle | 90 | / | AR | 1.5 | 3.73 | 46 |
| Embodiment4 | PET | 250 | 1 | Right triangle | 90 | / | AR | 1.5 | 3.73 | 46 |
| Embodiment5 | PMMA | 100 | 1 | Right triangle | 90 | | AR | 1.5 | 3.73 | 46 |
| Embodiment6 | PC | 100 | 1 | Right triangle | 90 | / | AR | 1.5 | 3.71 | 48 |
| Embodiment7 | PC | 250 | 1 | Right triangle | 90 | / | AR | 1.5 | 3.71 | 48 |
| Embodiment8 | PC | 500 | 1 | Right triangle | 90 | / | AR | 1.5 | 3.71 | 48 |
| Embodiment9 | PET | 100 | 1 | Right triangle | 90 | / | AR | 1.65 | 3.46 | 58 |
| Embodiment10 | PET | 100 | 1 | Right triangle | 90 | | AR | 1.4 | 3.90 | 40 |
| Embodiment11 | PC | 100 | 1 | Right triangle | 90 | / | PC | 1.58 | 3.61 | 52 |
| Embodiment12 | PMMA | 100 | 1 | Right triangle | 90 | | PMM | 1.5 | 3.72 | 47 |
| | | | | | | | A | | | |
| Embodiment13 | PET | 75 | 1 | Right triangle | 120 | / | AR | 1.5 | 4.21 | 30 |
| Embodiment14 | PET | 75 | 1 | Right triangle | 120 | / | AR | 1.65 | 3.89 | 40 |
| Embodiment15 | PET | 75 | 1 | Right triangle | 105 | / | AR | 1.5 | 3.86 | 42 |
| Embodiment16 | PET | 75 | 1 | Right triangle | 105 | / | AR | 1.65 | 3.58 | 53 |
| Embodiment17 | PET | 75 | 1 | Right triangle | 75 | / | AR | 1.4 | 3.75 | 46 |
| Embodiment18 | PET | 75 | 1 | Right triangle | 75 | / | AR | 1.5 | 3.58 | 53 |
| Embodiment19 | PET | 75 | 1 | Right triangle | 75 | | AR | 1.65 | 3.09 | 77 |
| Embodiment20 | PET | 75 | 1 | Right triangle | 60 | / | AR | 1.4 | 3.66 | 49 |
| Embodiment21 | PET | 75 | 1 | Right triangle | 60 | / | AR | 1.5 | 3.43 | 59 |
| Embodiment22 | PET | 75 | 1 | Right triangle | 60 | / | AR | 1.65 | 2.48 | 12 |
| | | | | | | | | | | 0 |
| Embodiment23 | PET | 75 | 1 | Convex arc | 120 | 30 | AR | 1.5 | 3.47 | 58 |
| | | | | side triangle | | | | | | |
| Embodiment24 | PET | 75 | 1 | Concave arc | 60 | 30 | AR | 1.5 | 3.44 | 59 |
| | | | | side triangle | | | | | | |
| Embodiment25 | PET | 75 | 1 | Convex arc | 100 | 10 | AR | 1.5 | 3.57 | 53 |
| | | | | side triangle | | | | | | |
| Embodiment26 | PET | 75 | 1 | Concave arc | 80 | 10 | AR | 1.5 | 3.55 | 54 |
| | | | | side triangle | | | | | | |
| Embodiment27 | PET | 75 | 1 | Convex arc | 93 | 3 | AR | 1.5 | 3.65 | 50 |
| | | | | side triangle | | | | | | |
| Embodiment28 | PET | 75 | 1 | Concave arc | 87 | 3 | AR | 1.5 | 3.64 | 50 |
| | | | | side triangle | | | | | | |
| Embodiment29 | PET | 75 | 1 | Convex arc | 91 | | AR | 1.5 | 3.73 | 46 |
| | | | | side triangle | | | | | | |
| Embodiment30 | PET | 75 | 1 | Concave arc | 89 | | AR | 1.5 | 3.73 | 46 |
| | | | | side triangle | | | | | | |
| Embodiment31 | PET | 75 | 2 | Right triangle | 90 | / | AR | 1.4 | 3.4 | 60 |
| Embodiment32 | PET | 75 | 2 | Right triangle | 90 | | AR | 1.5 | 2.93 | 87 |
| Embodiment33 | PET | 75 | 2 | Right triangle | 90 | / | AR | 1.65 | 2.44 | 124 |
| Embodiment34 | PET | 75 | 3 | Right triangle | 90 | / | AR | 1.4 | 3.34 | 64 |
| Embodiment35 | PET | 75 | 3 | Right triangle | 90 | / | AR | 1.5 | 2.82 | 94 |
| Embodiment36 | PET | 75 | 3 | Right triangle | 90 | / | AR | 1.65 | 2.20 | 249 |

[symbol]

indicates data missing or illegible when filed

As shown in Table 1, by comparing embodiments 1-12, it can be seen that the thickness and materials of the substrate layer have little effect on the light-uniformizing performance U of the light-uniformizing film, but the materials or refractive index of the spectral layer has an impact on U. For an single axis spectral layer, the higher the refractive index, the more obvious the spectral is, the better the spectral performance, the larger the U. By comparing embodiments 13-22, it can be seen that, the larger the vortex angle of the cross-section triangle θ, the more closer to the planar the structure, the less obvious the spectral layer, the worse the light-uniformizing performance, the smaller the U, and vice versa. Comparing embodiments 1, 8, 9, and 31-36, it can be seen that, for biaxial and triaxial light-uniformizing designs, just like the single axis design, the higher the refractive index, the more obvious the spectral is, the better the spectral performance, the larger the U; and under the same refractive index, the triaxial designs are better than the biaxial designs and better than the single axis design. By comparing embodiments 23-30, it can be seen that, when the waists of the cross-section triangle is bent in different degrees of curvature, all can still carry out the spectral effect, and the larger the α (the more bent), the light-uniformizing performance U still needs to improve. Note that in embodiments 23-30, in order to compare with embodiment 1, each of the average inclination angle δ set on the side is 45 degrees (this is consistent with embodiment 1). If the cross-section of embodiment 23 is a convex arc triangle, δ=(0.50+(0.50−α))/2=(θ−α)/2=(120−30)/2=45 degrees. If the cross-section in embodiment 24 is a concave arc triangle, δ=(0.50+(0.50+α)/2=(θ+α)/2=(60+30/2=45 degrees). From this result, it can be seen that the curved arc design can definitely improve the light-uniformizing performance compared to the straight line design.

### Embodiment 37

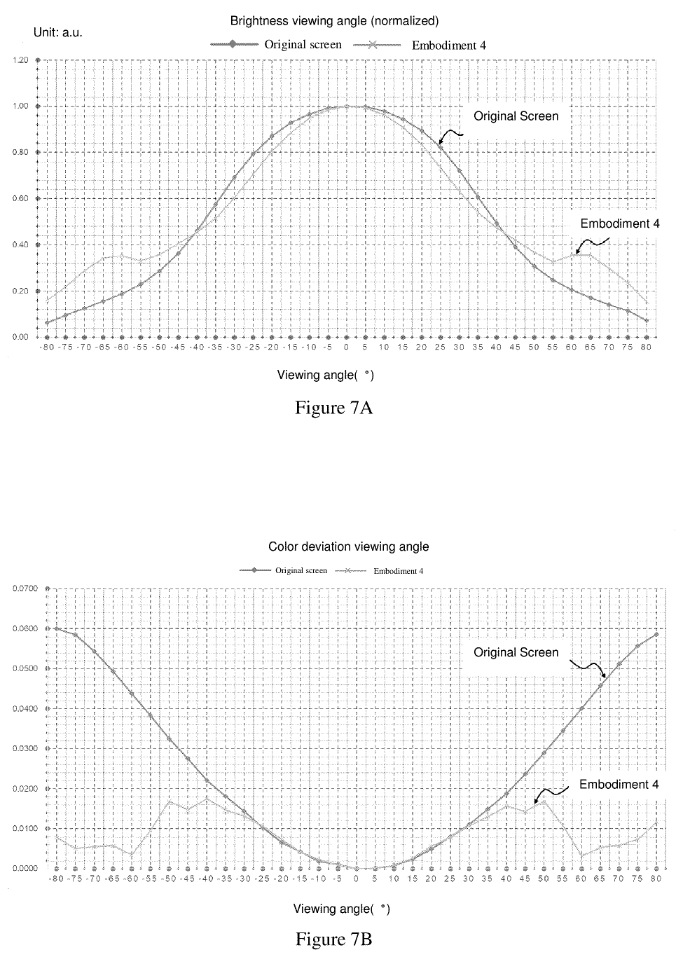

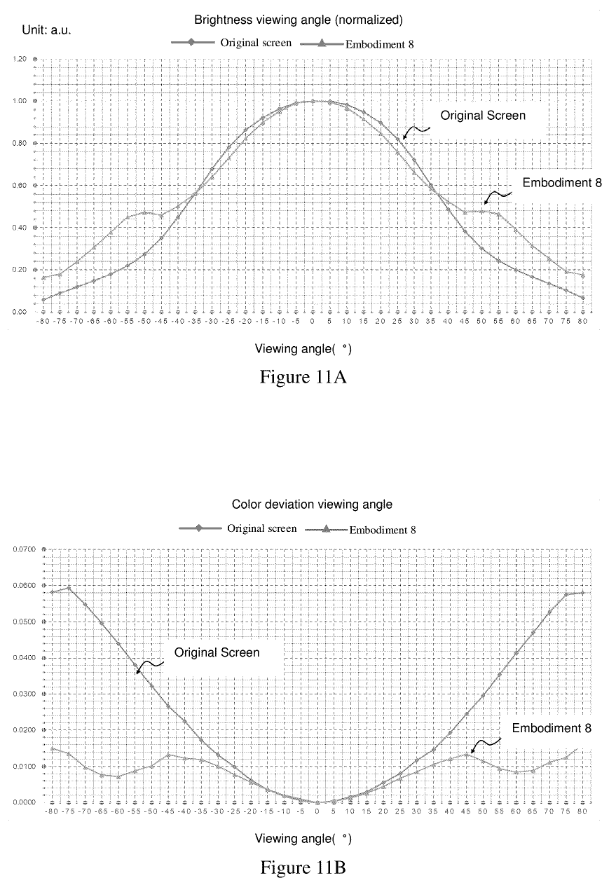

The present invention provides a light-uniformizing film, comprising a substrate layer 20, a spectral layer 21, and a diffuser layer 22, as shown in FIG. 11, the light-uniformizing film is a prism light-uniformizing film. The thickness M of the substrate layer 20 is 75 μm, the material of the substrate layer is selected from PET, and the spectral layer is composed of transparent polymer resin, the material of which is light-cured acrylic resin (AR) with a refractive index n₁ of 1.5. The diffuser layer is composed of transparent polymer resin, the material of which is light-cured acrylic resin (AR) with a refractive index n₂ of 1.5. The spectral layer is designed as a biaxial standard plane: it is composed of the long ribs stacked in N directions, which are laid flat on the lower surface of the substrate layer, which extend infinitely towards both ends, and the long ribs in the same direction are tightly arranged. The topological coefficient N is selected from 2, which is a biaxial spectral (as shown in FIG. 7); The spectral layer is selected from the standard plane spectral layer, and the cross-section of its corresponding long rib is an isosceles triangle, which has two finite cut straight lines on both sides, that is, the cross-section of the long rib is a straight triangle with a vertex angle θ of 90°. The diffuser layer is a prism layer 221, which are laid flat by the prism ribs, and the cross-section of the prism ribs is an isosceles triangle, with the base line V of 50 μm, the vortex angle β is 90°; The light-uniformizing performance of the light-uniformizing film is good, with an improvement in uniformity of U=91%.

### Embodiments 38-48

The prism light-uniformizing film is provided in embodiment 37, and the other parameters are listed in Table 2.

TABLE 2
Design parameters and light-uniformizing performance of prism
light-uniformizing film provided in Embodiments 37-48

| | | | | | | | | | | | Light-uniformizing | |
|---|---|---|---|---|---|---|---|---|---|---|---|---|
| | Substrate layer | | Spectral layer | | | | | Prism diffuser layer | | | performance | |
| | | M | | Cross-sectional | ⊖ | | | V | β | | | U/ |
| Items | Materials | μm | N | shape | 0 | α/o | n₁ | μm | 0 | N₂ | RSD | % |
| Embodiment37 | PET | 75 | 2 | Right triangle | 90 | / | 1.5 | 50 | 90 | 1.5 | 2.86 | 91 |
| Embodiment 38 | PC | 75 | 2 | Right triangle | 90 | / | 1.5 | 50 | 90 | 1.5 | 2.86 | 91 |
| Embodiment 39 | PET | 25 | 2 | Right triangle | 90 | / | 1.5 | 10 | 90 | 1.5 | 2.86 | 91 |
| Embodiment 40 | PMMA | 75 | 2 | Right triangle | 90 | | 1.5 | 25 | 90 | 1.5 | 2.86 | 91 |
| Embodiment 41 | PET | 250 | 2 | Right triangle | 90 | / | 1.5 | 75 | 90 | 1.5 | 2.86 | 91 |
| Embodiment 42 | PC | 500 | 2 | Right triangle | 90 | / | 1.5 | 100 | 90 | 1.5 | 2.86 | 91 |
| Embodiment 43 | PET | 75 | 2 | Right triangle | 90 | / | 1.5 | 50 | 120 | 1.5 | 2.24 | 144 |
| Embodiment 44 | PET | 75 | 2 | Right triangle | 90 | / | 1.5 | 50 | 105 | 1.5 | 2.62 | 109 |
| Embodiment 45 | PET | 75 | 2 | Right triangle | 90 | / | 1.5 | 50 | 75 | 1.5 | 2.24 | 144 |
| Embodiment 46 | PET | 75 | 2 | Right triangle | 90 | / | 1.5 | 50 | 60 | 1.5 | 1.48 | 270 |
| Embodiment 47 | PET | 75 | 2 | Right triangle | 90 | / | 1.5 | 50 | 60 | 1.4 | 1.97 | 178 |
| Embodiment 48 | PET | 75 | 2 | Right triangle | 90 | / | 1.5 | 50 | 60 | 1.65 | 1.36 | 302 |

Note:
The material of the spectral layer and the diffuser layer in embodiments 37-48 are all AR

As shown in Table 2, by comparing embodiments 37-42, it can be seen that the thickness and materials of the substrate layer and size of the diffuser layer prism (i.e. the width of the bottom edge) have little effect on the light-uniformizing performance U of the light-uniformizing film. By comparing embodiments 37, 43-45, it can be seen that, the vortex angle β of the prism structure has effects on U, the diffusing effects are optimum when the vortex angle is less than 90 degrees or larger than 90 degrees, and the U is larger. By comparing embodiments 46-48, it can be seen that, the refractive index n₂ of the prism structure also has effects on U.

### Embodiment 49

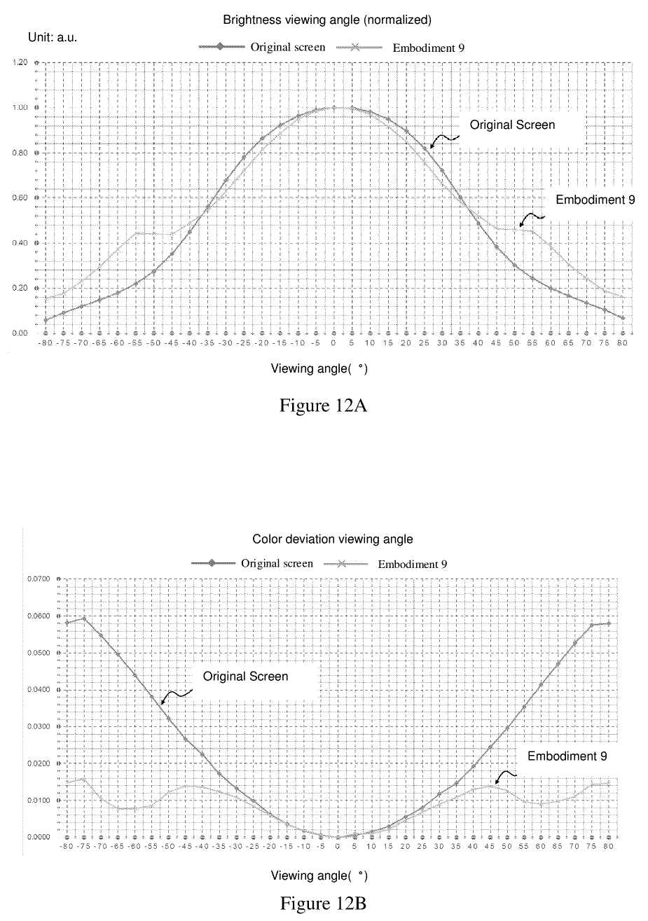

The present invention provides a light-uniformizing film, comprising a substrate layer 20, a spectral layer 21, and a diffuser layer 22, as shown in FIG. 12. The light-uniformizing film is a cylinder light-uniformizing film. The thickness M of the substrate layer 20 is 75 μm, the material of the substrate layer is selected from PET, and the spectral layer is composed of transparent polymer resin, the material of which is light-cured acrylic resin (AR) with a refractive index n₁ of 1.5, the diffuser layer is composed of transparent polymer resin, the material of which is light-cured acrylic resin (AR) with a refractive index n₂ of 1.5. The spectral layer is designed as a biaxial standard plane: it is composed of the long ribs stacked in N different directions, which are laid flat on the lower surface of the substrate layer. The long ribs extend infinitely towards both ends, and the long ribs in the same direction are tightly arranged. The topological coefficient N is selected from 2, that is the biaxial spectral; The spectral layer is selected from the standard plane spectral layer, the cross-section of its corresponding long rib is an isosceles triangle, which has two finite cut straight lines on both sides, that is, the cross-section of the long rib is a straight triangle with a vertex angle θ of 90°. The diffuser layer is a cylinder lens layer 222, which is laid flat by the cylinder lens ribs, the cross-section of the cylinder lens is an arc, and the width (chord length) of the arc F is 50 μm, the height of the arc is K, and the ratio of height and width K/F is 0.5. The light-uniformizing performance of the light-uniformizing film is good, with an improvement in uniformity of U=115%.

### Embodiments 50-60

The cylinder light-uniformizing film is provided by Embodiment 49, and the other parameters are listed in Table 3.

TABLE 3
Design parameters and light-uniformizing performance of the
cylinder light-uniformizing film provided in Embodiments 49 to 60

| | | | | | | | | | | | Light- | |
|---|---|---|---|---|---|---|---|---|---|---|---|---|
| | | | | | | | | Cylinder diffuser | | | uniformizing | |
| | Substrate layer | | Spectral layer | | | | | layer | | | performance | |
| | | M | | Cross-sectional | ⊖ | | | F | | | | U |
| Items | Materials | μm | N | shape | 0 | α/o | N₁ | μm | K/F | N₂ | RSD | % |
| Embodiment49 | PET | 75 | 2 | Right triangle | 90 | / | 1.5 | 50 | 0.5 | 1.5 | 2.55 | 115 |
| Embodiment50 | PC | 75 | 2 | Right triangle | 90 | / | 1.5 | 50 | 0.5 | 1.5 | 2.55 | 115 |
| Embodiment51 | PET | 25 | 2 | Right triangle | 90 | / | 1.5 | 20 | 0.5 | 1.5 | 2.55 | 115 |
| Embodiment52 | PMMA | 75 | 2 | Right triangle | 90 | / | 1.5 | 100 | 0.5 | 1.5 | 2.55 | 115 |
| Embodiment53 | PET | 125 | 2 | Right triangle | 90 | / | 1.5 | 250 | 0.5 | 1.5 | 2.55 | 115 |
| Embodiment54 | PET | 250 | 2 | Right triangle | 90 | / | 1.5 | 500 | 0.5 | 1.5 | 2.55 | 115 |
| Embodiment55 | PC | 500 | 2 | Right triangle | 90 | / | 1.5 | 1000 | 0.5 | 1.5 | 2.55 | 115 |
| Embodiment56 | PET | 75 | 2 | Right triangle | 90 | / | 1.5 | 50 | 0.3 | 1.5 | 2.64 | 107 |
| Embodiment57 | PET | 75 | 2 | Right triangle | 90 | / | 1.5 | 50 | 0.1 | 1.5 | 2.72 | 101 |
| Embodiment58 | PET | 75 | 2 | Right triangle | 90 | / | 1.5 | 50 | 0.05 | 1.5 | 2.78 | 97 |
| Embodiment59 | PET | 75 | 2 | Right triangle | 90 | / | 1.5 | 50 | 0.5 | 1.4 | 2.64 | 107 |
| Embodiment60 | PET | 75 | 2 | Right triangle | 90 | / | 1.5 | 50 | 0.5 | 1.65 | 2.43 | 125 |

Note:
The material of the spectral layer and the diffuser layer in Embodiments 49-60 are all AR

As shown in Table 3, by comparing Embodiments 49 to 55, it can be seen that the thickness and material of the substrate layer, as well as the size of the cylinder lens in the diffuser layer (i.e. the arc width F), have little effect on the light-uniformizing performance U of the light-uniformizing film. By comparing embodiments 49, 56 to 58, it can be seen that the ratio of height and width K/F of the cylinder lens structure has a slight impact on U. When K/F is large, the shape of the cylinder lens is more convex, resulting in better light spreading effect. The light-uniformizing performance of the light-uniformizing film is better, and U is larger. By comparing embodiments 49, 59, and 60, it can be seen that the refractive index n₂ of the cylinder structure has also an impact on the light-uniformizing performance, with the higher the refractive index, the greater the U.

### Embodiment 61

The present invention provides a light-uniformizing film comprising a substrate layer 20, a spectral layer 21, and a diffuser layer 22, as shown in FIG. 12, the light-uniformizing film is a pyramid light-uniformizing film. The thickness M of the substrate layer 20 is 75 μm, the material of the substrate layer is selected from PET, and the spectral layer is composed of transparent polymer resin, which is made of light-cured acrylic resin (AR) with a refractive index n₁ of 1.5, the diffuser layer is composed of transparent polymer resin, which is made of light-cured acrylic resin (AR), with a refractive index of n₂ of 1.5. The spectral layer is designed as a biaxial standard plane: it is composed of the long ribs stacked in N directions, which are laid flat on the lower surface of the substrate layer. The long ribs extend infinitely towards both ends, and the long ribs in the same direction are tightly arranged. The topological coefficient N is selected from 2, i.e. a biaxial spectral; The spectral layer is selected from the standard plane spectral layer, and the cross-section of its corresponding long rib is an isosceles triangle, which has two finite cut straight lines on both sides, the cross-section of the long ribs is a straight triangle with a vertex angle θ of 90°. The diffuser layer is a pyramid layer 224, which is laid flat by a pyramid, the vertices of the pyramid form a square arrangement, and the height T of the pyramid is 30 μm, the angle between the side and the height γ is 45°. The light-uniformizing performance of the light-uniformizing film is good, with an improvement in uniformity of U=41%.

### Embodiments 62-70

The pyramid light-uniformizing film is provided in embodiment 61, and the other parameters are listed in Table 4.

TABLE 4
Design parameters and light-uniformizing performance of the
pyramid light uniformizing film provided in embodiments 61-70

| | | | | | | | | | | | Light- | |
|---|---|---|---|---|---|---|---|---|---|---|---|---|
| | | | | | | | | Quadratic pyramid | | | uniformizing | |
| | Substrate layer | | Spectral layer | | | | | diffuser layer | | | performance | |
| | | M | | Cross-sectional | ⊖ | | | T | y | | | U |
| Items | Materials | μm | N | shape | 0 | α/o | n1 | μm | 0 | N₂ | RSD | % |
| Embodiment61 | PET | 75 | 2 | Right triangle | 90 | / | 1.5 | 30 | 45 | 1.5 | 3.87 | 41 |
| Embodiment62 | PC | 75 | 2 | Right triangle | 90 | / | 1.5 | 30 | 45 | 1.5 | 3.87 | 41 |
| Embodiment63 | PET | 25 | 2 | Right triangle | 90 | | 1.5 | 10 | 45 | 1.5 | 3.87 | 41 |
| Embodiment64 | PMMA | 75 | 2 | Right triangle | 90 | / | 1.5 | 20 | 45 | 1.5 | 3.87 | 41 |
| Embodiment65 | PET | 250 | 2 | Right triangle | 90 | / | 1.5 | 40 | 45 | 1.5 | 3.87 | 41 |
| Embodiment66 | PC | 500 | 2 | Right triangle | 90 | / | 1.5 | 50 | 45 | 1.5 | 3.87 | 41 |
| Embodiment67 | PET | 75 | 2 | Right triangle | 90 | / | 1.5 | 50 | 30 | 1.5 | 1.48 | 270 |
| Embodiment68 | PET | 75 | 2 | Right triangle | 90 | / | 1.5 | 50 | 60 | 1.5 | 2.54 | 115 |
| Embodiment69 | PET | 75 | 2 | Right triangle | 90 | / | 1.5 | 30 | 45 | 1.4 | 3.41 | 60 |
| Embodiment70 | PET | 75 | 2 | Right triangle | 90 | / | 1.5 | 30 | 45 | 1.65 | 3.33 | 64 |

Note:
The material of the spectral layer and the diffuser layer in Embodiments 61-70 are all AR

As shown in Table 4, by comparing embodiments 61-66, it can be seen that the thickness and material of the substrate layer, and the size of the quadrangular pyramid of the diffuser layer (i.e. the height T of the pyramids), have little effect on the light-uniformizing performance U of the light-uniformizing film. By comparing embodiments 61, 67, and 68, it can be seen that the angle between the side and the height γ has a significant impact on U, the smaller the γ, the more convex the shape of the pyramid, the better the light spreading effect, the better the light-uniformizing performance of the light-uniformizing film, the larger the U. By comparing embodiments 61, 69, and 70, it can be seen that the refractive index n₂ of the pyramid structure also has an impact on the light-uniformizing performance, with the higher refractive index, the larger the U.

### Embodiment 71

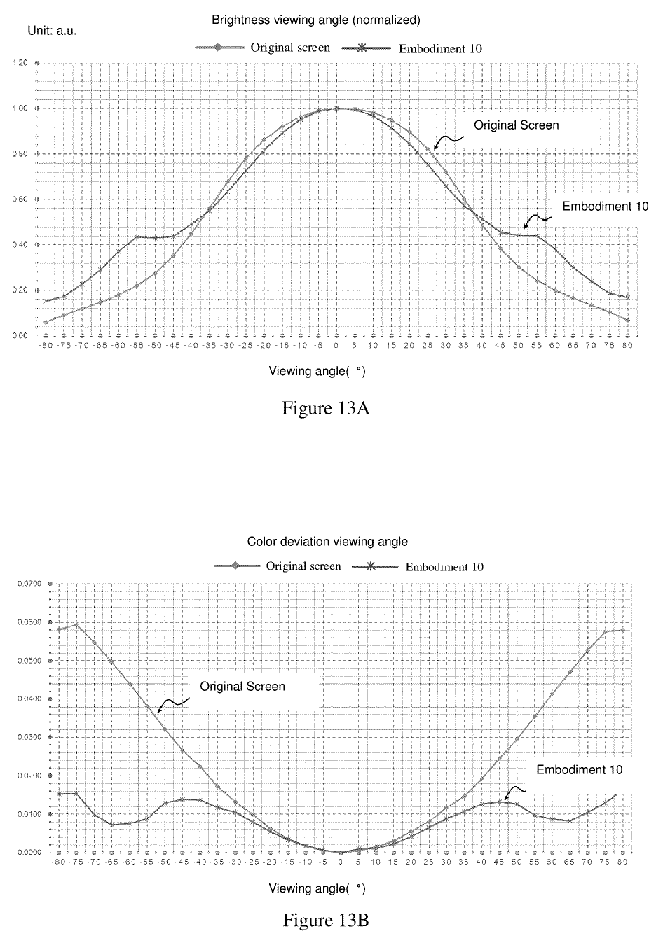

The present invention provides a light-uniformizing film comprising a substrate layer 20, a spectral layer 21, and a diffuser layer 22, as shown in FIG. 13, the light-uniformizing film is a micro lens light-uniformizing film. The thickness M of the substrate layer 20 is 75 μm, the material of the substrate layer is selected from PET, the spectral layer is composed of transparent polymer resin, and made of light-cured acrylic resin (AR) with a refractive index n₁ of 1.5. The diffuser layer is made of transparent polymer resin, and made of light-cured acrylic resin (AR) with a refractive index n₂ of 1.5. The spectral layer is designed as a biaxial standard plane: it is composed of the long ribs stacked in N directions, which are laid flat on the lower surface of the substrate layer. The long ribs extend infinitely towards both ends, and the long ribs in the same direction are tightly arranged. The topological coefficient N is selected from 2, i.e. a biaxial spectroscopy; The spectral layer is selected from a standard plane spectral layer, and the cross-section of its corresponding long rib is an isosceles triangle, which has two finite cut straight lines on both sides, respectively, the cross-section of the long rib is a straight triangle with a vertex angle θ of 90°. The diffuser layer is the microlens layer 225, and the coordinates of the main optical axes of the three adjacent microlenses are connected to form a regular triangle array. The microlenses in the microlens array are closely arranged. The width G of the microlens is 50 μm. The height of the microlens is H, the ratio of height and width H/G is 0.5, and the distance D between the main optical axes of adjacent microlenses is 0.5. The light-uniformizing performance of the light-uniformizing film is good, with an improvement in uniformity of U=103%.

### Embodiments 72-80

The microlens light-uniformizing film is provided in embodiment 71, and the other parameters are listed in Table 5.

TABLE 5
Design parameters and light-uniformizing performance of
microlens light-uniformizing films provided in embodiments 71 to 80

| | | | | | | | | | | | Light- | |
|---|---|---|---|---|---|---|---|---|---|---|---|---|
| | | | | | | | | | | | uniformizing | |
| | Substrate layer | | Spectral layer | | | | | Diffuser layer | | | performance | |
| | | M | | Cross-sectional | θ | a | | G | | | | U |
| Items | Materials | μm | N | shape | 0 | 0 | n₁ | μm | H/G | n₂ | RSD | % |
| Embodiment71 | PET | 75 | 2 | Right triangle | 90 | | 1.5 | 50 | 0.5 | 1.5 | 2.7 | 103 |
| Embodiment72 | PC | 75 | 2 | Right triangle | 90 | / | 1.5 | 10 | 0.5 | 1.5 | 2.7 | 103 |
| Embodiment73 | PET | 25 | 2 | Right triangle | 90 | / | 1.5 | 25 | 0.5 | 1.5 | 2.7 | 103 |
| Embodiment74 | PMMA | 75 | 2 | Right triangle | 90 | / | 1.5 | 75 | 0.5 | 1.5 | 2.7 | 103 |
| Embodiment75 | PET | 250 | 2 | Right triangle | 90 | / | 1.5 | 100 | 0.5 | 1.5 | 2.7 | 103 |
| Embodiment76 | PC | 500 | 2 | Right triangle | 90 | / | 1.5 | 50 | 0.3 | 1.5 | 2.65 | 106 |
| Embodiment77 | PET | 75 | 2 | Right triangle | 90 | / | 1.5 | 50 | 0.1 | 1.5 | 2.56 | 114 |
| Embodiment78 | PET | 75 | 2 | Right triangle | 90 | | 1.5 | 50 | 0.05 | 1.5 | 2.77 | 97 |
| Embodiment79 | PET | 75 | 2 | Right triangle | 90 | / | 1.5 | 50 | 0.5 | 1.4 | 2.78 | 97 |
| Embodiment80 | PET | 75 | 2 | Right triangle | 90 | / | 1.5 | 50 | 0.5 | 1.65 | 2.59 | 111 |

Note:
The material of the spectral and the diffuser layers in Embodiments 71-80 is AR

As shown in Table 5, by comparing embodiments 71-75, it can be seen that the thickness and material of the substrate layer, and the size of the microlens diffuser layer (i.e. the width G of the pyramid) has little effect on the light-uniformizing performance U of the light-uniformizing film. By comparing embodiments 71, 76 to 78,

It can be seen that the ratio of height and width H/G has a certain impact on U. When the ratio of height and width is 0.1, the light spreading effect is slightly better, and the light-uniformizing performance of the light-uniformizing film is slightly better, with a slightly larger U. By comparing embodiments 71, 79, and 80, it can be seen that the refractive index n₂ of the microlens structure also has an impact on the light-uniformizing performance. The higher the refractive index, the greater the U.

On the other hand, the present invention provides a concave diffusion light-uniformizing film. (Priority number: 202111268882.6, case number: 210087)

### Embodiment 81

The present invention provides a diffusion light-uniformizing film, comprising a substrate layer 20, a spectral layer 21, and a diffuser layer 22, as shown in FIG. 15. The light-uniformizing film is a concave diffusion light-uniformizing film. The thickness M of the substrate layer 20 is 75 μm, The material of the substrate layer is selected from PET, the spectral layer is composed of transparent polymer resin, and made of light-cured acrylic resin (AR), with a refractive index n₁ of 1.5, the diffuser layer is composed of transparent polymer resin, and made of light-cured acrylic resin (AR), with a refractive index of n₂ of 1.5. The spectral layer is designed as a single axis standard plane: it is composed of the long ribs stacked in N directions. The long ribs are laid flat on the lower surface of the substrate layer, extending infinitely towards both ends. The long ribs in the same direction are tightly arranged, and the topological coefficient N is 1, i.e. the single axis spectral; The spectral layer is selected from the standard plane spectral layer, and the cross-section of its corresponding long rib is an isosceles triangle, and it's left and right waists are finite cut straight lines on both sides, respectively; that is, the cross-section of the long rib is a straight triangle with a vertex angle θ of 90°. The diffuser layer is a concave diffuser layer (particle-free coating) 228, and the haze of the concave diffuser layer is 95%. The light-uniformizing performance of the light-uniformizing film is good, with an improvement in uniformity of U=163%.

### Embodiments 82-110

The concave diffusion light-uniformizing film is provided in embodiment 81, and the other parameters are listed in Table 6.

TABLE 6
Design parameters and light-uniformizing performance of
concave diffusion light-uniformizing film provided in embodiments 81-110

| | | | | | | | | | | Light- | |
|---|---|---|---|---|---|---|---|---|---|---|---|
| | | | | | | | | | | uniformizng | |
| | Substrate layer | | Spectral layer | | | | | Diffuser layer | | performance | |
| | | M | | Cross-sectional | θ | a | | Haze | | | U |
| Items | Materials | μm | N | shape | 0 | 0 | n₁ | % | n₂ | RSD | % |
| Embodiment81 | PET | 75 | 1 | Right triangle | 90 | | 1.5 | 95 | 1.5 | 2.08 | 163 |
| Embodiment82 | PC | 75 | 1 | Right triangle | 90 | / | 1.5 | 95 | 1.5 | 2.07 | 164 |
| Embodiment83 | PET | 25 | 1 | Right triangle | 90 | / | 1.5 | 95 | 1.5 | 2.08 | 163 |
| Embodiment84 | PMMA | 75 | 1 | Right triangle | 90 | | 1.5 | 95 | 1.5 | 2.08 | 163 |
| Embodiment85 | PET | 250 | 1 | Right triangle | 90 | / | 1.5 | 95 | 1.5 | 2.08 | 163 |
| Embodiment86 | PC | 500 | 1 | Right triangle | 90 | | 1.5 | 95 | 1.5 | 2.07 | 164 |
| Embodiment87 | PET | 75 | 1 | Right triangle | 90 | / | 1.5 | 98 | 1.65 | 1.91 | 186 |
| Embodiment88 | PET | 75 | 1 | Right triangle | 90 | | 1.5 | 90 | 1.4 | 2.24 | 144 |
| Embodiment89 | PET | 75 | 1 | Right triangle | 90 | / | 1.5 | 80 | 1.5 | 2.50 | 119 |
| Embodiment90 | PET | 75 | 1 | Right triangle | 90 | / | 1.5 | 60 | 1.5 | 2.97 | 85 |
| Embodiment91 | PET | 75 | 1 | Right triangle | 90 | | 1.4 | 95 | 1.5 | 2.25 | 143 |
| Embodiment92 | PET | 75 | 1 | Right triangle | 90 | | 1.65 | 95 | 1.5 | 1.87 | 193 |
| Embodiment93 | PET | 75 | 1 | Right triangle | 120 | | 1.4 | 95 | 1.5 | 2.63 | 108 |
| Embodiment94 | PET | 75 | 1 | Right triangle | 120 | / | | 95 | 1.5 | 2.50 | 119 |
| Embodiment95 | PET | 75 | 1 | Right triangle | 120 | | 1.65 | 95 | 1.5 | 2.29 | 139 |
| Embodiment96 | PET | 75 | 1 | Right triangle | 105 | / | 1.5 | 95 | 1.5 | 2.28 | 140 |
| Embodiment97 | PET | 75 | 1 | Right triangle | 75 | | 1.5 | 95 | 1.5 | 1.93 | 183 |
| Embodiment98 | PET | 75 | 1 | Right triangle | 60 | / | 1.4 | 95 | 1.5 | 1.96 | 179 |
| Embodiment99 | PET | 75 | 1 | Right triangle | 60 | | 1.5 | 95 | 1.5 | 1.75 | 213 |
| Embodiment100 | PET | 75 | 1 | Right triangle | 60 | / | 1.65 | 95 | 1.5 | 1.47 | 272 |
| Embodiment101 | PET | 75 | 1 | Convex arc | 120 | 30 | 1.5 | 95 | 1.5 | 2.12 | 158 |
| | | | | side triangle | | | | | | | |
| Embodiment102 | PET | 75 | 1 | Concave arc | 60 | 30 | 1.5 | 95 | 1.5 | 2.02 | 171 |
| | | | | side triangle | | | | | | | |
| Embodiment103 | PET | 75 | 1 | Convex arc | 120 | | 1.5 | 95 | 1.5 | 2.08 | 163 |
| | | | | side triangle | | | | | | | |
| Embodiment104 | PET | 75 | 1 | Concave arc | 60 | | 1.5 | 95 | 1.5 | 2.08 | 163 |
| | | | | side triangle | | | | | | | |
| Embodiment105 | PET | 75 | 2 | Right triangle | 90 | / | 1.4 | 95 | 1.5 | 2.07 | 164 |
| Embodiment106 | PET | 75 | 2 | Right triangle | 90 | | 1.5 | 95 | 1.5 | 1.85 | 196 |
| Embodiment107 | PET | 75 | 2 | Right triangle | 90 | / | 1.65 | 95 | 1.5 | 1.61 | 240 |
| Embodiment108 | PET | 75 | 3 | Right triangle | 90 | | 1.4 | 95 | 1.5 | 2.03 | 169 |
| Embodiment109 | PET | 75 | 3 | Right triangle | 90 | / | 1.5 | 95 | 1.5 | 1.79 | 206 |
| Embodiment 110 | PET | 75 | 3 | Right triangle | 90 | | 1.65 | 95 | 1.5 | 1.55 | 253 |

Note:
The materials of the spectral layer in embodiments 81-110 are AR, and the materials of the transparent polymer resin of the diffuser layer is AR

As shown in Table 6, by comparing embodiments 81 to 90, it can be seen that the thickness and material of the substrate layer, as well as the material of the concave diffuser layer, have little effect on the light-uniformizing performance U of the light-uniformizing film. However, the haze of the concave diffuser layer has a certain influence (as it is a particle-free coating, the haze can also be changed by adjusting n₂, and the higher the n₂, the greater the haze). The higher the haze, the greater the U. By comparing embodiments 81, 91˜100, it can be seen that the material or the refractive index of the spectral layer has an impact on U, and the higher the refractive index, the more obvious the splitting, and the better the light-uniformizing performance, the larger the U. At the same time, the larger the vortex angle θ of the triangle of the cross-section of the spectral layer, the closer the structure is to the plane, the less obvious the splitting, the worse the light-uniformizing performance, the smaller the U. By comparing embodiments 81, 91-100, and 105-110, it can be seen that for the biaxial and triaxial spectral layer designs, similar to the single axis designs, the higher the refractive index, the more obvious the splitting, the better the light-uniformizing performance, and the larger the U. The difference between the triaxial and biaxial designs of the concave diffusion light-uniformizing film is not significant, but both are better than the single axis design. By comparing embodiments 101-104, it can be seen that when the waist of the cross-section triangle is bent in different degrees of curvature, it still plays a role on splitting, and the larger the α (the larger the bend), the light-uniformizing performance U still needs improvement.

On the other hand, the present invention provides a diffusion light-uniformizing film. (Priority number: 202111272130.7, case number: 210088)

### Embodiment 111

The present invention provides a light-uniformizing film, comprising a substrate layer 20, a spectral layer 21, and a diffuser layer 22, as shown in FIG. 16. The light-uniformizing film is a diffusion light-uniformizing film. The thickness M of the substrate layer 20 is 75 μm, the material of the substrate layer is selected from PET, and the spectral layer is composed of transparent polymer resin, the material of which is light-cured acrylic resin (AR) with refractive index n₁ of 1.5. The diffuser layer is composed of transparent polymer resin, the material of which is light-cured acrylic resin (AR) with a refractive index n₂ of 1.5. The spectral layer is designed as a single axis which is laid flat on the lower surface of the substrate layer, the long ribs extend infinitely towards both ends, and the long ribs in the same direction are tightly arranged. The topological coefficient N is selected from 1, which is a single axis splitting; The spectral layer is selected from the standard plane spectral layer, and the cross-section of its corresponding long ribs is an isosceles triangle, which has two finite cut straight lines on both sides, the cross-section of the long rib is a straight triangle with a vertex angle θ of 90°. The diffuser layer is a particle-free diffuser layer 227, and the haze of the diffuser layer is 95%, the light-uniformizing performance of the light-uniformizing film is good, with an improvement in uniformity of U=99%.

### Embodiments 112-140

The diffusion light-uniformizing film is provided in embodiments 111-140, the other parameters are listed in Table 7.

TABLE 7
Design parameters and light-uniformizing performance of diffusion
uniformity films provided in embodiments 111-140.

| | | | | | | | | | | Light- | |
|---|---|---|---|---|---|---|---|---|---|---|---|
| | | | | | | | | | | uniformizing | |
| | Substrate layer | | Spectral layer | | | | | Diffuser layer | | performance | |
| | | M | | Cross-sectional | ⊖ | α | | Haze | | | U |
| Items | Materials | μm | N | shape | 0 | 0 | n₁ | % | n₂ | RSD | % |
| Embodiment111 | PET | 75 | 1 | Right triangle | 90 | / | 1.5 | 95 | 1.5 | 2.75 | 99 |
| Embodiment112 | PC | 75 | 1 | Right triangle | 90 | / | 1.5 | 95 | 1.5 | 2.74 | 100 |
| Embodiment113 | PET | 25 | 1 | Right triangle | 90 | / | 1.5 | 95 | 1.5 | 2.75 | 99 |
| Embodiment114 | PMMA | 75 | 1 | Right triangle | 90 | / | 1.5 | 95 | 1.5 | 2.75 | 99 |
| Embodiment115 | PET | 250 | 1 | Right triangle | 90 | / | 1.5 | 95 | 1.5 | 2.75 | 99 |
| Embodiment116 | PC | 500 | 1 | Right triangle | 90 | / | 1.5 | 95 | 1.5 | 2.74 | 100 |
| Embodiment117 | PET | 75 | 1 | Right triangle | 90 | / | 1.5 | 98 | 1.65 | 2.58 | 112 |
| Embodiment118 | PET | 75 | 1 | Right triangle | 90 | / | 1.5 | 90 | 1.4 | 3.10 | 76 |
| Embodiment119 | PET | 75 | 1 | Right triangle | 90 | / | 1.5 | 80 | 1.5 | 3.25 | 68 |
| Embodiment120 | PET | 75 | 1 | Right triangle | 90 | / | 1.5 | 60 | 1.5 | 3.42 | 60 |
| Embodiment121 | PET | 75 | 1 | Right triangle | 90 | | 1.4 | 95 | 1.5 | 2.95 | 85 |
| Embodiment122 | PET | 75 | 1 | Right triangle | 90 | / | 1.65 | 95 | 1.5 | 2.48 | 120 |
| Embodiment123 | PET | 75 | 1 | Right triangle | 120 | | 1.4 | 95 | 1.5 | 3.33 | 64 |
| Embodiment124 | PET | 75 | 1 | Right triangle | 120 | / | 1.5 | 95 | 1.5 | 3.14 | 74 |
| Embodiment125 | PET | 75 | 1 | Right triangle | 120 | / | 1.65 | 95 | 1.5 | 2.93 | 87 |
| Embodiment126 | PET | 75 | 1 | Right triangle | 105 | / | 1.5 | 95 | 1.5 | 3.00 | 82 |
| Embodiment127 | PET | 75 | 1 | Right triangle | 75 | | 1.5 | 95 | 1.5 | 2.46 | 122 |
| Embodiment128 | PET | 75 | 1 | Right triangle | 60 | / | 1.4 | 95 | 1.5 | 2.68 | 104 |
| Embodiment129 | PET | 75 | 1 | Right triangle | 60 | / | 1.5 | 95 | 1.5 | 2.42 | 126 |
| Embodiment130 | PET | 75 | 1 | Right triangle | 60 | / | 1.65 | 95 | 1.5 | 2.07 | 164 |
| Embodiment131 | PET | 75 | 1 | Convex arc | 120 | 30 | 1.5 | 95 | 1.5 | 2.70 | 103 |
| | | | | side triangle | | | | | | | |
| Embodiment132 | PET | 75 | 1 | Concave arc | 60 | 30 | 1.5 | 95 | 1.5 | 2.67 | 105 |
| | | | | side triangle | | | | | | | |
| Embodiment133 | PET | 75 | 1 | Convex arc | 120 | / | 1.5 | 95 | 1.5 | 2.75 | 99 |
| | | | | side triangle | | | | | | | |
| Embodiment134 | PET | 75 | 1 | Concave arc | 60 | / | 1.5 | 95 | 1.5 | 2.75 | 99 |
| | | | | side triangle | | | | | | | |
| Embodiment135 | PET | 75 | 2 | Right triangle | 90 | / | 1.4 | 95 | 1.5 | 2.88 | 90 |
| Embodiment136 | PET | 75 | 2 | Right triangle | 90 | / | 1.5 | 95 | 1.5 | 2.61 | 110 |
| Embodiment137 | PET | 75 | 2 | Right triangle | 90 | / | 1.65 | 95 | 1.5 | 2.24 | 144 |
| Embodiment138 | PET | 75 | 3 | Right triangle | 90 | / | 1.4 | 95 | 1.5 | 2.96 | 85 |
| Embodiment139 | PET | 75 | 3 | Right triangle | 90 | / | 1.5 | 95 | 1.5 | 2.67 | 105 |
| Embodiment140 | PET | 75 | 3 | Right triangle | 90 | | 1.65 | 95 | 1.5 | 2.23 | 145 |

Note:
The materials of the spectral layer in embodiments 111-140 is AR, and the material of the transparent polymer resin in the diffuser layer is AR.

As shown in Table 7, by comparing embodiments 111 to 120, it can be seen that the thickness and material of the substrate layer, as well as the material of the diffuser layer, have little effect on the light-uniformizing performance U of the light-uniformizing film. However, the haze of the diffuser layer has a certain influence (as it is a particle-free coating, the haze can also be changed by adjusting n₂, and the higher the n₂, the greater the haze). The higher the haze, the greater the U. By comparing embodiments 111, 121˜130, it can be seen that the material or the refractive index of the spectral layer has an impact on U, and the higher the refractive index, the more obvious the splitting, and the better the light-uniformizing performance, the larger the U. At the same time, the larger the vortex angle θ of the triangle of the cross-section of the spectral layer, the closer the structure is to the plane, the less obvious the splitting, the worse the light-uniformizing performance, the smaller the U. By comparing embodiments 111, 121-130, and 135-140, it can be seen that for the biaxial and triaxial spectral layer designs, similar to the single axis designs, the higher the refractive index, the more obvious the splitting, the better the light-uniformizing performance, and the larger the U. The difference between the triaxial and biaxial designs of the concave diffusion light-uniformizing film is not significant, but both are better than the single axis design. By comparing embodiments 131-134, it can be seen that when the waist of the cross-section triangle is bent in different degrees of curvature, it still plays a role on splitting, and the larger the α (the larger the bend), the light-uniformizing performance U still needs improvement.

On the other hand, the present invention provides a diffusion light-uniformizing film. (Priority number: 202111270266.4, case number: 210089)

### Embodiment 141

The present invention provides a light-uniformizing film, comprising a substrate layer 20, a spectral layer 21, and a diffuser layer 22, as shown in FIG. 17, wherein the light-uniformizing film is a diffusion light-uniformizing film. The thickness M of the substrate layer 20 is 75 μm, The material of the substrate layer is selected from PET, and the spectral layer is composed of transparent polymer resin, which is made of light-cured acrylic resin (AR), with a refractive index n₁ of 1.5. The spectral layer is designed as a single axis standard plane: it is composed of the long ribs stacked in N directions, which are laid flat on the lower surface of the substrate layer, the long ribs extend infinitely towards both ends, and the long ribs in the same direction are tightly arranged. The topological coefficient N is 1, i.e. the single axis splitting; The spectral layer is selected from the standard plane spectral layer, and the cross-section of its corresponding long rib is an isosceles triangle, which has two finite cut straight lines on both sides, that is, the cross-section of the long rib is a straight triangle with a vertex angle θ of 90°. The diffuser layer is a particle diffuser layer 226, and the haze of the diffuser layer is 98%, the particle diffuser layer is composed of transparent polymer resin and transparent polymer particles, and the transparent polymer resin is selected from PU, the refractive index n₂ is 1.5, and the material of transparent polymer particles is PMMA with a particle size of 10-20 μm. The uniformity of the light-uniformizing film performance is good, with a improvement in uniformity of U=92%.

### Embodiments 142-175

The diffusion light-uniformizing film is provided in embodiment 141, and the other parameters are listed in Table 8.

TABLE 8
Design parameters and uniformity of diffusion light-
uniformizing film provided in embodiments 141-175.

| | Substrate layer | | Spectral layer | | | | | Diffuser layer | | | Light- | |
|---|---|---|---|---|---|---|---|---|---|---|---|---|
| | | M | | Cross-sectional | ⊖ | α | | Haze | | Particle | uniformizing | |
| Items | Materials | μm | N | shape | 0 | 0 | n₁ | % | Particle | size μm | performance | |
| Embodiment141 | PET | 75 | | Right triangle | 90 | / | 1.5 | 98 | PMMA | 10-20 | 2.85 | 92 |
| Embodiment142 | PC | 75 | | Right triangle | 90 | / | 1.5 | 98 | PMMA | 10~20 | 2.84 | 93 |
| Embodiment143 | PET | 25 | 1 | Right triangle | 90 | / | 1.5 | 98 | PMMA | 10~20 | 2.85 | 92 |
| Embodiment144 | PMMA | 75 | | Right triangle | 90 | / | 1.5 | 98 | PMMA | 5~15 | 2.85 | 92 |
| Embodiment145 | PET | 250 | | Right triangle | 90 | / | 1.5 | 98 | PMMA | 5~15 | 2.85 | 92 |
| Embodiment146 | PC | 500 | | Right triangle | 90 | / | 1.5 | 98 | PMMA | 1~20 | 2.84 | 93 |
| Embodiment147 | PET | 75 | | Right triangle | 90 | / | 1.5 | 98 | PMMA | 1~20 | 2.85 | 92 |
| Embodiment148 | PET | 75 | | Right triangle | 90 | / | 1.5 | 98 | PBMA | 10~20 | 2.85 | 92 |
| Embodiment149 | PET | 75 | 1 | Right triangle | 90 | / | 1.5 | 98 | PU | 5~15 | 2.86 | 91 |
| Embodiment150 | PET | 75 | 1 | Right triangle | 90 | / | 1.5 | 98 | PS | 3~12 | 2.84 | 93 |
| Embodiment151 | PET | 75 | | Right triangle | 90 | / | 1.5 | 98 | [symbol] | 3~12 | 2.85 | 92 |
| Embodiment152 | PET | 75 | | Right triangle | 90 | / | 1.5 | 98 | [symbol] | 3~12 | 2.86 | 91 |
| Embodiment153 | PET | 75 | | Right triangle | 90 | / | 1.5 | 90 | PMMA | 10~20 | 3.2 | 71 |
| Embodiment154 | PET | 75 | | Right triangle | 90 | / | 1.5 | 80 | PMMA | 10~20 | 3.35 | 63 |
| Embodiment155 | PET | 75 | | Right triangle | 90 | / | 1.5 | 60 | PMMA | 10~20 | 3.52 | 55 |
| Embodiment156 | PET | 75 | | Right triangle | 90 | / | 1.4 | 98 | PMMA | 10~20 | 3.05 | 79 |
| Embodiment157 | PET | 75 | | Right triangle | 90 | / | 1.65 | 98 | PMMA | 10~20 | 2.58 | 112 |
| Embodiment158 | PET | 75 | | Right triangle | 120 | / | 1.4 | 98 | PMMA | 10~20 | 3.43 | 59 |
| Embodiment159 | PET | 75 | | Right triangle | 120 | / | 1.5 | 98 | PMMA | 10~20 | 3.24 | 69 |
| Embodiment160 | PET | 75 | | Right triangle | 120 | / | 1.65 | 98 | PMMA | 10~20 | 3.03 | 81 |
| Embodiment161 | PET | 75 | | Right triangle | 105 | / | 1.5 | 98 | PMMA | 10~20 | 3.1 | 76 |
| Embodiment162 | PET | 75 | | Right triangle | 75 | / | 1.5 | 98 | PMMA | 10~20 | 2.56 | 114 |
| Embodiment163 | PET | 75 | | Right triangle | 60 | / | 1.4 | 98 | PMMA | 10~20 | 2.78 | 97 |
| Embodiment164 | PET | 75 | | Right triangle | 60 | / | 1.5 | 98 | PMMA | 10~20 | 2.52 | 117 |
| Embodiment165 | PET | 75 | | Right triangle | 60 | / | 1.65 | 98 | PMMA | 10~20 | 2.17 | 152 |
| Embodiment166 | PET | 75 | | Convex arc | 120 | 30 | 1.5 | 98 | PMMA | 10~20 | 2.8 | 95 |
| | | | | side triangle | | | | | | | | |
| Embodiment167 | PET | 75 | | Concave arc | 60 | 30 | 1.5 | 98 | PMMA | 10~20 | 2.77 | 97 |
| | | | | side triangle | | | | | | | | |
| Embodiment168 | PET | 75 | | Convex arc | 120 | 1 | 1.5 | 98 | PMMA | 10~20 | 2.85 | 92 |
| | | | | side triangle | | | | | | | | |
| Embodiment169 | PET | 75 | | Concave arc | 60 | 1 | 1.5 | 98 | PMMA | 10~20 | 2.85 | 92 |
| | | | | side triangle | | | | | | | | |
| Embodiment170 | PET | 75 | 2 | Right triangle | 90 | / | 1.4 | 98 | PMMA | 10~20 | 2.98 | 84 |
| Embodiment171 | PET | 75 | 2 | Right triangle | 90 | / | 1.5 | 98 | PMMA | 10~20 | 2.71 | 102 |
| Embodiment172 | PET | 75 | 2 | Right triangle | 90 | / | 1.65 | 98 | PMMA | 10~20 | 2.34 | 134 |
| Embodiment173 | PET | 75 | 3 | Right triangle | 90 | / | 1.4 | 98 | PMMA | 10~20 | 3.06 | 79 |
| Embodiment174 | PET | 75 | 3 | Right triangle | 90 | / | 1.5 | 98 | PMMA | 10~20 | 2.77 | 97 |
| Embodiment175 | PET | 75 | 3 | Right triangle | 90 | / | 1.65 | 98 | PMMA | 10~20 | 2.33 | 135 |

Note:
The materials of the spectral layer in embodiments 141-175 is AR, and the material of the transparent polymer resin in the diffuser layer is PU, and each of the refractive index n₂ is 1.5.

As shown in Table 8, by comparing embodiments 141-155, it can be seen that the thickness and material of the substrate layer, the particle material of the diffuser layer, and the particle size distribution have little effect on the light-uniformizing performance U of the light-uniformizing film. However, the haze of the diffuser layer has a certain influence, the higher the haze, the greater the U. By comparing embodiments 141, 156, and 165, it can be seen that the material or refractive index of the spectral layer has an impact on U, and the higher the refractive index, the more obvious the splitting, and the better the light-uniformizing performance, the larger the U. At the same time, the larger the vortex angle θ of the triangle of the cross-section of the spectral layer, the closer the structure is to the plane, the less obvious the splitting, the worse the light-uniformizing performance, the smaller the U, and vice versa. By comparing embodiments 141, 156-165, and 170-175, it can be seen that for the biaxial and triaxial spectral layer designs, similar to the single axis designs, the higher the refractive index, the more obvious the splitting, the better the light-uniformizing performance, and the larger the U. The difference between the triaxial and biaxial designs of the concave diffusion light-uniformizing film is not significant, but both are better than the single axis design. By comparing embodiments 166-169, it can be seen that when the waist of the cross-section triangle is bent in different degrees of curvature, it still plays a role on splitting, and the larger the α (the larger the bend), the light-uniformizing performance U still needs improvement.

On the other hand, the present invention provides a triangular pyramid light-uniformizing film. (Priority number: 202111269132.0, case number: 210090)

### Embodiment 176

The present invention provides a light-uniformizing film comprising a substrate layer 20, a spectral layer 21, and a diffuser layer 22, as shown in FIG. 18, wherein the light-uniformizing film is a triangular prism light-uniformizing film. The thickness M of the substrate layer 20 is 75 μm, the material of the substrate layer is selected from PET, and the spectral layer is composed of transparent polymer resin, the material of which is light-cured acrylic resin (AR) with a refractive index n₁ of 1.5. The diffuser layer is composed of transparent polymer resin, the material of which is light-cured acrylic resin (AR) with a refractive index n₂ of 1.5. The spectral layer is designed as a single axis standard plane: it is composed of the long ribs stacked in N directions, which are laid flat on the lower surface of the substrate layer, the long ribs extend infinitely towards both ends, and the long ribs in the same direction are tightly arranged. The topological coefficient N is selected from 1, i.e. the single axis splitting; the layer is selected from the standard plane spectral layer, and its corresponding long rib cross-section is an isosceles triangle, with the left and right waists being finite cut straight lines at both ends. That is, the cross-section of the long rib is a straight triangle with a vertex angle θ of 90°. The diffuser layer is a triangular pyramid layer 223, which is laid flat by a triangular pyramids, the vertices of a pyramid form an regular triangle arrangement, and the height T of the pyramid is 30 μm. The angle between the side and the height γ is 45°. The light-uniformizing performance of the light-uniformizing film is good, with a improvement in uniformity of U=101%.

### Embodiments 177-205

The triangular pyramid light-uniformizing film is provided in embodiments 176-205, and the other parameters are listed in Table 9.

TABLE 9
Design parameters and uniformity of diffusion light-
uniformizing film provided in embodiments 176-205.

| | | | | | | | | | | | Light- | |
|---|---|---|---|---|---|---|---|---|---|---|---|---|
| | | | | | | | | Pyramid | | | uniformizing | |
| | Substrate layer | | Spectral layer | | | | | diffuser layer | | | performance | |
| | | M | | Cross-sectional | ⊖ | α | | T | y | | | U |
| Item | Materials | μm | N | shape | 0 | 0 | n₁ | μm | o | n₂ | RSD | % |
| Embodiment176 | PET | 75 | 1 | Right triangle | 90 | / | 1.5 | 30 | 45 | 1.5 | 2.72 | 101 |
| Embodiment177 | PC | 75 | 1 | Right triangle | 90 | / | 1.5 | 30 | 45 | 1.5 | 2.72 | 101 |
| Embodiment178 | PET | 25 | 1 | Right triangle | 90 | | 1.5 | 10 | 45 | 1.5 | 2.72 | 101 |
| Embodiment179 | PMMA | 75 | 1 | Right triangle | 90 | | 1.5 | 20 | 45 | 1.5 | 2.72 | 101 |
| Embodiment180 | PET | 250 | 1 | Right triangle | 90 | | 1.5 | 40 | 45 | 1.5 | 2.72 | 101 |
| Embodiment181 | PC | 500 | 1 | Right triangle | 90 | / | 1.5 | 50 | 45 | 1.5 | 2.72 | 101 |
| Embodiment182 | PET | 75 | 1 | Right triangle | 90 | / | 1.5 | 30 | 45 | 1.4 | 2.64 | 107 |
| Embodiment183 | PET | 75 | 1 | Right triangle | 90 | / | 1.5 | 30 | 45 | 1.65 | 2.45 | 123 |
| Embodiment184 | PET | 75 | 1 | Right triangle | 90 | / | 1.5 | 30 | 30 | 1.4 | 2.39 | 129 |
| Embodiment185 | PET | 75 | 1 | Right triangle | 90 | / | 1.5 | 30 | 30 | 1.5 | 1.45 | 277 |
| Embodiment186 | PET | 75 | 1 | Right triangle | 90 | / | 1.5 | 30 | 30 | 1.65 | 0.70 | 681 |
| Embodiment187 | PET | 75 | 1 | Right triangle | 90 | / | 1.5 | 30 | 60 | 1.4 | 2.80 | 95 |
| Embodiment188 | PET | 75 | 1 | Right triangle | 90 | | 1.5 | 30 | 60 | 1.5 | 2.75 | 99 |
| Embodiment189 | PET | 75 | 1 | Right triangle | 90 | / | 1.5 | 30 | 60 | 1.65 | 2.84 | 93 |
| Embodiment190 | PET | 75 | 1 | Right triangle | 120 | | 1.4 | 30 | 45 | 1.5 | 2.39 | 129 |
| Embodiment191 | PET | 75 | 1 | Right triangle | 120 | | 1.65 | 30 | 45 | 1.5 | 2.77 | 97 |
| Embodiment192 | PET | 75 | 1 | Right triangle | 105 | / | 1.5 | 30 | 45 | 1.5 | 2.76 | 98 |
| Embodiment193 | PET | 75 | 1 | Right triangle | 75 | / | 1.5 | 30 | 45 | 1.5 | 2.38 | 130 |
| Embodiment194 | PET | 75 | 1 | Right triangle | 60 | / | 1.4 | 30 | 45 | 1.5 | 2.43 | 125 |
| Embodiment195 | PET | 75 | 1 | Right triangle | 60 | / | 1.65 | 30 | 45 | 1.5 | 1.8 | 204 |
| Embodiment196 | PET | 75 | 1 | Convex arc | 120 | 30 | 1.5 | 30 | 45 | 1.5 | 2.9 | 89 |
| | | | | side triangle | | | | | | | | |
| Embodiment195 | PET | 75 | 1 | Concave arc | 60 | 30 | 1.5 | 30 | 45 | 1.5 | 2.42 | 126 |
| | | | | side triangle | | | | | | | | |
| Embodiment198 | PET | 75 | 1 | Convex arc | 120 | / | 1.5 | 30 | 45 | 1.5 | 2.72 | 101 |
| | | | | side triangle | | | | | | | | |
| Embodiment199 | PET | 75 | 1 | Concave arc | 60 | / | 1.5 | 30 | 45 | 1.5 | 2.72 | 101 |
| | | | | side triangle | | | | | | | | |
| Embodiment200 | PET | 75 | 2 | Right triangle | 90 | / | 1.4 | 30 | 45 | 1.5 | 3.07 | 78 |
| Embodiment201 | PET | 75 | 2 | Right triangle | 90 | / | 1.5 | 30 | 45 | 1.5 | 2.71 | 102 |
| Embodiment202 | PET | 75 | 2 | Right triangle | 90 | / | 1.65 | 30 | 45 | 1.5 | 2.34 | 134 |
| Embodiment203 | PET | 75 | 3 | Right triangle | 90 | / | 1.4 | 30 | 45 | 1.5 | 3.12 | 75 |
| Embodiment204 | PET | 75 | 3 | Right triangle | 90 | / | 1.5 | 30 | 45 | 1.5 | 2.68 | 104 |
| Embodiment205 | PET | 75 | 3 | Right triangle | 90 | / | 1.65 | 30 | 45 | 1.5 | 2.10 | 160 |

Note:
The material of the spectral layer and the diffuser layer in embodiments 176-205 are both AR

As shown in Table 9, by comparing embodiments 176-181, it can be seen that the thickness and material of the substrate layer, as well as the height, the material of the triangular pyramid layer has little effect on the light-uniformizing performance U of the light-uniformizing film. By comparing embodiments 176, 182-189, it can be seen that the angle between the side of the triangular pyramid layer and the height T is γ (as shown in FIG. 16) or the refractive index has a significant impact on U, the smaller the γ, the more convex the shape of the pyramid, the better the light spreading effect, and the better the light-uniformizing performance of the light-uniformizing film, the larger the U. The improvement of the refractive index on U is more significant when γ is relatively small. Comparing embodiments 176, 182-189, and 200-205, it can be seen that for the design of dual axis and three-axis spectral layer designs, similar to the single axis design, the higher the refractive index, the more obvious the splitting, the better the light-uniformizing performance, and the larger the U. By comparing embodiments 196-199, it can be seen that when the waists of the cross-section of the triangular is bent in different degrees of curvature, it still plays a role in splitting. For a triangular prism light-uniformizing film, the impact on U of the convex arc edge is different from that of the concave arc edge, and the concave arc edge is preferred.

On the other hand, the present invention provides an atomization light-uniformizing film. (Priority number: 202111587097.7, case number: 210113)

### Embodiment 206

The present invention provides an atomization light-uniformizing film, comprising a substrate layer 20 and an atomization spectral layer 212, as shown in FIG. 20. The thickness M of the substrate layer 20 is 75 μm, the material of the substrate layer is selected from PET. The atomization spectral layer is a concave rough surface spectral layer (as shown in FIG. 19), which is composed of transparent polymer resin and the material of which is light-cured acrylic resin (AR) with the refractive index n₁ is 1.5, and the surface of the atomization spectral layer is rough, with a line roughness Ra of 3-5 μm. The atomization spectral layer is a single axis standard plane design: it is composed of the long ribs stacked in N directions, The long ribs are laid flat on the lower surface of the substrate layer, the long ribs infinitely extend towards both ends, the long ribs arranged tightly in the same direction, with a topological coefficient N selected from 1, i.e. a single axis splitting; The light-uniformizing performance of the atomization light-uniformizing film is good, with an improvement in uniformity of U=69%.

### Embodiments 207-235

The atomization light-uniformizing film is provided in embodiment 206, and the other parameters are listed in Table 10.

TABLE 10
Design parameters and light-uniformizing performance of
atomization light-uniformizing film provided in embodiments 206 to 235

| | | | | | | | | | Light- | |
|---|---|---|---|---|---|---|---|---|---|---|
| | | | Atomization spectral layer | | | | | | uniformizing | |
| | Substrate layer | | | Rough | Line | | | | performance | |
| | | M | | surface | roughness | θ | | | | U |
| Items | Materials | μm | N | Type | μm | 0 | Materials | n₁ | RSD | % |
| Embodiment1 | PET | 75 | | Concave | <0.25 | 90 | AR | 1.5 | 3.73 | 46 |
| Embodiment206 | PET | 75 | | Concave | 3~5 | 90 | AR | 1.5 | 3.23 | 69 |
| Embodiment207 | PET | 25 | | Concave | 3~5 | 90 | AR | 1.5 | 3.23 | 69 |
| Embodiment208 | PET | 125 | | Concave | 3~5 | 90 | AR | 1.5 | 3.23 | 69 |
| Embodiment209 | PET | 250 | | Concave | 3~5 | 90 | AR | 1.5 | 3.23 | 69 |
| Embodiment210 | PMMA | 100 | | Concave | 3~5 | 90 | AR | 1.5 | 3.23 | 69 |
| Embodiment211 | PC | 100 | | Concave | 3~5 | 90 | AR | 1.5 | 3.21 | 70 |
| Embodiment212 | PC | 250 | | Concave | 3~5 | 90 | AR | 1.5 | 3.21 | 70 |
| Embodiment213 | PC | 500 | | Concave | 3~5 | 90 | AR | 1.5 | 3.21 | 70 |
| Embodiment214 | PET | 100 | | Concave | 3~5 | 90 | AR | 1.65 | 3.00 | 83 |
| Embodiment215 | PET | 100 | | Concave | 3~5 | 90 | AR | 1.4 | 3.38 | 62 |
| Embodiment216 | PC | 100 | | Concave | 3~5 | 90 | PC | 1.58 | 3.13 | 75 |
| Embodiment217 | PMMA | 100 | | Concave | 3~5 | 90 | PMMA | 1.5 | 3.22 | 70 |
| Embodiment218 | PET | 75 | 1 | Concave | 3~5 | 120 | AR | 1.5 | 3.65 | 50 |
| Embodiment219 | PET | 75 | | Concave | 3~5 | 120 | AR | 1.65 | 3.37 | 62 |
| Embodiment220 | PET | 75 | | Concave | 3~5 | 105 | AR | 1.5 | 3.34 | 64 |
| Embodiment221 | PET | 75 | | Concave | 3~5 | 105 | AR | 1.65 | 3.10 | 76 |
| Embodiment222 | PET | 75 | | Concave | 3~5 | 75 | AR | 1.4 | 3.25 | 68 |
| Embodiment223 | PET | 75 | 1 | Concave | 3~5 | 75 | AR | 1.5 | 3.10 | 76 |
| Embodiment224 | PET | 75 | 1 | Concave | 3~5 | 75 | AR | 1.65 | 2.68 | 104 |
| Embodiment225 | PET | 75 | 1 | Concave | 3~5 | 60 | AR | 1.4 | 3.17 | 73 |
| Embodiment226 | PET | 75 | 1 | Concave | 3~5 | 60 | AR | 1.5 | 2.97 | 84 |
| Embodiment227 | PET | 75 | 1 | Concave | 3~5 | 60 | AR | 1.65 | 2.15 | 155 |
| Embodiment228 | PET | 75 | 2 | Concave | 3~5 | 90 | AR | 1.4 | 2.96 | 85 |
| Embodiment229 | PET | 75 | 2 | Concave | 3~5 | 90 | AR | 1.5 | 2.54 | 116 |
| Embodiment230 | PET | 75 | 2 | Concave | 3~5 | 90 | AR | 1.65 | 2.11 | 159 |
| Embodiment231 | PET | 75 | 3 | Concave | 3~5 | 90 | AR | 1.4 | 2.89 | 89 |
| Embodiment232 | PET | 75 | 3 | Concave | 3~5 | 90 | AR | 1.5 | 2.44 | 124 |
| Embodiment233 | PET | 75 | 3 | Concave | 3~5 | 90 | AR | 1.65 | 1.90 | 187 |
| Embodiment234 | PET | 75 | 1 | Concave | 2~3 | 90 | AR | 1.5 | 3.38 | 62 |
| Embodiment235 | PET | 75 | 1 | Concave | 5~10 | 90 | AR | 1.5 | 2.96 | 85 |

As shown in Table 10, by comparing embodiments 206 to 217, it can be seen that the thickness and the material of the substrate layer have little effect on the light-uniformizing performance U of the light-uniformizing film, however the material or refractive index of the spectral layer has an impact on U. For a single axis spectral layer, the higher the refractive index, the more obvious the splitting, the better the light-uniformizing performance, and the larger the U. By comparing embodiments 218-227, it can be seen that the larger the opposite angle of the vortex angle of the cross-section triangle θ, the more closer to the planar the structure, the less obvious the splitting, the worse the light-uniformizing performance, the smaller the U, and vice versa. Compared embodiments 206, 213, 214, and 228˜233, it can be seen that, for the designs of the biaxial and the triaxial spectral layers, similar to the single axis, the higher the refractive index, the more obvious the splitting, the better the light-uniformizing performance, the larger the U, and under the same refractive index, the triaxial spectral layer is better than the biaxial layer and the single axis layer. By comparing embodiments 1, 206, 234, and 235, it can be seen that the higher the roughness of the spectral layer, the better the light-uniformizing performance, and the larger the U.

### Embodiment 236

The present invention provides an atomization light-uniformizing film, comprising a substrate layer 20 and an atomization spectral layer 211, as shown in FIG. 22. The thickness M of the substrate layer 20 is 75 μm, the material of the substrate layer is selected from PET. The atomized spectral layer is a convex rough surface spectral layer (as shown in FIG. 21), which is composed of transparent polymer resin, made of light-cured acrylic resin (AR), with a refractive index n₁ of 1.5. The surface of the atomized spectral layer is rough, and the line roughness Ra is 3-5 μm. The atomization spectral layer is designed as a single axis standard plane: it is composed of the long ribs stacked in N directions. The long ribs are laid flat on the lower surface of the substrate layer, extending infinitely towards both ends. The long ribs in the same direction are tightly arranged, and the topological coefficient N is selected from 1, which is a single axis splitting; the light-uniformizing performance of the atomization light-uniformizing film is good, with an improvement in uniformity of U=61%.

### Embodiments 237-265

The atomization light-uniformizing film is provided in embodiment 236, and the other parameters are listed in Table 11.

TABLE 11
Design parameters and light-uniformizing performance of
atomization light-uniformizing film provided in embodiments 236-265

| | | | | | | | | | Light- | |
|---|---|---|---|---|---|---|---|---|---|---|
| | | | Atomization spectral layer | | | | | | uniformizing | |
| | Substrate layer | | | Rough | Line | | | | performance | |
| | | M | | surface | roughnes | θ | | | | U |
| Items | Materials | μm | N | type | μm | 0 | Materials | n₁ | RSD | % |
| Embodiment1 | PET | 75 | 1 | Concave | <0.25 | 90 | AR | 1.5 | 3.73 | 46 |
| Embodiment236 | PET | 75 | 1 | Concave | 3~5 | 90 | AR | 1.5 | 3.39 | 61 |
| Embodiment237 | PET | 25 | 1 | Concave | 3~5 | 90 | AR | 1.5 | 3.39 | 61 |
| Embodiment238 | PET | 125 | 1 | Concave | 3~5 | 90 | AR | 1.5 | 3.39 | 61 |
| Embodiment239 | PET | 250 | 1 | Concave | 3~5 | 90 | AR | 1.5 | 3.39 | 61 |
| Embodiment240 | PMMA | 100 | 1 | Concave | 3~5 | 90 | AR | 1.5 | 3.39 | 61 |
| Embodiment241 | PC | 100 | 1 | Concave | 3~5 | 90 | AR | 1.5 | 3.37 | 62 |
| Embodiment242 | PC | 250 | 1 | Concave | 3~5 | 90 | AR | 1.5 | 3.37 | 62 |
| Embodiment243 | PC | 500 | 1 | Concave | 3~5 | 90 | AR | 1.5 | 3.37 | 62 |
| Embodiment244 | PET | 100 | 1 | Concave | 3~5 | 90 | AR | 1.65 | 3.15 | 74 |
| Embodiment245 | PET | 100 | 1 | Concave | 3~5 | 90 | AR | 1.4 | 3.55 | 54 |
| Embodiment246 | PC | 100 | 1 | Concave | 3~5 | 90 | PC | 1.58 | 3.28 | 67 |
| Embodiment247 | PMMA | 100 | 1 | Concave | 3~5 | 90 | PMMA | 1.5 | 3.38 | 62 |
| Embodimen248 | PET | 75 | 1 | Concave | 3~5 | 120 | AR | 1.5 | 3.83 | 43 |
| Embodiment249 | PET | 75 | 1 | Concave | 3~5 | 120 | AR | 1.65 | 3.54 | 55 |
| Embodiment250 | PET | 75 | 1 | Concave | 3~5 | 105 | AR | 1.5 | 3.51 | 56 |
| Embodiment251 | PET | 75 | 1 | Concave | 3~5 | 105 | AR | 1.65 | 3.25 | 68 |
| Embodiment252 | PET | 75 | 1 | Concave | 3~5 | 75 | AR | 1.4 | 3.41 | 60 |
| Embodiment253 | PET | 75 | 1 | Concave | 3~5 | 75 | AR | 1.5 | 3.25 | 68 |
| Embodiment254 | PET | 75 | 1 | Concave | 3~5 | 75 | AR | 1.65 | 2.81 | 95 |
| Embodiment255 | PET | 75 | 1 | Concave | 3~5 | 60 | AR | 1.4 | 3.33 | 64 |
| Embodiment256 | PET | 75 | 1 | Concave | 3~5 | 60 | AR | 1.5 | 3.12 | 75 |
| Embodiment257 | PET | 75 | 1 | Concave | 3~5 | 60 | AR | 1.65 | 2.25 | 143 |
| Embodiment258 | PET | 75 | 2 | Concave | 3~5 | 90 | AR | 1.4 | 3.11 | 76 |
| Embodiment259 | PET | 75 | 2 | Concave | 3~5 | 90 | AR | 1.5 | 2.66 | 105 |
| Embodiment260 | PET | 75 | 2 | Concave | 3~5 | 90 | AR | 1.65 | 2.22 | 147 |
| Embodiment261 | PET | 75 | 3 | Concave | 3~5 | 90 | AR | 1.4 | 3.04 | 80 |
| Embodiment262 | PET | 75 | 3 | Concave | 3~5 | 90 | AR | 1.5 | 2.56 | 113 |
| Embodiment263 | PET | 75 | 3 | Concave | 3~5 | 90 | AR | 1.65 | 2.00 | 174 |
| Embodiment264 | PET | 75 | 1 | Concave | 2~3 | 90 | AR | 1.5 | 3.55 | 54 |
| Embodiment265 | PET | 75 | 1 | Concave | 5~10 | 90 | AR | 1.5 | 3.11 | 76 |

As shown in Table 11, by comparing embodiments 236-247, it can be seen that the thickness and material of the substrate layer have little effect on the light-uniformizing performance U of the light-uniformizing film, but the material or refractive index of the spectral layer has an impact on U. For a single axis spectral layer, the higher the refractive index, the more obvious the light, the better the light-uniformizing performance, and the larger the U. By comparing embodiments 248 to 257, it can be seen that the larger the opposite angle of the vortex angle of the cross-section triangle θ, the more closer to the planar the structure, the less obvious the splitting, the worse the light-uniformizing performance, the smaller the U, and vice versa. Comparing embodiments 236, 243, 244, and 258-263, it can be seen that for the biaxial and triaxial spectral layer designs, similar to the single axis design, the higher the refractive index, the more obvious the splitting, the better the light-uniformizing performance, and the larger the U, and under the same refractive index, triaxial designs are better than biaxial designs than single axis design. By comparing embodiments 1, 236, 264, and 265, it can be seen that the higher the roughness of the spectral layer, the better the light-uniformizing performance, and the larger the U.

On the other hand, the present invention provides an orthogonal prism light-uniformizing film. (Priority number: 202210320342.6, case number: 220010)

### Embodiment 266

The present invention provides a light-uniformizing film comprising a substrate layer 20, a spectral layer 21, and a diffuser layer 22, as shown in FIGS. 23 and 24, and the light-uniformizing film is an orthogonal prism light-uniformizing film. The thickness M of the substrate layer 20 is 75 μm, The material of the substrate layer is selected from PET, the spectral layer is composed of transparent polymer resin, the material of which is made of light-cured acrylic resin (AR) with a refractive index n₁ of 1.5, and the diffuser layer is composed of transparent polymer resin, the material of which is made of light-cured acrylic resin (AR) with a refractive index n₂ of 1.5. The spectral layer is designed as a single axis standard plane: it is composed of the long ribs stacked in N directions. The long ribs are laid flat on the lower surface of the substrate layer, extending infinitely towards both ends. The long ribs in the same direction are tightly arranged, and the topological coefficient N is 1, i.e. a single axis splitting; The spectral layer is a standard plane spectral layer, and cross-section of its corresponding long rib is an isosceles triangle, which has two finite cut straight lines on both sides, that is, the cross-section of the long rib is a straight triangle with a vertex angle θ of 90°. The diffuser layer is an orthogonal prism layer 223, which is laid flat by the triangular prism ribs. The cross-section of the triangular prism ribs is an isosceles triangle, with the bottom edge V of the triangle of 50 μm, the vortex angle β of 75°. The matching angle Δω(i.e. ω₄−ω₁) of the diffuser layer and the spectral layer is 90°. The light-uniformizing performance of the orthogonal prism light-uniformizing film is good, with an improvement in uniformity of U=488%.

### Embodiments 267-288

The orthogonal prism light-uniformizing film is provided in embodiment 266, and the other parameters are listed in Table 12.

TABLE 12
Design parameters and light-uniformizing performance
of orthogonal prism light-uniformizing film provided in embodiments
266-288 for Scale 1

| | | | | | | | | | | | | Light- | |
|---|---|---|---|---|---|---|---|---|---|---|---|---|---|
| | | | | | | | | | | | Mating | uniformizing | |
| | Substrate layer | | Spectral layer | | | | | Prism diffuser layer | | | angle | performance | |
| | | M | | Cross-sectional | θ | a/ | | V | | | Δw | | U/ |
| Item | Materials | μm | N | shape | 0 | o | n₁ | μm | β | n₂ | 0 | RSD | % |
| Example 1 | PET | 75 | 1 | Right triangle | 90 | | 1.5 | 50 | 75 | 1.5 | 0 | 2.24 | 144 |
| Embodiment266 | PET | 75 | 1 | Right triangle | 90 | | 1.5 | 50 | 75 | 1.5 | 90 | 0.93 | 488 |
| Embodiment267 | PET | 75 | 1 | Right triangle | 90 | | 1.5 | 50 | 75 | 1.5 | 75 | 1.21 | 352 |
| Embodiment268 | PET | 75 | 1 | Right triangle | 90 | | 1.5 | 50 | 75 | 1.5 | 105 | 1.21 | 352 |
| Embodiment269 | PC | 75 | 1 | Right triangle | 90 | | 1.5 | 50 | 75 | 1.5 | 90 | 0.93 | 488 |
| Embodiment270 | PET | 25 | 1 | Right triangle | 90 | | 1.5 | 10 | 75 | 1.5 | 90 | 0.93 | 488 |
| Embodiment271 | PMMA | 75 | 1 | Right triangle | 90 | | 1.5 | 25 | 75 | 1.5 | 90 | 0.93 | 488 |
| Embodiment272 | PET | 250 | 1 | Right triangle | 90 | | 1.5 | 75 | 75 | 1.5 | 90 | 0.93 | 488 |
| Embodiment273 | PC | 500 | 1 | Right triangle | 90 | | 1.5 | 100 | 75 | 1.5 | 90 | 0.93 | 488 |
| Embodiment274 | PET | 75 | 1 | Right triangle | 90 | | 1.5 | 50 | 105 | 1.5 | 90 | 1.91 | 186 |
| Embodiment275 | PET | 75 | 1 | Right triangle | 90 | | 1.5 | 50 | 90 | 1.5 | 90 | 1.79 | 206 |
| Embodiment276 | PET | 75 | 1 | Right triangle | 90 | | 1.5 | 50 | 85 | 1.5 | 90 | 1.50 | 265 |
| Embodiment277 | PET | 75 | 1 | Right triangle | 90 | | 1.5 | 50 | 80 | 1.5 | 90 | 1.35 | 305 |
| Embodiment278 | PET | 75 | 1 | Right triangle | 90 | | 1.5 | 50 | 60 | 1.5 | 90 | 0.72 | 660 |
| Embodiment279 | PET | 75 | 1 | Right triangle | 90 | | 1.5 | 50 | 75 | 1.4 | 90 | 0.66 | 727 |
| Embodiment280 | PET | 75 | 11 | Right triangle | 90 | | 1.5 | 50 | 75 | 1.65 | 90 | 0.75 | 631 |
| Embodiment281 | PET | 75 | 1 | Right triangle | 120 | | 1.5 | 50 | 75 | 1.5 | 90 | 1.33 | 311 |
| Embodiment282 | PET | 75 | 1 | Right triangle | 105 | | 1.5 | 50 | 75 | 1.5 | 90 | 1.04 | 426 |
| Embodiment283 | PET | 75 | 1 | Right triangle | 75 | | 1.5 | 50 | 75 | 1.5 | 90 | 0.52 | 955 |
| Embodiment284 | PET | 75 | 1 | Right triangle | 60 | | 1.5 | 50 | 75 | 1.5 | 90 | 0.77 | 615 |
| Embodiment285 | PET | 75 | 1 | Convex arc side | 90 | 15 | 1.5 | 50 | 75 | 1.5 | 90 | 0.58 | 843 |
| | | | | triangle | | | | | | | | | |
| Embodiment286 | PET | 75 | 1 | Concave arc side | 60 | 15 | 1.5 | 50 | 75 | 1.5 | 90 | 0.56 | 877 |
| | | | | triangle | | | | | | | | | |
| Embodiment287 | PET | 75 | 1 | Convex arc side | 76 | | 1.5 | 50 | 75 | 1.5 | 90 | 0.52 | 950 |
| | | | | triangle | | | | | | | | | |
| Embodiment288 | PET | 75 | 1 | Concave arc side | 74 | | 1.5 | 50 | 75 | 1.5 | 90 | 0.52 | 950 |
| | | | | triangle | | | | | | | | | |

Note:
each of the material of the spectral and diffuser layers in example 1, embodiments 266-288 is AR.

As shown in Table 12, it can be seen from example 1 and embodiments 266-268 that the mating angle Δω will significantly affect RSD, RSD is largest when Δω is at 0°. The closer the Aw to 90 degrees, the smaller the RSD, the better the light-uniformizing performance. The effect will deteriorate when Δω deviates from 90 degrees. Therefore, the matching angle of the orthogonal prism light-uniformizing film is preferably 75˜105°, and further preferably 90°. By comparing embodiments 266, 269-273, the thickness, material the substrate layer, height, and material of the prism layer have less effect on the light-uniformizing performance U of the orthogonal prism light-uniformizing film. By comparing embodiments 266, 272-179, and 274-278, it can be seen that the vortex angle of the prism layer has a significant impact on the light-uniformizing performance U of the orthogonal prism light-uniformizing film, the smaller the vortex angles, the better the light-uniformizing performance. By comparing embodiments 266, 279-280, it can be seen that the refractive index of the prism layer has also impact on U, both the combination of prism resin with low or high refractive indexes further increase U.
By comparing embodiments 266, 281-284, it can be seen that the vortex angle of the long ribs in the spectral layer has also an impact on the light-uniformizing performance. The light-uniformizing performance is best at 75°, with U being the largest. By comparing embodiments 285-288, it can be seen that when the waists of the cross-section triangle are bent in different degrees of curvature, it has a slight impact on the light-uniformizing performance, and the impact of convex and concave edges on U is different.
On the other hand, the present invention provides an oblique prism light-uniformizing film. (Priority number: 202210322327.5, case number: 220011)

### Embodiment 289

The present invention provides a light-uniformizing film comprising a substrate layer 20, a spectral layer 21, and a diffuser layer 22, as shown in FIGS. 27 and 28, The light-uniformizing film is a diagonal prism light-uniformizing film. The thickness M of the substrate layer 20 is 75 μm, The material of the substrate layer is selected from PET, the spectral layer is composed of transparent polymer resin, and made of light-cured acrylic resin (AR) with a refractive index n₁ of 1.5, and the diffuser layer is composed of transparent polymer resin, and made of light-cured acrylic resin (AR) with a refractive index n₂ of 1.5. The spectral layer is designed as a biaxial standard plane: it is composed of the long ribs stacked in N different directions, which are laid flat on the lower surface of the substrate layer. The long ribs extend infinitely towards both ends, and the long ribs in the same direction are tightly arranged. The topological coefficient N is 2, that is, a biaxial splitting, ω₁ is 0°, ω₄ is 90°; The spectral layer is selected from the standard plane spectral layer, and cross-section of its corresponding long rib is an isosceles triangle which has two finite cut straight lines on both sides, that is, the cross-section of the long rib is a straight triangle with a vertex angle θ of 90°. The diffuser layer is a diagonal prism layer 223, which is laid flat by three prism ribs. The cross-section of the three prism ribs is an isosceles triangle, and the bottom edge V of the triangle is 50 μm, with the vortex angle β of 75°, ω₄ of 45°. The matching angle Δω(i.e., ω₄−ω₁) of the diffuser layer and the spectral layer is 45°. The uniform performance of the oblique prism light-uniformizing film is good, with an improvement in uniformity of U=338%.

### Embodiments 290-311

The other parameters of the oblique prism light-uniformizing film provided in embodiment 289 are listed in Table 13.

TABLE 13
Design parameters and light-uniformizing performance of
the oblique prism light-uniformizing film provided in embodiments
289-311

| | | | | | | | | | | | | Light- | |
|---|---|---|---|---|---|---|---|---|---|---|---|---|---|
| | | | | | | | | | | | collocation | uniformizing | |
| | Substrate layer | | Spectral layer | | | | | Prism diffuser layer | | | angle | performance | |
| | | M | | Cross-sectional | θ | a/ | | V | | | Δω | | U |
| Item | Materials | μm | N | shape | 0 | o | n₁ | μm | β | n₂ | 0 | RSD | 1% |
| Example1 | PET | 75 | 2 | Right triangle | 90 | / | 1.5 | 50 | 75 | 1.5 | 0 | 2.36 | 132 |
| Embodiment289 | PET | 75 | 2 | Right triangle | 90 | / | 1.5 | 50 | 75 | 1.5 | 45 | 1.25 | 338 |
| Embodiment290 | PET | 75 | 2 | Right triangle | 90 | / | 1.5 | 50 | 75 | 1.5 | 30 | 1.34 | 308 |
| Embodiment291 | PET | 75 | 2 | Right triangle | 90 | | 1.5 | 50 | 75 | 1.5 | 60 | 1.34 | 308 |
| Embodiment292 | PC | 75 | 2 | Right triangle | 90 | / | 1.5 | 50 | 75 | 1.5 | 45 | 1.25 | 338 |
| Embodiment293 | PET | 25 | 2 | Right triangle | 90 | / | 1.5 | 10 | 75 | 1.5 | 45 | 1.25 | 338 |
| Embodiment294 | PMMA | 75 | 2 | Right triangle | 90 | / | 1.5 | 25 | 75 | 1.5 | 45 | 1.25 | 338 |
| Embodiment295 | PET | 250 | 2 | Right triangle | 90 | / | 1.5 | 75 | 75 | 1.5 | 45 | 1.25 | 338 |
| Embodiment296 | PC | 500 | 2 | Right triangle | 90 | / | 1.5 | 100 | 75 | 1.5 | 45 | 1.25 | 338 |
| Embodiment297 | PET | 75 | 2 | Right triangle | 90 | / | 1.5 | 50 | 105 | 1.5 | 45 | 2.05 | 167 |
| Embodiment298 | PET | 75 | 2 | Right triangle | 90 | / | 1.5 | 50 | 90 | 1.5 | 45 | 1.87 | 193 |
| Embodiment299 | PET | 75 | 2 | Right triangle | 90 | / | 1.5 | 50 | 85 | 1.5 | 45 | 1.65 | 232 |
| Embodiment300 | PET | 75 | 2 | Right triangle | 90 | / | 1.5 | 50 | 80 | 1.5 | 45 | 1.4 | 291 |
| Embodiment301 | PET | 75 | 2 | Right triangle | 90 | / | 1.5 | 50 | 60 | 1.5 | 45 | 1.03 | 431 |
| Embodiment302 | PET | 75 | 2 | Right triangle | 90 | / | 1.5 | 50 | 75 | 1.4 | 45 | 0.85 | 544 |
| Embodiment303 | PET | 75 | 2 | Right triangle | 90 | | 1.5 | 50 | 75 | 1.65 | 45 | 0.96 | 470 |
| Embodiment304 | PET | 75 | 2 | Right triangle | 120 | | 1.5 | 50 | 75 | 1.5 | 45 | 1.68 | 226 |
| Embodiment305 | PET | 75 | 2 | Right triangle | 105 | / | 1.5 | 50 | 75 | 1.5 | 45 | 1.35 | 305 |
| Embodiment306 | PET | 75 | 2 | Right triangle | 75 | / | 1.5 | 50 | 75 | 1.5 | 45 | 0.78 | 601 |
| Embodiment307 | PET | 75 | 2 | Right triangle | 60 | / | 1.5 | 50 | 75 | 1.5 | 45 | 1.02 | 436 |
| Embodiment308 | PET | 75 | 2 | Convex arc | 90 | 15 | 1.5 | 50 | 75 | 1.5 | 45 | 0.85 | 544 |
| | | | | side triangle | | | | | | | | | |
| Embodiment309 | PET | 75 | 2 | Concave arc | 60 | 15 | 1.5 | 50 | 75 | 1.5 | 45 | 0.83 | 559 |
| | | | | side triangle | | | | | | | | | |
| Embodiment310 | PET | 75 | 2 | Convex arc | 76 | 1 | 1.5 | 50 | 75 | 1.5 | 45 | 0.78 | 601 |
| | | | | side triangle | | | | | | | | | |
| Embodiment311 | PET | 75 | 2 | Concave arc | 74 | 1 | 1.5 | 50 | 75 | 1.5 | 45 | 0.78 | 601 |
| | | | | side triangle | | | | | | | | | |

Note:
The material of the spectral layer and the diffuser layer in embodiments 45, 289-311 are all AR

As shown in Table 13, comparing the example 1, and embodiments 289˜291, it can be seen that the matching angle Δω will significantly affect RSD. When Δω is 0 degree, RSD is the largest. The closer the Δω to 45 degrees, the smaller the RSD, the better the light-uniformizing performance. The effect will deteriorate when Δω deviates from 45 degrees. Therefore, the matching angle of the orthogonal prism light-uniformizing film is preferably 30˜60°, and further preferably 45°. By comparing embodiments 289, 292-296, the thickness, material the substrate layer, height, and material of the prism layer have less effect on the light-uniformizing performance U of the oblique prism light-uniformizing film. By comparing embodiments 289, 297-301, it can be seen that the vortex angle of the prism layer has a significant impact on the light-uniformizing performance U of the oblique prism light-uniformizing film, the smaller the vortex angle, the better the light-uniformizing performance, the larger the U. By comparing embodiments 289, 302-303, it can be seen that the refractive index of the prism layer has also impact on U, both the combination of prism resin with low or high refractive indexes further increase U. By comparing embodiments 289, 304-307, it can be seen that the vortex angle of the long ribs in the spectral layer has also an impact on the light-uniformizing performance. The light-uniformizing performance is best at 75°, with U being the largest. By comparing embodiments 308-311, it can be seen that when the waists of the cross-section triangle are bent in different degrees of curvature, it has a slight impact on the light-uniformizing performance, and the impact of convex and concave edges on U is different.

It should be noted that the above description is only a few typical embodiments of the present invention and is not intended to limit scopes of the present invention. All equal changes and modifications made based on the content of the present invention are covered within the scope of the patent of the present invention.

1. A light-uniformizing film, comprising:
a spectral layer;
a substrate layer; and
a diffuser layer;
the diffuser layer is located on an upper surface of the substrate layer, and the diffuser layer is located on a lower surface of the substrate layer;
a line roughness of the surface of the spectral layer is Ra<250 nm;
the light-uniformizing film being one of a planar light-uniformizing film, a prism light-uniformizing film, a cylinder light-uniformizing film, a pyramid light-uniformizing film, and a microlens light-uniformizing film;
the spectral layer being composed of long ribs stacked in N different directions, where N is a topological coefficient, the long ribs are laid flat on the lower surface of the substrate, the long ribs extending infinitely towards both ends, with the long ribs in a same direction tightly arranged, the N directions divide the 360 degree azimuth equally, where each of the angle interval between adjacent directions is 180/N degrees, and N is selected from 1, 2, or 3.

2.-5. (canceled)

6. The light-uniformizing film according to claim 1, wherein a cross-section of the long ribs in the spectral layer is the same, both are isosceles triangles, with a left and a right waists being one of a finite cut straight lines at both ends, an outer convex arc, and an inner concave arc, and a bottom edge being a straight line, a bottom edge W1 is between 10-100 μm, a vortex angle θ being between 60˜120°; a degree of curvature of the outer convex arc and an inner concave arc is represented by a center angle of a circle, which is a of between 1˜30°; the spectral layer is one of the standard plane spectral layer, convex arc surface spectral layer, and concave arc surface spectral layer, and a waists of its corresponding long rib cross-section isosceles triangle are finite cut straight lines at both ends, an outer convex arc line, and an inner concave arc line, respectively.

7. A light-uniformizing film according to claim 6, wherein the light-uniformizing film is a planar light-uniformizing film, and the planar light-uniformizing film includes a spectral layer and a substrate layer; the spectral layer is one of a standard plane spectral layer, a convex arc surface spectral layer, and a concave arc surface spectral layer.

8. The light-uniformizing film according to claim 7, characterized in that the light-uniformizing film is a prism light-uniformizing film, and the prism light-uniformizing film includes a spectral layer, a substrate layer, and a diffuser layer; the spectral layer is one of a standard plane spectral layer, a convex arc surface spectral layer, and a concave arc surface spectral layer; the diffuser layer is a prism layer, which is composed of triangular prism ribs laid flat; a cross-section of the triangular prism ribs is an isosceles triangle, with a base edge V of between 10-100 μm, a vortex angle β of between 60˜120°.

9.-12. (canceled)

13. A concave diffusion light-uniformizing film, comprising:
a spectral layer;
a substrate layer; and
a diffuser layer,
the diffuser layer being located on an upper surface of the substrate layer;
the spectral layer being located on a lower surface of the substrate layer; the diffuser layer being a concave diffuser layer;
the concave diffuser layer is a particle-free coating, with a haze being 60-98%;
the spectral layer being one of a standard plane surface, a convex arc surface and a concave arc surface;
the particle-free coating is composed of a transparent polymer resin, wherein the transparent polymer resin is selected from AR, and a refractive index n₂ is between 1.4 to 1.65; an upper surface of the concave diffuser layer has a concave arc surface that intersects to form a peak.

14.-28. (canceled)

29. An atomization light-uniformizing film, comprising:
an atomization spectral layer;
a substrate layer; and
a diffuser layer;
the diffused layer being located on an upper surface of the substrate layer;
the atomization spectral layer being located on a lower surface of the substrate layer;
a surface of the atomization spectral layer is rough, wherein a line roughness of the surface of the atomization spectral layer is Ra is between 2-10 μm.

30. (canceled)

31. The atomization light-uniformizing film according to claim 29, wherein the atomization spectral layer is composed of long ribs stacked in N directions, with N being a topological coefficient; the long ribs are laid flat on a lower surface of the substrate layer, and extend infinitely towards both ends, the long ribs in a same direction are tightly arranged, and the N directions divide the 360 degree azimuth equally, with an angle interval of 180/N between adjacent directions, N is selected from 1, 2, or 3.

32. The atomization light-uniformizing film according to claim 29, wherein the atomization spectral layer is a concave rough surface spectral layer or a convex rough surface spectral layer.

33. The atomization light-uniformizing film according to claim 32, wherein the atomization spectral layer is a concave rough surface spectral layer, a long rib cross-section in the concave rough surface spectral layer is approximate an isosceles triangle, with left and right waists being finite cut concave rough lines at both ends, a bottom edge is a straight line and a bottom edge W₁ of between 10-100 μm, a vortex angle θ of between 60˜120°, the concave rough line has a concave arc.

34. The atomization light-uniformizing film according to claim 33, wherein the atomization spectral layer is a convex rough surface spectral layer, the long rib cross-section in the convex rough surface spectral layer is approximate an isosceles triangle, with the left and right waists being finite cut convex rough lines at both ends, the bottom edge being both straight lines and the bottom edge W₁ of 10-100 μm, the vortex angle θ of 60˜120°, the convex rough line has a convex arc.

35.-43. (canceled)
